(19) United States
(12) Patent Application Publication
(10) Pub. No.: US 2009/0317567 A1
(43) Pub. Date: Dec. 24, 2009

(54) CELLULOSE ESTER FILM, POLARIZER AND LIQUID CRYSTAL DISPLAY DEVICE

(75) Inventors: Jun Takeda, Minami-ashigara-shi (JP); Ryousuke Takada, Minami-ashigara-shi (JP); Masaya Suzuki, Minami-ashigara-shi (JP); Hiromichi Tachikawa, Minami-ashigara-shi (JP)

Correspondence Address: BUCHANAN, INGERSOLL & ROONEY PC, POST OFFICE BOX 1404, ALEXANDRIA, VA, 22313-1404, US

(73) Assignee: FUJIFILM CORPORATION, Minato-ku (JP)

(21) Appl. No.: 12/488,055

(22) Filed: Jun. 19, 2009

(30) Foreign Application Priority Data
Jun. 19, 2008 (JP) 2008-160543
Aug. 18, 2008 (JP) 2008-210183

(51) Int. Cl. C09K 19/02; C08L 67/00

(52) U.S. Cl. 428/1.33; 524/600

(57) ABSTRACT

A cellulose ester film with Rth>0 nm comprising a cellulose ester having a total degree of substitution of at least 2.3 and a polymer X with a weight-average molecular weight of 500-100000 satisfying 30%≦A≦100%, wherein A indicates the polymerization ratio of a monomer whose homopolymer has a negative birefringence, is excellent in humidity stability and wet heat durability.

### BACKGROUND OF THE INVENTION

1. Field of the Invention

The present invention relates to a cellulose ester film improved in point of the humidity stability and the wet heat durability thereof, and to a polarizer. Precisely, the invention relates to a cellulose ester film useful in liquid crystal display devices, which has a positive retardation in the thickness direction, has excellent humidity-dependent stability of the retardation in the thickness direction, and has excellent wet heat durability of the retardation in the thickness direction and the dimensional change resistance, to a polarizer produced by the use of the cellulose ester film, and to a liquid crystal display device comprising them.

2. Description of the Related Art

In general, a liquid crystal display device comprises a liquid crystal cell, an optically-compensatory film, and a polarizing element. The optically-compensatory film serves to cancel image coloration and to enlarge a viewing angle, including a stretched birefringent film and a film produced by coating a transparent film with a liquid crystal. For example, Japanese Patent No. 2587398 discloses a technique of applying an optically-compensatory film prepared by applying a discotic liquid crystal to a triacetyl cellulose film and aligning and fixing it thereon, to a TN-mode liquid crystal cell to thereby enlarge a viewing angle.

However, for a liquid crystal display device for TVs that are expected to be watched at various angles on a large-size panel, the requirement in point of the viewing angle dependence thereof is severe, and still could not be on a satisfactory level even though the above-mentioned technique is applied thereto. Accordingly, others than TN-mode liquid crystal display devices, such as IPS (in-plane switching) mode, OCB (optically compensatory bend) mode and VA (vertically aligned) mode devices are now under investigations. In particular, VA-mode devices have a high contrast and the production yield thereof is relatively high, and therefore they are now being in the mainstream of liquid crystal display devices for TV.

As the material of the polarizing element that is indispensable in a liquid crystal display device, in general, polyvinyl alcohol (hereinafter this may be referred to as “PVA”) is mainly used. A PVA film is monoaxially stretched and then colored with iodine or a dichroic dye, or after colored, it is stretched, and thereafter the resulting film is crosslinked with a boron compound to have a polarizing ability, and is used as a polarizing element.

For use that requires optical isotropy as in protective films for polarizers, cellulose ester films are generally used. This is based on the characteristics thereof in that cellulose ester films have a higher optical isotropy (having a lower retardation) as compared with other polymer films.

On the other hand, an optically-compensatory film (retardation film) in liquid crystal display devices is required to have an optical anisotropy (a high retardation) contrary to the above. Accordingly, as the optically-compensatory film, heretofore generally used are synthetic polymer films having a high retardation, such as polycarbonate films and polysulfone films.

Specifically, the general principle of optical members for use in liquid crystal display devices is that synthetic polymer films are used in case where the polymer films are required to have an optical anisotropy (a high retardation), but cellulose ester films are used in case where the films are required to have an optical isotropy (a low retardation).

In EP-A 911656, proposed is a cellulose acetate film having a high retardation which is applicable also to use that requires an optical anisotropy, contrary to the conventional general principle. In this proposal, an aromatic compound having at least two aromatic rings, especially a compound having 1,3,5-triazine rings is added to a cellulose triacetate film and the film is stretched to thereby realize a high retardation of the film. In general, cellulose triacetate is a hardly-stretchable polymer material, and it is known that the birefringence of the film is difficult to increase; however, the additive in the film is also oriented therein through the stretching treatment of the film, whereby the birefringence of the stretched film can be increased and a high retardation of the resulting film is thereby realized. The film can serve also as a protective film of a polarizer, and therefore has an advantage in that the necessary member films constituting a liquid crystal display device can be reduced and inexpensive and thin-body liquid crystal display devices can be provided.

Recently, use of liquid crystal display devices is increasing more and more, and the devices for outdoor use and those for in-car use are much increasing. Accordingly, liquid crystal display devices favorable for use in wet heat environments are being required. Therefore, member films having excellent humidity-dependent stability of the retardation in the thickness direction and having excellent wet heat durability of the retardation in the thickness direction and the dimensional change resistance are desired.

For enhancing the humidity-dependent stability of the retardation in the thickness direction of films regarding the above, proposed are a method of adding an additive or a saccharide ester having a specific structure (see WO2007/125764), and a method of adding a copolymer of styrene and any other component (see WO2007/119646). For enhancing the durability of dimensional change resistance in long-term use in wet heat environments, there is proposed a method of adding a styrene/maleic anhydride copolymer material having a negative birefringence (see JP-A 2007-304376) However, according to the methods of adding such additives, the durability of optical properties in long-term use in wet heat environments still could not be on a satisfactory level.

On the other hand, especially as a retardation film and a polarizer protective film for TN mode and VA mode devices, it is important to make the film express a positive retardation (Rth) in the thickness direction thereof. However, according to the methods of the above-mentioned Patent References, WO2007/119646 and JP-A 2007-304376, only films having a negative Rth could be obtained.

Accordingly, at present, it is still required to further develop a technique of producing a film of which the change in the optical properties is sufficiently minimized relative to the change in the ambient humidity and additionally which has excellent wet heat durability of the optical properties and the dimensional change resistance thereof that controls the display performance of display devices, and a polarizer comprising the film.

### SUMMARY OF THE INVENTION

The present inventors have found that the above-mentioned problems can be solved by using a cellulose ester film of which the degree of substitution falls within a specific range and by adding a specific additive to the film. Specifically, the inventors have invented a film having a positive Rth and having enhanced humidity stability and wet heat durability.

An object of the invention is to provide a cellulose ester film useful in liquid crystal display devices, which has a positive retardation in the thickness direction, has excellent humidity-dependent stability of the retardation in the thickness direction, and has excellent wet heat durability of the retardation in the thickness direction and the dimensional change resistance, to provide a polarizer produced by the use of the cellulose ester film, and to provide a liquid crystal display device comprising them.

The inventors have assiduously studied and, as a result, have provided the invention described below.

[1] A cellulose ester film comprising a cellulose ester having a total degree of substitution (DS) of at least 2.3 and a polymer X having a weight-average molecular weight of from 500 to 100000, wherein

the polymer X satisfies the following formula (1):

30%≦A≦100% (1)

wherein A indicates the polymerization ratio of a monomer whose homopolymer has a negative birefringence in the polymer X, and

the cellulose ester film has an Rth of more than 0 nm wherein the Rth indicates the retardation in the thickness direction of the film.

[2] The cellulose ester film of [1], wherein the polymer X satisfies the following formula (2):

30%≦B≦100% (2)

wherein B indicates the polymerization ratio of a monomer having at least one of a hydroxyl group or a carbonyl group in the polymer X.
[3] The cellulose ester film of [1] or [2], having an Rth of at least 40 nm (Rth≧40 nm).
[4] The cellulose ester film of any one of [1] to [3], wherein the total degree of substitution (DS) is 2.30≦DS≦2.80.
[5] The cellulose ester film of any one of [2] to [4], wherein at least one of the monomer whose homopolymer has a negative birefringence and the monomer having at least one of a hydroxyl group or a carbonyl group has an aromatic ring.
[6] The cellulose ester film of any one of [1] to [5], wherein the monomer whose homopolymer has a negative birefringence is a styrene derivative monomer.
[7] The cellulose ester film of any one of [2] to [6], wherein the monomer having at least one of a hydroxyl group or a carbonyl group is a monomer selected from the group consisting of hydroxystyrene, acetoxystyrene, vinylpyrrolidone, hydroxyacrylate, acrylic acid and hydroxymethacrylate.
[8] The cellulose ester film of any one of [2] to [7], wherein at least one of the monomer whose homopolymer has a negative birefringence and the monomer having at least one of a hydroxyl group or a carbonyl group has a phenyl group with a functional group at the ortho-position or the meta-position.
[9] The cellulose ester film of [8], wherein the phenyl group has a functional group only at the ortho-position or the meta-position.
[10] The cellulose ester film of any one of [1] to [9], which satisfies the following formula (3):

0≦|ΔRth(10-80)|≦20 nm (3)

wherein ΔRth(10-80) indicates a difference between Rth at 25° C. and 10% RH and Rth at 25° C. and 80% RH.
[11] The cellulose ester film of any one of [1] to [10], wherein the absolute value of the Rth change before and after 24 hours at 60° C. and 90% RH, ΔRth(60° C., 90% RH) is at most 15 nm.
[12] The cellulose ester film of anyone of [1] to [11], wherein the absolute value of the cellulose ester film dimensional change before and after 24 hours at 60° C. and 90% RH is at most 0.2%.
[13] The cellulose ester film of any one of [1] to [12], which contains at least one retardation enhancer.
[14] The cellulose ester film of any one of [1] to [13], wherein the cellulose ester is a cellulose acetate.
[15] A polarizer comprising the cellulose ester film of any one of [1] to [14].
[16] A liquid crystal display device comprising the cellulose ester film of any one of [1] to [14] or the polarizer of [15].

The cellulose ester film of the invention has a positive retardation in the thickness direction (hereinafter referred to as Rth), has excellent humidity-dependent stability of Rth, and has excellent wet heat durability of Rth and dimensional change resistance, and the film is useful in liquid crystal display devices. Using the film, a polarizer can be produced. Since the film has a positive and high Rth, it is favorable for TN mode and VA mode liquid crystal display devices.

### BEST MODE FOR CARRYING OUT THE INVENTION

Description will now be made in detail of the cellulose ester film according to the invention. Although the following description of its structural features may often be made on the basis of typical embodiments of the invention, it is to be understood that the invention is not limited to any such embodiment. It is also to be noted that every numerical range as herein expressed by employing the words “from” and “to”, or simply the word “to”, or the symbol “˜” is supposed to include the lower and upper limits thereof as defined by such words or symbol, unless otherwise noted.

### [Cellulose Ester]

The cellulose ester for use for the cellulose ester film of the invention is obtained through substitution of the hydroxyl group of the glucose unit that constitutes the cellulose ester, with an acyl group.

Cellulose used as a starting material in preparation for the cellulose ester used in the invention includes cotton linter and wood pulp (broadleaf pulp, coniferous pulp), etc. Any cellulose ester obtained from any of such a starting cellulose may be used. As the case may be, a mixture of different cellulose esters may also be used herein. The details of the cellulose as a starting material are described, for example, in “Plastic Material Lecture (17), Cellulosic Resin” (written by Marusawa, Uda, published by Nikkan Kogyo Shinbun-sha, 1970); and Hatsumei Kyokai Disclosure Bulletin 2001-1745 (pp. 7-8). Cellulose used in the cellulose ester film of the invention is not specifically limited.

### (Cellulose Ester)

Description will first be made in detail of the cellulose ester preferably used for the purpose of the invention. The glucose units having a β-1, 4 bond and forming the cellulose have free hydroxyl groups in the 2-, 3- and 6-positions thereof. The cellulose ester is a polymer obtained by esterifying a part or all of those hydroxyl groups with an acyl group Its acyl substitution degree means the total of the esterification degrees of cellulose in the 2-, 3- and 6-positions (an esterification degree of 100% meaning a substitution degree of

### (Degree of Substitution)

The total degree of substitution, DS, with an acyl group of the cellulose ester in the invention is at least 2.3. The invention is characterized in that an additive having a specific structure is added to the cellulose ester of which the total degree of substitution falls within the range, thereby greatly enhancing the wet heat durability of Rth and the dimensional change resistance of the cellulose ester film The total degree of substitution with an acyl group, DS is preferably 2.3≦DS≦2.95, more preferably 2.3≦DS≦2.8, even more preferably 2.35≦DS≦2.8. Having a total degree of substitution that falls within the range, the cellulose ester may have an increased miscibility with cellulose ester resins; and having such an increased miscibility, the film is hardly whitened even when the amount of the polymer X to be added thereto is increased, and therefore clear films are easy to obtain in the invention. In particular, within a range of 2.35≦DS≦2.8, the wet heat durability of Rth of the film can be greatly enhanced, and the display performance stability of liquid crystal display devices comprising the film can be enhanced further more. Preferably, DS6/ (DS2+DS3+DS6) is at least 0.08, more preferably at least 0.15, even more preferably from 0.2 to 0.45. DS2 is a degree of substitution with an acyl group of the 2-positioned hydroxyl group of the glucose unit constituting the cellulose ester (hereinafter this may be referred to as “degree of 2-position acyl substitution”); DS3 is a degree of substitution with an acyl group of the 3-positioned hydroxyl group (hereinafter this may be referred to as “degree of 3-position acyl substitution”); DS6 is a degree of substitution with an acyl group of the 6-positioned hydroxyl group (hereinafter this may be referred to as “degree of 6-position acyl substitution”). DS6/(DS2+DS3+DS6) indicates the ratio of the degree of 6-position acyl substitution to the total degree of substitution (hereinafter this may be referred to as “ratio of 6-position acyl substitution”).

### (Acyl Group)

One or more different types of acyl groups may be in the cellulose ester in the invention. Preferably, the cellulose ester film of the invention has a substituent of an acyl group having from 2 to 4 carbon atoms. In case where the ester film has two or more different types of acyl groups, preferably, one of them is an acetyl group. As the other acyl group having from 2 to 4 carbon atoms than the acetyl group, preferred are a propionyl group and a butyryl group. The sum total of the degree of substitution with an acetyl group of the 2-positioned, 3-positioned and 6-positioned hydroxyl groups is referred to as DSA; and the sum total of the degree of substitution with a propionyl or butyryl group of the 2-positioned, 3-positioned and 6-positioned hydroxyl groups is referred to as DSB. Preferably, the value of DSA+DSB is 2.3≦DSA+DSB≦2.6, more preferably 2.35≦DSA+DSB≦2.55, even more preferably 2.4≦DSA+DSB≦2.5. When DSA and DSB are specifically defined to fall within the above range, it is favorable since films of which Re and Rth change little depending on the ambient temperature, can be obtained.

Preferably, at least 5% of DSB is a degree of substitution of the 6-positioned hydroxyl group; more preferably at least 10% thereof is a degree of substitution of the 6-positioned hydroxyl group; even more preferably at least 20% thereof is a degree of substitution of the 6-positioned hydroxyl group; still more preferably at least 30% thereof is a degree of substitution of the 6-positioned hydroxyl group;

The acyl group in the cellulose used in the invention may be an aliphatic group or an aryl group, and are not particularly limited. They may be an alkylcarbonyl ester of cellulose, an alkenylcarbonyl ester of cellulose, an aromatic carbonyl ester of cellulose or an aromatic alkylcarbonyl ester of cellulose. These esters may have a substituent. Preferable examples of the substituents include an acetyl group, a propionyl group, a butanoyl group, a heptanoyl group, a hexanoyl group, an octanoyl group, a decanoyl group, a dodecanoyl group, a tridecanoyl group, a tetradecanoyl group, a hexadecanoyl group, an octadecanoyl group, an isobutanoyl group, a tert-butanoyl group, a cyclohexanecarbonyl group, an oleoyl group, a benzoyl group, a naphthylcarbonyl group and a cinnamoyl group. An acetyl group, a propionyl group, a butanoyl group, a dodecanoyl group, an octadecanoyl group, a tert-butanoyl group, an oleoyl group, a benzoyl group, a naphthylcarbonyl group and a cinnamoyl group are more preferred, and an acetyl group, a propionyl group and a butanoyl group are particularly preferred, and the most preferred is an acetyl group.

ID acylation of cellulose, when an acid anhydride or an acid chloride is used as the acylating agent, the organic solvent as the reaction solvent may be an organic acid, such as acetic acid, or methylene chloride or the like.

When the acylating agent is an acid anhydride, the catalyst is preferably a protic catalyst such as sulfuric acid; and when the acylating agent is an acid chloride (e.g., CH₃CH₂COCl), a basic compound may be used as the catalyst.

A most popular industrial production method for a mixed fatty acid ester of cellulose comprises acylating cellulose with a fatty acid corresponding to an acetyl group and other acyl groups (e.g., acetic acid, propionic acid, valeric acid, etc.), or with a mixed organic acid ingredient containing their acid anhydride.

The cellulose ester for use in the invention can be produced, for example, according to the method described in JP-A 10-45804.

### [High-Molecular-Weight Additive]

The film of the invention contains a high-molecular-weight additive including the polymer X to be described hereinunder.

The high-molecular-weight additive for use in the film of the invention is a compound having repetitive units therein, preferably having a number-average molecular weight of from 500 to 100000. The high-molecular-weight additive serves to promote the solvent vaporization speed and to reduce the residual solvent amount in a solution casting process. Also in the film produced according to a melt casting process, the high-molecular-weight additive is effective for preventing coloration and film strength depression. Further, the high-molecular-weight additive added to the film of the invention is effective from the viewpoint of reforming the film of, for example, enhancing the mechanical properties of the film, imparting flexibility and water absorption resistance to the film and reducing the moisture permeability of the film.

The high-molecular additive for use in the invention more preferably has a number-average molecular weight from 700 to less than 10000, further preferably from 800 to 8000, further more preferably from 800 to 5000, particularly preferably 1000 to 5000. The high-molecular additive having a number-average molecular weight in such range has higher compatibility with the cellulose ester.

Description will be made in detail of the high-molecular additives used in the invention with reference to the specific examples. However, the high-molecular additives used in the invention are not limited thereto.

The high-molecular-weight additive naturally includes the polymer X, and is preferably selected from polyester polymers, styrenic polymers, acrylic polymers and their copolymers, more preferably from aliphatic polyesters, aromatic polyesters, acrylic polymers and styrenic polymers. Also preferably, the additive contains at least one polymer having a negative intrinsic birefringence, such as styrenic polymers and acrylic polymers.

### Polyester-Type Polymers:

The polyester-type polymers for use in the invention is one produced by reaction of a mixture of an aliphatic dicarboxylic acid having from 2 to 20 carbon atoms and an aromatic dicarboxylic acid having from 8 to 20 carbon atoms, and a diol selected from the group consisting of aliphatic diols having from 2 to 12 carbon atoms, alkyl ether diols having from 4 to 20 carbon atoms and aromatic diols having from 6 to 20 carbon atoms, and both ends of the reaction product may be as such, or may be blocked by further reaction with a monocarboxylic acid or a monoalcohol. The terminal blocking may be effected for the reason that the absence of a free carboxylic acid in the plasticizer is effective for the storability of the plasticizer. The dicarboxylic acid for the polyester plasticizer for use in the invention is preferably an aliphatic dicarboxylic having from 4 to 20 carbon atoms, or an aromatic dicarboxylic acid having from 8 to 20 carbon atoms.

The aliphatic dicarboxylic acids having from 2 to 20 carbon atoms preferably for use in the film of the invention include, for example, oxalic acid, malonic acid, succinic acid, maleic acid, fumaric acid, glutaric acid, adipic acid, pimelic acid, suberic acid, azelaic acid, sebacic acid, dodecanedicarboxylic acid and 1,4-cyclohexanedicarboxylic acid.

The aromatic dicarboxylic acids preferably for use in the film of the invention having from 8 to 20 carbon atoms include phthalic acid, terephthalic acid, isophthalic acid, 1,5-naphthalene dicarboxylic acid, 1,4-naphthalene dicarboxylic acid, 1,8-naphthalene dicarboxylic acid, 2,8-naphthalene dicarboxylic acid and 2,6-naphthalene dicarboxylic acid etc.

More preferred aliphatic dicarboxylic acids in these are malonic acid, succinic acid, maleic acid, fumaric acid, glutaric acid, adipic acid, azelaic acid, 1,4-cyclohexanedicarboxylic acid. More preferred aromatic dicarboxylic acids in these are phthalic acid, terephthalic acid, isophthalic acid, 1,5-naphthalene dicarboxylic acid and 1,4-naphthalene dicarboxylic acid. Particularly preferred dicarboxylic acids are succinic acid, glutaric acid and adipic acid and particularly preferable aromatic dicarboxylic acids are phthalic acid, terephthalic acid and isophthalic acid.

In the invention, at least one kind of above-mentioned aliphatic dicarboxylic acid and at least one kind of the aromatic dicarboxylic acid are used in combination. The combination of these acids is not limited and several kinds of each ingredient may be used in combination.

The diol and the aromatic diol used for the high-molecular additive are selected, for example, from aliphatic diols having from 2 to 20 carbon atoms, alkyl ether diols having from 4 to 20 carbon atoms, and aromatic diols having from 6 to 20 carbon atoms.

Examples of the aliphatic diol having from 2 to 20 carbon atoms include an alkyldiol and an aliphatic diol. For example, an ethandiol, 1,2-propandiol, 1,3-propandiol, 1,2-butandiol, 1,3-butandiol, 2-methyl-1,3-propandiol, 1,4-butandiol, 1,5-pentandiol, 2,2-dimethyl-1,3-propandiol(neopentyl glycol), 2,2-diethyl-1,3-propandiol(3,3-dimethylolpentane), 2-n-buthyl-2-ethyl-1,3-propandiol(3,3-dimethylolheptane), 3-methyl-1,5-pentandiol, 1,6-hexandiol, 2,2,4-trimethyl-1,3-pentandiol, 2-ethyl-1,3-hexandiol, 2-methyl-1,8-octandiol, 1,9-nonandiol, 1,10-decandiol, 1,12-octadecandiol, etc. One or more of these glycols may be used either singly or as combined mixture.

Specific examples of preferred aliphatic diols include an ethandiol, 1,2-propandiol, 1,3-propandiol, 1,2-butandiol, 1,3-butandiol, 2-methyl-1,3-propandiol, 1,4-butandiol, 1,5-pentandiol, 3-methyl-1,5-pentandiol, 1,6-hexandiol, 1,4-cyclohexandiol, 1,4-cyclohexandimethanol. Particularly preferred examples include ethandiol, 1,2-propandiol, 1,3-propandiol, 1,2-butandiol, 1,3-butandiol, 1,4-butandiol, 1,5-pentandiol, 1,6-hexandiol, 1,4-cyclohexandiol, 1,4-cyclohexanedimethanol.

Specific examples of preferred alkyl ether diols having from 4 to 20 carbon atoms are polytetramethylene ether glycol, polyethylene ether glycol and polypropylene ether glycol, and combinations of these. The average degree of polymerization is not limited in particular, and it is preferably from 2 to 20, more preferably 2 to 10, further preferably from 2 to 5, especially preferably from 2 to 4. As these examples, Carbowax resin, Pluronics resin and Niax resin are commercially available as typically useful polyether glycols.

Specific examples of aromatic diols having from 6 to 20 carbon atoms, not limited, include Bisphenol A, 1,2-hydroxybenzene, 1,3-hydroxybenzene, 1,4-hydroxybenzene, 1,4-dimethylolbenzene, and preferably include bisphenol A, 1,4-hydroxybenzene and 1,4-dimethylolbenzene.

In the invention, especially preferred is a high-molecular additive of which the terminal is blocked with an alkyl group or an aromatic group. The terminal protection with a hydrophobic functional group is effective against aging at high temperature and high humidity, by which the hydrolysis of the ester group is retarded.

Preferably, the polyester plasticizer in the invention is protected with a monoalcohol residue or a monocarboxylic acid residue in order that both ends of the polyester plasticizer are not a carboxylic acid or a hydroxyl group. In this case, the monoalcohol residue is preferably a substituted or unsubstituted monoalcohol residue having from 1 to 30 carbon atoms, including, for example, aliphatic alcohols such as methanol, ethanol, propanol, isopropanol, butanol, isobutanol, pentanol, isopentanol, hexanol, isohexanol, cyclohexyl alcohol, octanol, isooctanol, 2-ethylhexyl alcohol, nonyl alcohol, isononyl alcohol, tert-nonyl alcohol, decanol, dodecanol, dodecahexanol, dodecaoctanol, allyl alcohol, oleyl alcohol; and substituted alcohols such as benzyl alcohol, 3-phenylpropanol.

Alcohol residues for terminal blocking that are preferred for use in the invention are methanol, ethanol, propanol, isopropanol, butanol, isobutanol, isopentanol, hexanol, isohexanol, cyclohexyl alcohol, isooctanol, 2-ethylhexyl alcohol, isononyl alcohol, oleyl alcohol, benzyl alcohol, more preferably methanol, ethanol, propanol, isobutanol, cyclohexyl alcohol, 2-ethylhexyl alcohol, isononyl alcohol, benzyl alcohol.

In blocking with a monocarboxylic acid residue, the monocarboxylic acid for use as the monocarboxylic acid residue is preferably a substituted or unsubstituted monocarboxylic acid having from 1 to 30 carbon atoms. It may be an aliphatic monocarboxylic acid or an aromatic monocarboxylic acid. Preferred aliphatic monocarboxylic acids are described. They include acetic acid, propionic acid, butanoic acid, caprylic acid, caproic acid, decanoic acid, dodecanoic acid, stearic acid, oleic acid. Preferred aromatic monocarboxylic acids are, for example, benzoic acid, p-tert-butylbenzoic acid, orthotoluic acid, metatoluic acid, paratoluic acid, dimethylbenzoic acid, ethylbenzoic acid, normal-propylbenzoic acid, aminobenzoic acid, acetoxybenzoic acid. One or more of these may be used either singly or as combined.

The high-molecular additive for use in the invention may be easily produced according to any of a thermal melt condensation method of polyesterification or interesterification of the above-mentioned dicarboxylic acid and diol and/or monocarboxylic acid or monoalcohol for terminal blocking, or according to an interfacial condensation method of an acid chloride of those acids and a glycol in an ordinary manner. The polyester additives are described in detail in Koichi Murai's “Additives, Their Theory and Application” (by Miyuki Publishing, first original edition published on Mar. 1, 1973). The materials described in JP-A 05-155809, 05-155810, 05-197073, 2006-259494, 07-330670, 2006-342227, 2007-003679 are also usable herein.

Specific examples of the polyester-type polymers for use in the invention are shown below, to which, however, the polyester-type polymers for the invention should not be limited.

TABLE 1

| | Dicarboxylic acid | | | Diol | | | Number |
|---|---|---|---|---|---|---|---|
| | Aromatic | Aliphatic | Dicarboxylic | | Diol | | average |
| | dicarboxylic | dicarboxylic | acid ratio | | ratio | | molecular |
| | acid | acid | (Mol %) | Aliphatic diol | (Mol %) | Ends of polymer | weight |
| P-1 | — | AA | 100 | Ethandiol | 100 | Hydroxyl group | 1000 |
| P-2 | — | AA | 100 | Ethandiol | 100 | Hydroxyl group | 2000 |
| P-3 | — | AA | 100 | Propandiol | 100 | Hydroxyl group | 2000 |
| P-4 | — | AA | 100 | Butandiol | 100 | Hydroxyl group | 2000 |
| P-5 | — | AA | 100 | Hexandiol | 100 | Hydroxyl group | 2000 |
| P-6 | — | AA/SA | 60/40 | Ethandiol | 100 | Hydroxyl group | 900 |
| P-7 | — | AA/SA | 60/40 | Ethandiol | 100 | Hydroxyl group | 1600 |
| P-8 | — | AA/SA | 60/40 | Ethandiol | 100 | Hydroxyl group | 1800 |
| P-9 | — | SA | 100 | Ethandiol | 100 | Hydroxyl group | 1500 |
| P-10 | — | SA | 100 | Ethandiol | 100 | Hydroxyl group | 2300 |
| P-11 | — | SA | 100 | Ethandiol | 100 | Hydroxyl group | 6000 |
| P-12 | — | SA | 100 | Ethandiol | 100 | Hydroxyl group | 1000 |
| P-13 | PA | SA | 50/50 | Ethandiol | 100 | Hydroxyl group | 1000 |
| P-14 | PA | SA | 50/50 | Ethandiol | 100 | Hydroxyl group | 1800 |
| P-15 | PA | AA | 50/50 | Ethandiol | 100 | Hydroxyl group | 2300 |
| P-16 | PA | SA/AA | 40/30/30 | Ethandiol | 100 | Hydroxyl group | 1000 |
| P-17 | PA | SA/AA | 50/20/30 | Ethandiol | 100 | Hydroxyl group | 1500 |
| P-18 | PA | SA/AA | 50/30/20 | Ethandiol | 100 | Hydroxyl group | 2600 |
| P-19 | TPA | SA | 50/50 | Ethandiol | 100 | Hydroxyl group | 1000 |
| P-20 | TPA | SA | 50/50 | Ethandiol | 100 | Hydroxyl group | 1200 |
| P-21 | TPA | AA | 50/50 | Ethandiol | 100 | Hydroxyl group | 2100 |
| P-22 | TPA | SA/AA | 40/30/30 | Ethandiol | 100 | Hydroxyl group | 1000 |
| P-23 | TPA | SA/AA | 50/20/30 | Ethandiol | 100 | Hydroxyl group | 1500 |
| P-24 | TPA | SA/AA | 50/30/20 | Ethandiol | 100 | Hydroxyl group | 2100 |
| P-25 | PA/TPA | AA | 15/35/50 | Ethandiol | 100 | Hydroxyl group | 1000 |
| P-26 | PA/TPA | AA | 20/30/50 | Ethandiol | 100 | Hydroxyl group | 1000 |
| P-27 | PA/TPA | SA/AA | 15/35/20/30 | Ethandiol | 100 | Hydroxyl group | 1000 |
| P-28 | PA/TPA | SA/AA | 20/30/20/30 | Ethandiol | 100 | Hydroxyl group | 1000 |
| P-29 | PA/TPA | SA/AA | 10/50/30/10 | Ethandiol | 100 | Hydroxyl group | 1000 |
| P-30 | PA/TPA | SA/AA | 5/45/30/20 | Ethandiol | 100 | Hydroxyl group | 1000 |
| P-31 | — | AA | 100 | Ethandiol | 100 | Acetyl ester residue | 1000 |
| P-32 | — | AA | 100 | Ethandiol | 100 | Acetyl ester residue | 2000 |
| P-33 | — | AA | 100 | Propandiol | 100 | Acetyl ester residue | 2000 |
| P-34 | — | AA | 100 | Butandiol | 100 | Acetyl ester residue | 2000 |
| P-35 | — | AA | 100 | Hexandiol | 100 | Acetyl ester residue | 2000 |
| P-36 | — | AA/SA | 60/40 | Ethandiol | 100 | Acetyl ester residue | 900 |

TABLE 2

| | Dicarboxylic acid | | | Diol | | | Number |
|---|---|---|---|---|---|---|---|
| | Aromatic | Aliphatic | Dicarboxylic | | Diol | | average |
| | dicarboxylic | dcarboxylic | acid ratio | | ratio | | molecular |
| | acid | acid | (Mol %) | Aliphatic diol | (Mol %) | Ends of polymer | weight |
| P-37 | — | AA/SA | 60/40 | Ethandiol | 100 | Acetyl ester residue | 1000 |
| P-38 | — | AA/SA | 60/40 | Ethandiol | 100 | Acetyl ester residue | 2000 |
| P-39 | — | SA | 100 | Ethandiol | 100 | Acetyl ester residue | 1000 |
| P-40 | — | SA | 100 | Ethandiol | 100 | Acetyl ester residue | 3000 |
| P-41 | — | SA | 100 | Ethandiol | 100 | Acetyl ester residue | 5500 |
| P-42 | — | SA | 100 | Ethandiol | 100 | Acetyl ester residue | 1000 |
| P-43 | PA | SA | 50/50 | Ethandiol | 100 | Acetyl ester residue | 1000 |
| P-44 | PA | SA | 50/50 | Ethandiol | 100 | Acetyl ester residue | 1500 |
| P-45 | PA | AA | 50/50 | Ethandiol | 100 | Acetyl ester residue | 2000 |
| P-46 | PA | SA/AA | 40/30/30 | Ethandiol | 100 | Acetyl ester residue | 1000 |
| P-47 | PA | SA/AA | 33/33/34 | Ethandiol | 100 | Benzoic acid residue | 1000 |
| P-48 | PA | SA/AA | 50/20/30 | Ethandiol | 100 | Acetyl ester residue | 1500 |
| P-49 | PA | SA/AA | 50/30/20 | Ethandiol | 100 | Acetyl ester residue | 2000 |
| P-50 | TPA | SA | 50/50 | Ethandiol | 100 | Acetyl ester residue | 1000 |
| P-51 | TPA | SA | 50/50 | Ethandiol | 100 | Acetyl ester residue | 1500 |
| P-52 | TPA | SA | 45/55 | Ethandiol | 100 | Acetyl ester residue | 1000 |
| P-53 | TPA | AA | 50/50 | Ethandiol | 100 | Acetyl ester residue | 2200 |
| P-54 | TPA | SA | 35/65 | Ethandiol | 100 | Acetyl ester residue | 1000 |
| P-55 | TPA | SA/AA | 40/30/30 | Ethandiol | 100 | Acetyl ester residue | 1000 |
| P-56 | TPA | SA/AA | 50/20/30 | Ethandiol | 100 | Acetyl ester residue | 1500 |
| P-57 | TPA | SA/AA | 50/30/20 | Ethandiol | 100 | Acetyl ester residue | 2000 |
| P-58 | TPA | SA/AA | 20/20/60 | Ethandiol | 100 | Acetyl ester residue | 1000 |
| P-59 | PA/TPA | AA | 15/35/50 | Ethandiol | 100 | Acetyl ester residue | 1000 |
| P-60 | PA/TPA | AA | 25/25/50 | Ethandiol | 100 | Acetyl ester residue | 1000 |
| P-61 | PA/TPA | SA/AA | 15/35/20/30 | Ethandiol | 100 | Acetyl ester residue | 1000 |
| P-62 | PA/TPA | SA/AA | 20/30/20/30 | Ethandiol | 100 | Acetyl ester residue | 1000 |
| P-63 | PA/TPA | SA/AA | 10/50/30/10 | Ethandiol | 100 | Acetyl ester residue | 1000 |
| P-64 | PA/TPA | SA/AA | 5/45/30/20 | Ethandiol | 100 | Acetyl ester residue | 1000 |
| P-65 | PA/TPA | SA/AA | 5/45/20/30 | Ethandiol | 100 | Acetyl ester residue | 1000 |
| P-66 | IPA | AA/SA | 20/40/40 | Ethandiol | 100 | Acetyl ester residue | 1000 |
| P-67 | 2,6-NPA | AA/SA | 20/40/40 | Ethandiol | 100 | Acetyl ester residue | 1200 |
| P-68 | 1,5-NPA | AA/SA | 20/40/40 | Ethandiol | 100 | Acetyl ester residue | 1200 |
| P-69 | 1,4-NPA | AA/SA | 20/40/40 | Ethandiol | 100 | Acetyl ester residue | 1200 |
| P-70 | 1,8-NPA | AA/SA | 20/40/40 | Ethandiol | 100 | Acetyl ester residue | 1200 |
| P-71 | 2,8-NPA | AA/SA | 20/40/40 | Ethandiol | 100 | Acetyl ester residue | 1200 |

In Table 1 and Table 2, PA is phthalic acid, TPA is terephthalic acid, IPA is isophthalic acid, AA is adipic acid, SA is succinic acid, 2,6-NPA is 2,6-naphthalenedicarboxylic acid, 2,8-NPA is 2,8-naphthalenedicarboxylic acid, 1,5-NPA is 1,5-naphthalenedicarboxylic acid, 1,4-NPA is 1,4-naphthalenedicarboxylic acid, 1,8-NPA is 1,8-naphthalenedicarboxylic acid.

### [Polymer X]

The polymer X which the cellulose ester film of the invention contains is described below.

The polymer X satisfies 30%≦A≦100%, in which A indicates the polymerization ratio of a monomer in the polymer X, and wherein the homopolymer of the monomer has a negative birefringence.

So far as the polymer X in the invention satisfies 30%≦A≦100%, in which A indicates the polymerization ratio of a monomer in the polymer X, and wherein the homopolymer of the monomer has a negative birefringence, the polymer X may be a homopolymer or a copolymer of the above-mentioned monomer having at least one of a hydroxyl group or a carbonyl group. Not overstepping the scope and the sprit of the invention, the polymer X in the invention may a copolymer of a monomer, of which the homopolymer has a negative birefringence, and any other monomer than the monomer having at least one of a hydroxyl group or a carboxyl group. In case where the polymer X is a copolymer, it may be a block copolymer or a random copolymer.

### (Monomer Ingredient)

The monomer, of which the homopolymer has a negative birefringence, and the monomer having at least one of a hydroxyl group or a carbonyl group are described below.

Preferably, at least one of the monomer, of which the homopolymer has a negative birefringence, or the monomer having at least one of a hydroxyl group or a carbonyl group has an aromatic ring.

(Monomer of which the Homopolymer has a Negative Birefringence)

The polymerization ratio (A) is 30%≦A≦100%, preferably 40%≦A≦100%. When the polymerization ratio (A) is 30%≦A≦100%, then the polymer X may express a sufficient negative birefringence; and when the polymer X is added to the cellulose ester film of the invention, the humidity dependence of the film may be reduced and the wet heat durability thereof may be enhanced.

The monomer of which the homopolymer has a negative birefringence is described in more detail. The monomer of which the homopolymer has a negative birefringence for use in the invention is not specifically defined.

The monomer of which the homopolymer has a negative birefringence includes, for example, aromatic ring-having monomers and ethylenic unsaturated monomers such as acrylic monomers, cellulose benzoate monomers, styrenic monomers, etc. Of those, preferred are acrylic monomers, styrenic derivative monomers and vinylpyrrolidone monomers; and from the viewpoint of the miscibility thereof, more preferred are styrenic derivative monomers and vinylpyrrolidone, and most preferred are styrenic derivative monomers.

The styrenic monomers (and styrenic derivative monomers) are preferably aromatic vinylic monomers represented by the following formula (1):

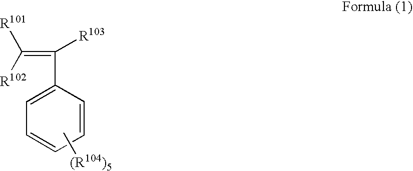

wherein R¹⁰¹ to R¹⁰⁴ each independently represent a hydrogen atom, a halogen atom, or a substituted or unsubstituted hydrocarbon group having from 1 to 30 carbon atoms and optionally having a linking group containing an oxygen atom, a sulfur atom, a nitrogen atom or a silicon atom, or a polar group; R¹⁰⁴'s may be all the same atoms or groups, or may be different atoms or groups, and they may bond to each other to form a carbon ring or a hetero ring (the carbon ring or the hetero ring may have a monocyclic structure or may have a polycyclic structure condensed with any other ring).

Specific examples of the aromatic vinylic monomer include styrene; alkyl-substituted styrenes such as α-methylstyrene, β-methylstyrene, p-methylstyrene; halogen-substituted styrenes such as 4-chlorostyrene, 4-bromostyrene; hydroxystyrenes such as p-hydroxystyrene, α-methyl-p-hydroxystyrene, 2-methyl-4-hydroxystyrene, 3,4-dihydroxystyrene; vinylbenzyl alcohols; alkoxy-substituted styrenes such as p-methoxystyrene, p-tert-butoxystyrene, m-tert-butoxystyrene; vinylbenzoic acids such as 3-vinylbenzoic acid, 4-vinylbenzoic acid; vinylbenzoates such as methyl 4-vinylbenzoate, ethyl 4-vinylbenzoate; 4-vinylbenzyl acetate; 4-acetoxystyrene; amidestyrenes such as 2-butylamidostyrene, 4-methylamidestyrene, p-sulfonamidestyrene; aminostyrenes such as 3-aminostyrene, 4-aminostyrene, 2-isopropenylaniline, vinylbenzyldimethylamine; nitrostyrenes such as 3-nitrostyrene, 4-nitrostyrene; cyanostyrenes such as 3-cyanostyrene, 4-cyanostyrene; vinylphenylacetonitrile; arylstyrenes such as phenylstyrene; indenes, etc. However, the invention should not be limited to these examples. Two or more different such monomers may be copolymerized to give copolymers for use herein.

The acrylic monomers are preferably acrylate monomers of the following formula (2):

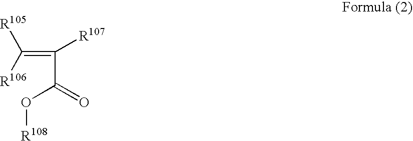

wherein R¹⁰⁵ to R¹⁰⁸ each independently represent a hydrogen atom, a halogen atom, or a substituted or unsubstituted hydrocarbon group having from 1 to 30 carbon atoms optionally having a linking group containing an oxygen atom, a sulfur atom, a nitrogen atom or a silicon atom, or a polar group.

Examples of the acrylate monomers include, for example, methyl acrylate, ethyl acrylate, (i-, n-)propyl acrylate, (n-, i-, s-, tert-)butyl acrylate, (n-, i-, s-)pentyl acrylate, (n-, i-)hexyl acrylate, (n-, l-)heptyl acrylate, (n-, i-)octyl acrylate, (n-, i-)nonyl acrylate, (n-, i-)myristyl acrylate, (2-ethylhexyl)acrylate, (ε-caprolactone)acrylate, (2-hydroxyethyl)acrylate, (2-hydoxypropyl)acrylate, (3-hydroxypropyl acrylate, (4-hydroxybutyl)acrylate, (2-hydroxybutyl)acrylate, (2-methoxyethyl)acrylate, (2-ethoxyethyl)acrylate, phenyl acrylate, phenyl methacrylate, (2 or 4-chlorophenyl)acrylate, (2 or 4-chlorophenyl)methacrylate, (2 or 3 or 4-ethoxycarbonylphenyl)acrylate, (2 or 3 or 4-ethoxycarbonylphenyl)methacrylate, (o or m or p-tolyl)acrylate, (o or m or p-tolyl)methacrylate, benzyl acrylate, benzyl methacrylate, phenethyl acrylate, phenethyl methacrylate, (2-naphthyl)acrylate, cyclohexyl acrylate, cyclohexyl methacrylate, (4-methylcyclohexyl)acrylate, (4-methylcyclohexyl)methacrylate, (4-ethylcyclohexyl)acrylate, (4-ethylcyclohexyl)methacrylate, and methacrylates corresponding to the above-mentioned acrylates. However, the invention should not be limited to these examples. Two or more such monomers may be copolymerized into copolymers for use herein. Of those, preferred are methyl acrylate, ethyl acrylate, (i-, n-)propyl acrylate, (n-, i-, s-, tert-)butyl acrylate, (n-, i-, s-)pentyl acrylate, (n-, i-)hexyl acrylate, and methacrylates corresponding to these acrylates, from the viewpoint that they are easily available industrially and are inexpensive.

As the copolymer for use herein, preferred are those produced from an aromatic vinylic monomer of the following formula (1) and an acrylate monomers of the following formula (2):

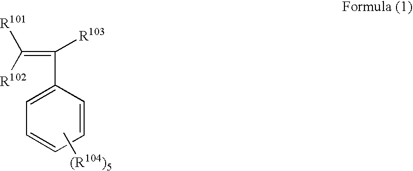

wherein R¹⁰¹ to R¹⁰⁴ each independently represent a hydrogen atom, a halogen atom, or a substituted or unsubstituted hydrocarbon group having from 1 to 30 carbon atoms and optionally having a linking group containing an oxygen atom, a sulfur atom, a nitrogen atom or a silicon atom, or a polar group; R¹⁰⁴'s may be all the same atoms or groups, or may be different atoms or groups, and they may bond to each other to form a carbon ring or a hetero ring (the carbon ring or the hetero ring may have a monocyclic structure or may have a polycyclic structure condensed with any other ring).

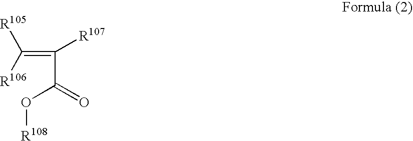

wherein R¹⁰⁵ to R¹⁰⁸ each independently represent a hydrogen atom, a halogen atom, or a substituted or unsubstituted hydrocarbon group having from 1 to 30 carbon atoms optionally having a linking group containing an oxygen atom, a sulfur atom, a nitrogen atom or a silicon atom, or a polar group. As the other structure than the above to constitute the copolymer composition, preferred are those excellent in the copolymerizability with the above-mentioned monomers, and their examples include acid anhydrides such as maleic anhydride, citraconic anhydride, cis-1-cyclohexene-1,2-dicarboxylic acid anhydride, 3-methyl-cis-1-cyclohexene-1,2-dicarboxylic acid anhydride, 4-methyl-cis-1-cyclohexene-1,2-dicarboxylic acid anhydride; nitrile group-containing radical-polymerizable monomers such as acrylonitrile, methacrylonitrile; amide bond-containing radical-polymerizable monomers such as acrylamide, methacrylamide, trifluoromethanesulfonylaminomethyl(meth)acrylate; aliphatic vinyls such as vinyl acetate; chlorine-containing radical-polymerizable monomers such as vinyl chloride, vinylidene chloride; conjugated diolefins such as 1,3-butadiene, isoprene, 1,4-dimethylbutadiene, etc. However, the invention should not be limited to these examples. Of those, especially preferred are styrene/maleic anhydride copolymers.

When the monomer of which the homopolymer has a negative birefringence is a styrenic derivative monomer, preferably, the phenyl group in the monomer has a substituent. The substituent is preferably an alkyl group, a halogen atom, an alkoxy group, a carboxyl group including an acetoxy group, an amino group, a nitro group, a cyano group, an aryl group, a hydroxyl group, a carbonyl group or the like, more preferably a hydroxyl group, a carbonyl group or an acetoxy group, even more preferably a hydroxyl group or an acetoxy group. The phenyl group may be substituted with one or more such substituents, in which the substituent may be further substituted.

The phenyl group in the monomer, of which the homopolymer has a negative birefringence, may be substituted with the above-mentioned substituent at any position thereof, but is preferably substituted at the ortho- or meta-position from the viewpoint of retarding the humidity dependence of the film. More preferably, the phenyl group has a functional group at only the ortho- or meta-position thereof from the viewpoint of more effectively retarding the humidity dependence of the film.

In the styrenic derivative monomer, the phenyl group may be condensed with any other aromatic ring; or the monomer may be in the form of indenes or indanes where the substituent forms any other ring than the phenyl group therein; or the monomer may have a crosslinked structure.

In case where the monomer of which the homopolymer has a negative birefringence is not a styrenic derivative monomer, then it may have or may not have a substituent; however, in case where the monomer has an oxygen atom-containing substituent, preferably, the substituent is fixed in the cyclic structure to be nearly in parallel to the main chain of the polymer X from the viewpoint of increasing the negative birefringence of the polymer.

Specific examples of the monomer of which the homopolymer has a negative birefringence include styrene; alkyl-substituted styrenes such as α-methylstyrene, β-methylstyrene, p-methylstyrene; halogen-substituted styrenes such as 4-chlorostyrene, 4-bromostyrene; hydroxystyrenes such as p-hydroxystyrene, α-methyl-p-hydroxystyrene, 2-methyl-4-hydroxystyrene, 3,4-dihydroxystyrene; vinylbenzyl alcohols; alkoxy-substituted styrenes such as p-methoxystyrene, p-tert-butoxystyrene, m-tert-butoxystyrene; vinylbenzoic acids such as 3-vinylbenzoic acid, 4-vinylbenzoic acid; vinylbenzoates such as methyl 4-vinylbenzoate, ethyl 4-vinylbenzoate; 4-vinylbenzyl acetate; 4-acetoxystyrene; amidestyrenes such as 2-butylamidostyrene, 4-methylamidestyrene, p-sulfonamidestyrene; aminostyrenes such as 3-aminostyrene, 4-aminostyrene, 2-isopropenylaniline, vinylbenzyldimethylamine; nitrostyrenes such as 3-nitrostyrene, 4-nitrostyrene; cyanostyrenes such as 3-cyanostyrene, 4-cyanostyrene; vinylphenylacetonitrile; arylstyrenes such as phenylstyrene; indenes, vinylpyrrolidone, etc. However, the invention should not be limited to these examples. Of those, preferred are styrene, hydroxystyrene, acetoxystyrene and vinylpyrrolidone; and more preferred are styrene, m-hydroxystyrene, o-hydroxystyrene, m-acetoxystyrene, o-acetoxystyrene and vinylpyrrolidone.

(Monomer having at Least One of Hydroxyl Group or Carbonyl Group)

Preferably, the polymer X contains a monomer having at least one of a hydroxyl group or a carbonyl group.

The polymerization ratio of the monomer having at least one of a hydroxyl group or a carbonyl group in the polymer X is not specifically defined. Preferably, the polymerization ratio (B) of the monomer is within a range of 30%≦B≦100%, more preferably 35%≦B≦100%, even more preferably 40%≦B≦100%.

When the polymerization ratio B is 30%≦B≦100%, then the polymer is favorable as having a good miscibility with cellulose acetate.

The monomer having at least one of a hydroxyl group or a carbonyl group is described in detail. The monomer having at least one of a hydroxyl group or a carbonyl group for use in the invention is not specifically defined.

The ethylenic unsaturated monomer unit having a hydroxyl group or a carbonyl group includes, for example, vinyl alcohol monomer, vinyl acetate monomer, maleic acid monomer, maleic anhydride monomer, methyl methacrylate, styrenic derivative monomers, etc. Of those, preferred are acrylic monomers, styrenic derivative monomers and vinylpyrrolidone monomers; and from the viewpoint of the miscibility of the polymer, more preferred is at least one selected from a group consisting of hydroxystyrene, acetoxystyrene, vinylpyrrolidone, hydroxyacrylate, acrylic acid and hydroxymethacrylate.

In case where the monomer having at least one of a hydroxyl group or a carbonyl group is a styrenic derivative monomer, preferably, the phenyl group in the monomer has a substituent. The substituent includes a methyl group, a chlorine atom, a bromine atom, a dihydroxy group, a nitro group, an amino group, a sulfone group, a cyano group, a hydroxyl group, a carbonyl group, an acetoxy group, etc.; and preferred are an amino group, a hydroxyl group, a carbonyl group and an acetoxy group; more preferred are a hydroxyl group, a carbonyl group and an acetoxy group. The phenyl group may have one or more such substituents.

In the monomer having at least one of a hydroxyl group or a carbonyl group, the phenyl group may be substituted with the above-mentioned substituent at any position thereof, but is preferably substituted at the ortho- or meta-position from the viewpoint of retarding the humidity dependence of the film. More preferably, the phenyl group has a functional group at only the ortho- or meta-position thereof from the viewpoint of more effectively retarding the humidity dependence of the film.

In case where the monomer having at least one of a hydroxyl group or a carbonyl group is not a styrenic derivative monomer, then it may have or may not have a substituent; however, in case where the monomer has an oxygen atom-containing substituent, preferably, the substituent is fixed in the cyclic structure to be nearly in parallel to the main chain of the polymer X from the viewpoint of increasing the negative birefringence of the polymer.

Specific examples of the monomer having at least one of a hydroxyl group or a carbonyl group include vinyl alcohol monomer, vinyl acetate monomer, maleic acid monomer, maleic anhydride monomer, methyl methacrylate, hydroxystyrene, acetoxystyrene, vinylpyrrolidone, hydroxyacrylate, acrylic acid, methacrylic acid and hydroxymethacrylate, to which, however, the invention should not be limited. Of those, preferred are hydroxystyrene, acetoxystyrene, vinylpyrrolidone, hydroxyacrylate, acrylic acid and hydroxymethacrylate; and more preferred are acrylic acid, m-hydroxystyrene, o-hydroxystyrene, m-acetoxystyrene, o-acetoxystyrene, vinylpyrrolidone, hydroxyacrylate, acrylic acid and hydroxymethacrylate.

Preferably, at least one of the monomer of which the homopolymer has a negative birefringence and the monomer having at least one of a hydroxyl group or a carbonyl group has a benzene ring, in which, preferably, the benzene ring has a functional group at the ortho- or meta-position thereof.

More preferably, the benzene ring has a functional group only at the ortho-position or the meta-position thereof.

### (Other Monomers)

The other monomers are not specifically defined. For example, they include acrylic acid, methacrylic acid, alkyl acrylate (e.g., methyl acrylate, ethyl acrylate), alkyl methacrylate (e.g., methyl methacrylate, ethyl methacrylate), aminoalkyl acrylate (e.g., diethylaminoethyl acrylate), aminoalkyl methacrylate, monoester of acrylic acid and glycol, monoester of methacrylic acid and glycol (e.g., hydroxyethyl methacrylate), alkali metal salt of acrylic acid, alkali metal salt of methacrylic acid, ammonium salt of acrylic acid, ammonium salt of methacrylic acid, quaternary ammonium derivative of aminoalkyl acrylate, quaternary ammonium derivative of aminoalkyl methacrylate, quaternary ammonium compound of diethylaminoethyl acrylate and methyl sulfate, vinyl methyl ether, vinyl ethyl ether, alkali metal salt of vinylsulfonic acid, ammonium salt of vinylsulfonic acid, styrenesulfonic acid, styrenesulfonic acid salt, allylsulfonic acid, allylsulfonic acid salt, methallylsulfonic acid, methallylsulfonic acid salt, vinyl acetate, vinyl stearate, N-vinylimidazole, N-vinylacetamide, N-vinylformamide, N-vinylcaprolactam, N-vinylcarbazole, acrylamide, methacrylamide, N-alkylacrylamide, N-methylolacrylamide, N,N-methylenebisacrylamide, glycol diacrylate, glycol dimethacrylate, divinylbenzene, glycol diallyl ether, etc.

### (Composition of Polymer X)

In this description, the polymerization ratio (A) of the monomer of which the homopolymer has a negative birefringence, and the polymerization ratio (B) of the monomer having at least one of a hydroxyl group or a carbonyl group may be computed as doubled. For example, the polymer X may be a homopolymer of a monomer of which the homopolymer has a negative birefringence and which has at least one of a hydroxyl group or a carbonyl group. In this case, the polymerization ratio A is 100%, and the polymerization ratio B is also 100%. Specifically, the polymerization ratio A and the polymerization ratio B are to define the proportion of the monomer ingredient having a specific effect in the overall polymer X from two different viewpoints.

Regarding the combination of the polymerization ratio A and the polymerization ratio B, preferably, the polymer X satisfies the above formula (1), and more preferably satisfies both the formula (1) and the formula (2).

30%≦A≦100% (1)

30%≦B≦100% (2)

More preferably, the polymer X satisfies both the following formulae (4) and (5), most preferably both the following formulae (6) and (7):

35%≦A≦100% (4)

35%≦B≦100% (5)

40%≦A≦100% (6)

40%≦B≦100% (7)

Regarding the composition of the polymer X, preferred is an embodiment where the polymer X comprises only a monomer of which the homopolymer has a negative birefringence, or an embodiment where the polymer X comprises a monomer of which the homopolymer has a negative birefringence and a monomer having at least one of a hydroxyl group or a carbonyl group, from the viewpoint of retarding the humidity dependence and enhancing the wet heat durability of the cellulose ester film of the invention.

On the other hand, from the viewpoint of enhancing the miscibility with cellulose ester resin, the polymer X may be a copolymer containing any other monomer as in the above. In case where the degree of substitution of the cellulose ester resin is high, the cellulose ester resin is more hydrophobic, and therefore, it is desirable that the polymer X is copolymerized with any other monomer in such a controlled manner that the degree of hydrophobicity of the resulting copolymer could be increased, thereby enhancing the miscibility of the copolymer with the resin. On the contrary, in cases where the degree of substitution of the cellulose ester resin is low, then the cellulose ester resin is poorly hydrophobic, and therefore, it is desirable that the polymer X is copolymerized with any other monomer in such a controlled manner that the degree of hydrophobicity of the resulting copolymer could be lowered, thereby enhancing the miscibility of the copolymer with the resin.

In case where the polymer X is a homopolymer of the monomer of which the homopolymer has a negative birefringence, the monomer of which the homopolymer preferably has a negative birefringence may have a hydroxyl group or a carboxyl group from the viewpoint of increasing the Rth of the film. Specifically, it is desirable that the polymerization ratio A in the polymer X is A=100%, and the polymerization B therein is 0%<B≦100%. In case where the polymer X is a homopolymer of the monomer of which the homopolymer has a negative birefringence, it is preferably a homopolymer of m-hydroxystyrene, o-hydroxystyrene, m-acetoxystyrene, o-acetoxystyrene or vinylpyrrolidone.

In case where the polymer X is a copolymer, preferred monomer combinations are as follows: One monomer is at least one selected from a group consisting of styrene, m-hydroxystyrene, o-hydroxystyrene, p-hydroxystyrene, m-acetoxystyrene, o-acetoxystyrene, p-acetoxystyrene and vinylpyrrolidone; and the other monomer is at least one selected from a group consisting of acrylic acid, m-hydroxystyrene, o-hydroxystyrene, p-hydroxystyrene, m-acetoxystyrene, o-acetoxystyrene, p-acetoxystyrene and vinylpyrrolidone. More preferred monomer combinations are as follows: One monomer is at least one selected from a group consisting of styrene, m-hydroxystyrene, o-hydroxystyrene, m-acetoxystyrene, o-acetoxystyrene and vinylpyrrolidone; and the other monomer is at least one selected from a group consisting of acrylic acid, m-hydroxystyrene, o-hydroxystyrene, m-acetoxystyrene, o-acetoxystyrene and vinylpyrrolidone.

### (Weight-Average Molecular Weight)

The weight-average molecular weight of the polymer X is from 500 to 100,000. Preferably, the weight-average molecular weight of the polymer X is from 700 to 50,000, more preferably from 1,000 to 25,000.

Having a molecular weight of at least 500, the polymer X is well evaporative; while having a molecular weight of at most 100,000, the miscibility of the polymer X with cellulose ester resin is good; and both are favorable.

### (Amount of Addition)

The amount of the polymer X to be added is preferably from 0.5 to 30 parts by mass relative to 100 parts by mass of the cellulose ester resin, more preferably from 1 to 20 parts by mass, even more preferably from 2 to 15 parts by mass. When the amount of the polymer X to be added is at most 30 parts by mass, then its advantage is that the film secures retardation expression; and when the amount is at least 1 part by mass, its advantage is that the wet heat durability of the film is greatly enhanced.

### [Low-Molecular-Weight Additive]

The low-molecular-weight additive for use herein includes retardation enhancer, antiaging agent, UV inhibitor, release promoter, other plasticizer, IR absorbent, etc. These may be solid or oily. In other words, they are not specifically defined in point of the melting point and the boiling point thereof For example, UV absorbent materials at not lower than 20° C. and lower than 20° C. are mixed, or antiaging agents are similarly mixed. IR absorbent dyes are described in, for example, JP-A 2001-194522. Regarding timing of addition, the additive may be added in any stage of a process of producing a cellulose ester solution (dope), or in the final stage of the dope production process, the additive may be added to the dope. The amount of the material is not specifically defined so far as the material could exhibit its function.

### (Retardation Enhancer)

Preferably in the invention, a retardation enhancer is added to the film for making the film have a retardation. The retardation enhancer for use in the invention includes rod-shaped or discotic compounds. Of the rod-shaped or discotic compounds, those having at least two aromatic groups are preferred for use as the retardation enhancer in the invention.

The amount of the retardation enhancer of a rod-shaped compound to be added is preferably from 0.1 to 30 parts by mass relative to 100 parts by mass of the cellulose ester-containing polymer ingredient, more preferably from 0.5 to 20 parts by mass.

Preferably, the amount of a discotic retardation enhancer to be added is preferably from 0.05 to 20 parts by mass relative to 100 parts by mass of the cellulose ester resin, more preferably from 1.0 to 15 parts by mass, even more preferably from 3.0 to 10 parts by mass.

A discotic compound is superior to a rod-shaped compound as an Rth retardation enhancer, and is therefore favorably used in ace where the film requires an especially large Rth retardation. Two or more different types of retardation enhancers may be used, as combined.

Preferably, the retardation enhancer has a maximum absorption in a wavelength range of from 250 to 400 nm, and preferably, it does not have substantial absorption in a visible light region.

Description will be given about the discotic compound. As the discotic compound, a compound having at least two aromatic rings can be employed.

In the specification, an “aromatic ring” includes an aromatic heteroring, in addition to an aromatic hydrocarbon ring.

The aromatic hydrocarbon ring is particularly preferably a 6-membered ring (that is, benzene ring). Generally, the aromatic heteroring is an unsaturated heteroring. The aromatic heteroring is preferably a 5-membered ring, 6-membered ring or a 7-membered ring, more preferably a 5-membered ring or a 6-membered ring. Generally, the aromatic heteroring has the largest number of double bonds. As hetero atoms, a nitrogen atom, an oxygen atom and a sulfur atom are preferred, and a nitrogen atom is particularly preferred. Examples of the aromatic heteroring include a furan ring, a thiophene ring, a pyrrole ring, an oxazole ring, an iso-oxazole ring, a thiazole ring, an iso-thiazole ring, an imidazole ring, a pyrazole ring, a furazane ring, a triazole ring, a pyran ring, a pyridine ring, a pyridazine ring, a pyrimidine ring, a pyrazine ring and a 1,3,5-triazine ring.

As the aromatic ring, a benzene ring, a condensed benzene ring, biphenol and a 1,3,5-triazine ring are used preferably, and, in particular, a 1,3,5-triazine ring is preferably used. Specifically, compounds, for example, disclosed in JP-A-2001-166144 are used preferably as a discotic compound.

Number of aromatic rings included in the retardation enhancer is preferably 2-20, more preferably 2-12, furthermore preferably 2-8, most preferably 2-6.

Bond relation of two aromatic rings can be classified into following cases (since an aromatic ring, a spiro bond can not be formed): (a) formation of a condensed ring, (b) formation of a direct bond by a single bond, and (c) formation of a bond via a linking group. The bond relation may be any one of (a)-(c).

Examples of the (a) condensed ring (a condensed ring of two or more of aromatic rings) include an indene ring, a naphthalene ring, an azulene ring, a fluorene ring, a phenanthrene ring, an anthracene ring, an acenaphthylene ring, an biphenylene ring, a naphthacene ring, a pyrene ring, an indole ring, an iso-indole ring, a benzofuran ring, a benzothiophene ring, an indolizine ring, a benzoxazole ring, a benzothiazole ring, a benzoimidazole ring, a benzotriazole ring, a purine ring, an indazole ring, a chromene ring, a quinoline ring, an isoquinoline ring, a quinolizine ring, a quinazoline ring, a cinnoline ring, a quinoxaline ring, a phthalazine ring, a pteridine ring, a carbazole ring, an acridine ring, a phenanthridine ring, a xanthene ring, a phenazine ring, a phenothiazine ring, a phenoxthine ring, a phenoxazine ring and a thianthrene ring. A naphthalene ring, an azulene ring, an indole ring, a benzoxazole ring, a benzothiazole ring, a benzoimidazole ring, benzotriazole ring and a quinoline ring are preferred.

The single bond of (b) is preferably a carbon-carbon bond between two aromatic rings. Two aromatic rings may be bonded by two or more of single bonds to form an aliphatic ring or a non-aromatic heteroring between the two aromatic rings.

The linking group of (c) also bonds, preferably, to carbon atoms of the two aromatic rings The linking group is preferably an alkylene group, an alkenylene group, an alkynylene group, —CO—, —O—, —NH—, —S— or combinations thereof. Examples of the linking group composed of the combination are shown below. In this connection, the relation of right and left in the following examples of linking group may be reversed.

c1: —CO—O—

### c2: —CO—NH—

c3: -alkylene-O—

### c4: —NH—CO—NH—

### c5: —NH—CO—O—

### c6: —O—CO—O—

### c7: —O-alkylene-O—

### c8: —CO-alkenylene-

### c9: —CO-alkenylene-NH—

c10: —CO-alkenylene-O—
c11: -alkylene-CO—O-alkylene-O—CO-alkylene-

### c12: —O-alkylene-CO—O-alkylene-O—CO-alkylene-O—

### c13: —O—CO-alkylene—CO—O—

### c14: —NH—CO-alkenylene-

c15: —O—CO-alkenylene-

The aromatic ring and the linking group may have a substituent.

Examples of the substituent include a halogen atom (F, Cl, Br, I), a hydroxyl group, a carboxyl group, a cyano group, an amino group, a nitro group, a sulfo group, a carbamoyl group, a sulfamoyl group, an ureide group, an alkyl group, an alkenyl group, an alkynyl group, an aliphatic acyl group, an aliphatic acyloxy group, an alkoxy group, an alkoxycarbonyl group, an alkoxycarbonylamino group, an alkylthio group, an alkylsulfonyl group, an aliphatic amide group, an aliphatic sulfoneamide group, an aliphatic-substituted amino group, an aliphatic-substituted carbamoyl group, an aliphatic-substituted sulfamoyl group, an aliphatic-substituted ureide group and a non-aromatic heterocyclic group.

Number of carbon atoms of the alkyl group is preferably 1-8. A chain alkyl group is preferred to a cyclic alkyl group, and a strait-chain alkyl group is particularly preferred. The alkyl group may further have a substituent (for example, a hydroxyl group, a carboxyl group, an alkoxy group, an alkyl-substituted amino group). Examples of the alkyl group (including the substituted alkyl group) include a methyl group, an ethyl group, a n-butyl group, a n-hexyl group, a 2-hydroxyethyl group, a 4-carboxybutyl group, a 2-methoxyethyl group and 2-diethylaminoethyl group.

Number of carbon atoms of the alkenyl group is preferably 2-8. A chain alkenyl group is preferred to a cyclic alkenyl group, and a straight-chain alkenyl group is particularly preferred. The alkenyl group may further have a substituent. Examples of the alkenyl group include a vinyl group, an aryl group and a 1-hexenyl group.

Number of carbon atoms of the alkynyl group is preferably 2-8. A chain alkynyl group is preferred to a cyclic alkynyl group, and a straight-chain alkynyl group is particularly preferred. The alkynyl group may further have a substituent. Examples of the alkynyl group include an ethynyl group, a 1-butynyl group and a 1-hexynyl group.

Number of carbon atoms of the aliphatic acyl group is preferably 1-10. Examples of the aliphatic acyl group include an acetyl group, a propanoyl group and a butanoyl group.

Number of carbon atoms of the aliphatic acyloxy group is preferably 1-10. Example of the aliphatic acyloxy group include an acetoxy group.

Number of carbon atoms of the alkoxy group is preferably 1-8. The alkoxy group may further have an substituent (for example, an alkoxy group). Examples of the alkoxy group (including a substituted alkoxy group) include a methoxy groups an ethoxy group, a butoxy group and a methoxyethoxy group.

Number of carbon atoms of the alkoxycarbonyl group is preferably 2-10. Examples of the alkoxycarbonyl group include a methoxycarbonyl group and an ethoxycarbonyl group.

Number of carbon atoms of the alkoxycarbonylamino group is preferably 2-10. Examples of the alkoxycarbonylamino group include a methoxycarbonylamino group and an ethoxycarbonylamino group.

Number of carbon atoms of the alkylthio group is preferably 1-12. Examples of the alkylthio group include a methylthio group, an ethylthio group and an octylthio group.

Number of carbon atoms of the alkylsulfonyl group is preferably 1-8. Examples of the alkylsulfonyl group include a methanesulfonyl group and an ethanesulfonyl group.

Number of carbon atoms of the aliphatic amide group is preferably 1-10. Example of the aliphatic amide group includes an acetamide group.

Number of carbon atoms of the aliphatic sulfonamido group is preferably 1-8. Examples of the aliphatic sulfonamido group include a methane sulfonamide group, a butane sulfonamido group and a n-octane sulfonamido group.

Number of carbon atoms of the aliphatic-substituted amino group is preferably 1-10. Examples of the aliphatic-substituted amino group include a dimethylamino group, a diethylamino group and a 2-carboxyethylamino group.

Number of carbon atoms of the aliphatic-substituted carbamoyl group is preferably 2-10. Examples of the aliphatic-substituted carbamoyl group include a methylcarbamoyl group and a diethylcarbamoyl group.

Number of carbon atoms of the aliphatic-substituted sulfamoyl group is preferably 1-8. Examples of the aliphatic-substituted sulfamoyl group include a methylsulfamoyl group and a diethylsulfamoyl group.

Number of carbon atoms of the aliphatic-substituted ureide group is preferably 2-10. Example of the aliphatic-substituted ureide group includes a methylureide group.

Examples of the non-aromatic heterocyclic group include a piperidino group and a morphorino group.

Molecular weight of the retardation enhancer composed of the discotic compound is preferably 300-800.

A compound represented by following formula (I) is preferably used for the discotic compound.

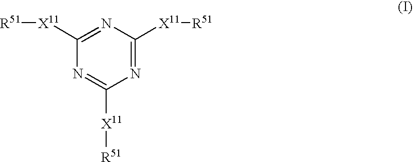

In the above formula (I):

R⁵¹ each independently represents an aromatic ring or a hetero ring having a substituent at any of the ortho-, meta- and para-positions.

X¹¹ each independently represents a single bond or —NR⁵²—. R⁵² each independently represents a hydrogen atom, or a substituted or unsubstituted alkyl, alkenyl, aryl or heterocyclic group.

The aromatic ring represented by R⁵¹ is preferably a phenyl ring or a naphtyl ring, particularly preferably a phenyl ring. The aromatic ring represented by R⁵¹ may have at least one substituent in any one of substitution positions. For the example of the above-mentioned substituent, a halogen atom, a hydroxyl group, a cyano group, a nitro group, a carboxyl group, an alkyl group, an alkenyl group, an aryl group, an alkoxy group, an alkenyloxy group, an aryloxy group, an acyloxy group, an alkoxycarbonyl group, an alkenyloxycarbonyl group, an aryloxycarbonyl group, a sulfamoyl group, an alkyl substituted sulfamoyl group, an alkenyl substituted sulfamoyl group, an aryl substituted sulfamoyl group, a sulfoneamide group, a carbamoyl group, an alkyl substituted carbamoyl group, an alkenyl substituted carbamoyl group, an aryl substituted carbamoyl group, an amide group, an alkylthio group, an alkenylthio group, an arylthio group and an acyl group are included.

The hetero ring for R⁵¹ is preferably aromatic. The aromatic hetero ring is generally an unsaturated hetero ring, and is preferably a hetero ring having maximum double bonds. The hetero ring is preferably a 5-membered ring, a 6-membered ring or a 7-membered ring, more preferably a 5-membered ring or a 6-membered ring, most preferably a 5-membered ring. The hetero atom constituting the hetero ring is preferably a nitrogen atom, a sulfur atom or an oxygen atom, more preferably a nitrogen atom. The aromatic hetero ring is especially preferably a pyridine ring (as the heterocyclic group, a 2-pyridyl or 4-pyridyl group). The heterocyclic group may have a substituent. Examples of the substituent for the heterocyclic group may be the same as those mentioned hereinabove for the substituent of the aryl moiety.

The heterocyclic group in a case where X¹¹ is a single bond is preferably a heterocyclic group having a chemical bond at the nitrogen atom. The heterocyclic group having a chemical bond at the nitrogen atom is preferably a 5-membered ring, a 6-membered ring or a 7-membered ring, more preferably a 5-membered ring or a 6-membered ring, most preferably a 5-membered ring. The heterocyclic group may have plural nitrogen atoms. The heterocyclic group may have any other hetero atom (e.g., O, S) than the nitrogen atom. Examples of the heterocyclic group having a chemical bond at the nitrogen atom are shown below.

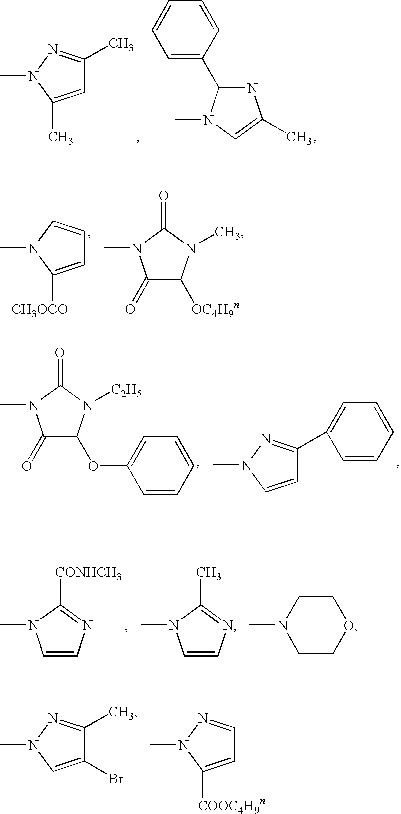

The alkyl group represented by R⁵² may be an cyclo alkyl group or a chain alkyl group, preferably a chain alkyl group. A straight chain alkyl group is more preferred to a branched chain alkyl group. Number of the carbon atoms of the alkyl group is preferably 1-30, more preferably 1-20, further preferably 1-10, further more preferably 1-8, and most preferably 1-6. The alkyl group may have a substituent. An example of the substituent includes a halogen atom, an alkoxy group (for example, a methoxy group, a ethoxy group) and an acyloxy group (for example, a acryloxy group, a metacryloxy group).

The alkenyl group represented by R⁵² may be an cyclo alkenyl group or a chain alkenyl group, preferably a chain alkenyl group. A straight chain alkenyl group is more preferred to a branched chain alkyl group. Number of the carbon atoms of the alkyl group is preferably 2-30, more preferably 2-20, further preferably 2-10, further more preferably 2-8, and most preferably 2-6. The alkenyl group may have a substituent. As the substituents, those for the above-mentioned alkyl group can be used.

The aromatic ring group and heterocyclic group represented by R⁵² and their preferable groups are as described in R⁵¹ above. The aromatic ring group and the heterocyclic group may have a substituent further, and examples of the substituent are the same as those for R⁵¹.

As a discotic compound, the triphenylene compound represented by the following formula (II) can also be used preferably.

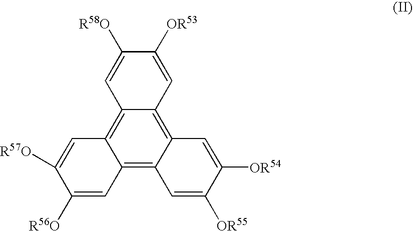

In the formula (II), R⁵³, R⁵⁴, R⁵⁵, R⁵⁶, R⁵⁷ and R⁵⁸ each represent independently a hydrogen atom or a substituent.

Examples of each of the substituent represented by R⁵³, R⁵⁴, R⁵⁵, R⁵⁶, R⁵⁷ and R⁵⁸ include an alkyl group (including, preferably, 1-40 carbon atoms, more preferably 1-30 carbon atoms, particularly preferably 1-20 carbon atoms, such as a methyl group, an ethyl group, an isopropyl group, a tert-butyl group, a n-octyl group, a n-decyl group, a n-hexadecyl group, a cyclopropyl group, a cyclopentyl group and a cyclohexyl group), an alkenyl group (including, preferably, 2-40 carbon atoms, more preferably 2-30 carbon atoms, particularly preferably 2-20 carbon atoms, such as a vinyl group, an aryl group, a 2-butenyl group and a 3-pentenyl group), an alkynyl group (including, preferably, 2-40 carbon atoms, more preferably 2-30 carbon atoms, particularly preferably 2-20 carbon atoms, such as a propagyl group and a 3-pentynyl group), an aryl group (including, preferably, 6-30 carbon atoms, more preferably 6-20 carbon atoms, particularly preferably 6-12 carbon atoms, such as a phenyl group, a p-methylphenyl group and a naphthyl group), substituted or unsubstituted amino group (including, preferably, 0-40 carbon atoms, more preferably 0-30 carbon atoms, particularly preferably 0-20 carbon atoms, such as an unsubstituted amino group, a methylamino group, a dimethylamino group, a diethylamino group and an anilino group), an alkoxy group (including, preferably, 1-40 carbon atoms, more preferably 1-30 carbon atoms, particularly preferably 1-20 carbon atoms, such as a methoxy group, an ethoxy group and a butoxy group), an aryloxy group (including, preferably, 6-40 carbon atoms, more preferably 6-30 carbon atoms, particularly preferably 6-20 carbon atoms, such as a phenyloxy group and a 2-naphthyloxy group), an acyl group (including, preferably, 1-40 carbon atoms, more preferably 1-30 carbon atoms, particularly preferably 1-20 carbon atoms, such as an acetyl group, a benzoyl group, a formyl group and a pivaloyl group), an alkoxycarbonyl group (including, preferably, 2-40 carbon atoms, more preferably 2-30 carbon atoms, particularly preferably 2-20 carbon atoms, such as a methoxycarbonyl group and an ethoxycarbonyl group), an aryloxycarbonyl group (including, preferably, 7-40 carbon atoms, more preferably 7-30 carbon atoms, and particularly preferably 7-20 carbon atoms, such as a phenyloxycarbonyl group), an acyloxy group (including, preferably, 2-40 carbon atoms, more preferably 2-30 carbon atoms, particularly preferably 2-20 carbon atoms, such as an acetoxy group and a benzoyloxy group), an acylamino group (including, preferably, 2-40 carbon atoms, more preferably 2-30 carbon atoms, particularly preferably 2-20 carbon atoms, such as an acetylamino group and a benzoylamino group), an alkoxycarbonylamino group (including, preferably, 2-40 carbon atoms, more preferably 2-30 carbon atoms, particularly preferably 2-20 carbon atoms, such as a methoxycarbonylamino group), an aryloxycarbonylamino group (including, preferably, 7-40 carbon atoms, more preferably 7-30 carbon atoms, and particularly preferably 7-20 carbon atoms, such as a phenyloxycarbonylamino group), a sulfonylamino group (including, preferably, 1-40 carbon atoms, more preferably 1-30 carbon atoms, particularly preferably 1-20 carbon atoms, such as a methanesulfonylamino group and a benzenesulfonylamino group), a sulfamoyl group (including, preferably, 0-40 carbon atoms, more preferably 0-30 carbon atoms, particularly preferably 0-20 carbon atoms, such as a sulfamoyl group, a methylsulfamoyl group, a dimethylsulfamoyl group and a phenylsulfamoyl group), a carbamoyl group (including, preferably, 1-40 carbon atoms, more preferably 1-30 carbon atoms, particularly preferably 1-20 carbon atoms, such as a carbamoyl group, a methylcarbamoyl group, a diethylcarbamoyl group and a phenylcarbamoyl group), an alkylthio group (including, preferably, 1-40 carbon atoms, more preferably 1-30 carbon atoms, particularly preferably 1-20 carbon atoms, such as a methylthio group, an ethylthio group, propylthio group, butylthio group, pentylthio group, hexylthio group, heptylthio group and octylthio group), an arylthio group (including, preferably, 6-40 carbon atoms, more preferably 6-30 carbon atoms, particularly preferably 6-20 carbon atoms, such as a phenylthio group), a sulfonyl group (including, preferably, 1-40 carbon atoms, more preferably 1-30 carbon atoms, particularly preferably 1-20 carbon atoms, such as a mesyl group and a tosyl group), a sulfinyl group (including, preferably, 1-40 carbon atoms, more preferably 1-30 carbon atoms, particularly preferably 1-20 carbon atoms, such as a methanesulfinyl group and a benzenesulfinyl group), an ureide group (including, preferably, 1-40 carbon atoms, more preferably 1-30, carbon atoms, particularly preferably 1-20 carbon atoms, such as an ureide group, a methylureide group and a phenylureide group), a phosphoric amide group (including, preferably, 1-40 carbon atoms, more preferably 1-30 carbon atoms, particularly preferably 1-20 carbon atoms, such as a diethylphosphoric amide group and a phenylphosphoric amide group), a hydroxyl group, a mercapto group, a halogen atom (such as a fluorine atom, a chlorine atom, a bromine atom, an iodine atom), a cyano group, a sulfo group, a carboxyl group, a nitro group, a hydroxamic acid group, a sulfino group, a hydrazino group, an imino group, a heteroring group (including, preferably, 1-30 carbon atoms, more preferably 1-12 carbon atoms, wherein examples of the hetero atom include a nitrogen atom, an oxygen atom and a sulfur atom, and specific examples include an imidazolyl group, a pyridyl group, a quinolyl group, a furyl group, a piperidyl group, a morphorino group, a benzoxysazolyl group, a benzimidazolyl group, a benzothiazolyl group and 1,3,5-triazyl group), and a silyl group (including, preferably, 3-40 carbon atoms, more preferably 3-30 carbon atoms, particularly preferably 3-24 carbon atoms, such as a trimethylsilyl group and a triphenylsilyl group). These substituents may further have a substituent. When there are two substituents or more, they may be same with or different from each other. Further, when possible, they may be linked with each other to form a ring.

As the substituent represented by R⁵³, R⁵⁴, R⁵⁵, R⁵⁶, R⁵⁷ and R⁵⁸ is preferably an alkyl group, an aryl group, a substituted or unsubstituted amino group, an alkoxy group, an alkylthio group or a halogen atoms.

Preferable examples of the compound represented by the formula (II) are shown below, however compounds usable in the invention are not restricted to these specific examples.

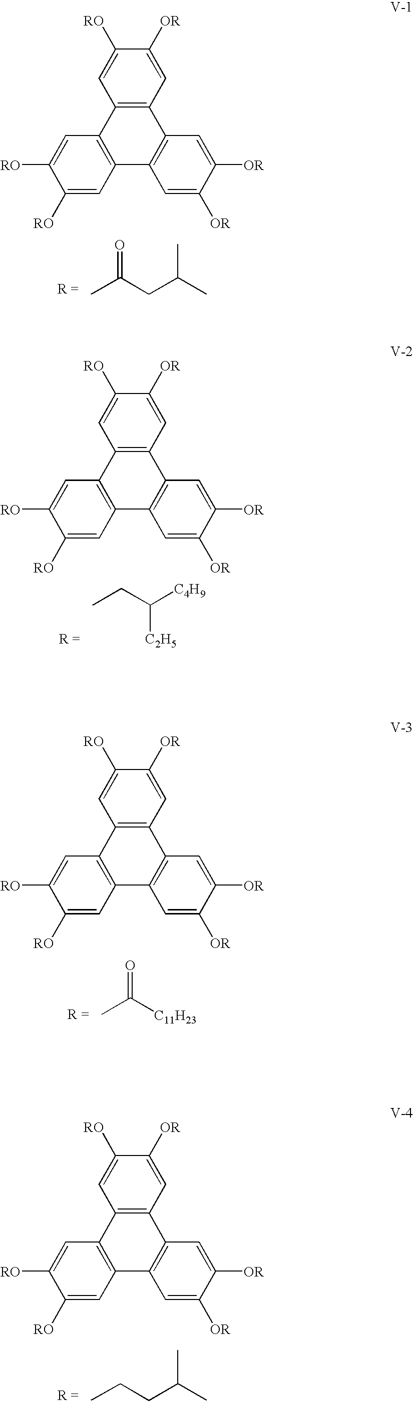

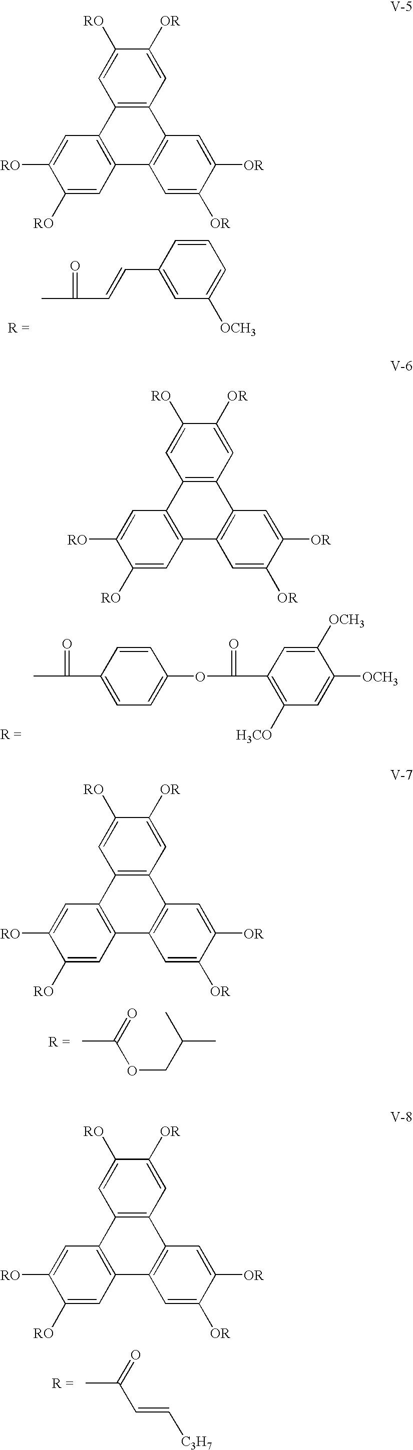

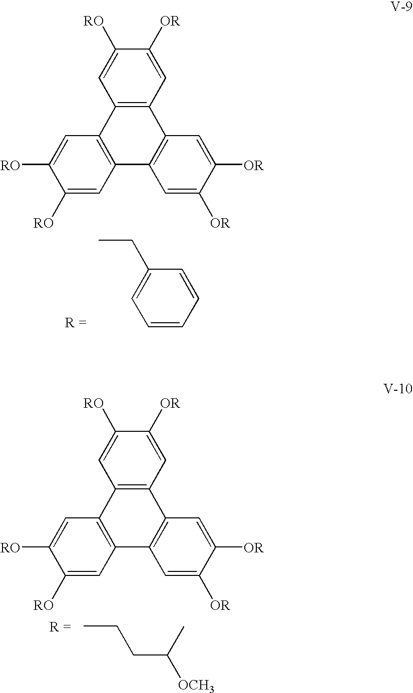

The compound represented by formula (I) can be produced by, for example, a method given in the JP-A 2003-344655 and the compound represented by formula (II) can be produced by, for example, a method given in JP-A 2005-134884. Both compounds may be produced by other well-known methods.

In the invention, rod-shaped compounds having a linear molecular structure are also usable preferably in addition to the discotic compound. “The linear molecular structure” means that molecular structure of a rod-shaped compound is linear in the thermodynamically stablest structure. The thermodynamically stablest structure can be obtained by crystal structure analysis or molecular orbital calculation. For example, molecular orbital calculation can be performed using a software for molecular orbital calculation (for example, WinMOPAC2000, manufactured by FUJITSU) to obtain the molecular structure for which heat of formation of the compound becomes least. “The linear molecular structure” means that the angle constituted by the primary chain of the molecular structure is 140 degrees or more in the thermodynamically stablest structure obtained according to the aforementioned calculation.

As the rod-shaped compound having at least two aromatic rings, compounds represented by formula (3) below are preferred.

Ar¹-L¹¹-Ar²: Formula (3)

wherein each of Ar¹ and Ar² represents an aromatic group independently from each other.

In the specification, the aromatic group includes an aryl group (aromatic hydrocarbon group), a substituted aryl group, an aromatic heteroring group and a substituted aromatic heteroring group.

An aryl group and a substituted aryl group are preferred to an aromatic heteroring group and a substituted aromatic heteroring group. A heteroring in the aromatic heteroring group is generally unsaturated. The aromatic heteroring is preferably a 5-membered ring, a 6-membered ring or a 7-membered ring, more preferably a 5-membered ring or a 6-membered ring. The aromatic heteroring generally has the largest number of double bonds. As for the hetero atom, a nitrogen atom, an oxygen atom or a sulfur atom is preferred, and a nitrogen atom or a sulfur atom is more preferred.

Preferable examples of the aromatic ring in the aromatic group include a benzene ring, a furan ring, a thiophene ring, a pyrrole ring, an oxazole ring, a thiazole ring, an imidazole ring, a triazole ring, a pyridine ring, a pyrimidine ring and a pyrazine ring. A benzene ring is particularly preferred.

Examples of the substituent of the substituted aryl group and substituted aromatic heteroring group include a halogen atom (S, Cl, Br, I), a hydroxyl group, a carboxyl group, a cyano group, an amino group, an alkylamino group (for example, a methylamino group, an ethylamino group, a butylamino group, a dimethylamino group), a nitro group, a sulfo group, a carbamoyl group, an alkylcarbamoyl group (for example, an N-methylcarbamoyl group, an N-ethylcarbamoyl group, an N,N-dimethylcarbamoyl group), a sulfamoyl group, an alkylsulfamoyl group (for example, an N-methylsulfamoyl group, an N-ethylsulfamoyl group, an N,N-dimethylsulfamoyl group), an ureide group, an alkylureide group (for example, an N-methylureide group, an N,N-dimethylureide group, an N,N,N′-trimethylureide group), an alkyl group (for example, a methyl group, an ethyl group, a propyl group, a butyl group, a pentyl group, a heptyl group, an octyl group, an isopropyl group, a s-butyl group, a tert-amyl group, a cyclohexyl group, a cyclopentyl group), an alkenyl group (for example, a vinyl group, an aryl group, a hexenyl group), an alkynyl group (for example, an ethynyl group, a butynyl group), an acyl group (for example, a formyl group, an acetyl group, a butyryl group, a hexanoyl group, a lauryl group), an acyloxy group (for example, an acetoxy group, a butylyloxy group, a hexanoyloxy group, a lauryloxy group), an alkoxy group (for example, a methoxy group, an ethoxy group, a propoxy group, a butoxy group, a pentyloxy group, a heptyloxy group, an octyloxy group), an aryloxy group (for example, a phenoxy group), an alkoxycarbonyl group (for example, a methoxycarbonyl group, an ethoxycarbonyl group, a propoxycarbonyl group, a butoxycarbonyl group, a pentyloxycarbonyl group, a heptyloxycarbonyl group), an aryloxycarbonyl group (for example, a phenoxycarbonyl group), an alkoxycarbonylamino group (for example, a butoxycarbonylamino group, a hexyloxycarbonylamino group), an alkylthio group (for example, a methylthio group, an ethylthio group, a propylthio group, a butylthio group, a pentylthio group, a heptylthio group, an octylthio group), an arylthio group (for example, phenylthio group), an alkylsulfonyl group (for example, a methylsulfonyl group, an ethylsulfonyl group, a propylsulfonyl group, a butylsulfonyl group, a pentylsulfonyl group, a heptylsulfonyl group, an octylsulfonyl group), an amide group (for example, an acetamide group, a butylamide group, a hexylamide group, a laurylamide group) and non-aromatic heterocyclic groups (for example, a morphoryl group, a pyrazinyl group).

Preferable examples of the substituent of the substituted aryl group and substituted aromatic heteroring group include a halogen atom, a cyano group, a carboxyl group, a hydroxyl group, an amino group, an alkyl-substituted amino group, an acyl group, an acyloxy group, an amide group, an alkoxycarbonyl group, an alkoxy group, an alkylthio group and an alkyl group.

An alkyl moiety in the alkylamino group, the alkoxycarbonyl group, the alkoxy group and the alkylthio group and the alkyl group may further have a substituent. Examples of the substituent in the alkyl moiety and the alkyl group include a halogen atom, a hydroxyl, carboxyl, cyano, amino and alkylamino groups, a nitro, sulfo, carbamoyl and alkylcarbamoyl groups, a sulfamoyl and alkylsulfamoyl groups, an ureide and alkylureide groups, an alkenyl group, an alkynyl group, an acyl group, an acyloxy group, an acylamino group, an alkoxy group, an aryloxy group, an alkoxycarbonyl group, an ayrloxycarbonyl group, an alkoxycarbonylamino group, an alkylthio group, an arylthio group, an alkylsulfonyl group, an amide group and non-aromatic heterocyclic groups. As the substituent in the alkyl moiety and the alkyl group, a halogen atom, a hydroxyl, an amino and alkylamino groups, an acyl group, an acyloxy group, an acylamino group, an alkoxycarbonyl group and an alkoxy group are preferred.

In the formula (3), L¹¹ represents a divalent linking group selected from an alkylene group, an alkenylene group, an alkynylene group, —O—, —CO— and groups composed of combinations thereof.

The alkylene group may have a cyclic structure. As a cyclic alkylene group, cicrohexylene is preferred, and 1,4-cyclohexylene is particularly preferred. As a chain alkylene group, a straight-chain alkylene group is preferred to a branched alkylene group.

Number of carbon atoms of an alkylene group is preferably 1-20, more preferably 1-15, further preferably 1-10, furthermore preferably 1-8, most preferably 1-6.

The alkenylene group and the alkynylene group preferably have a chain structure compared with a cyclic structure, more preferably a straight chain structure compared with a branched chain structure.

Number of carbon atoms of the alkenylene group and the alkynylene group is preferably 2-10, more preferably 2-8, further preferably 2-6, furthermore preferably 2-4, most preferably 2 (that is, vinylene or ethynylene). Number of carbon atoms of the arylene group is preferably 6-20, more preferably 6-16, further preferably 6-12.

In the molecular structure of the formula (3), an angle formed by Ar¹ and Ar² across L¹¹ is preferably 140 degrees or more.

As the rod-shaped compound, compounds represented by formula (3-1) below are more preferred.

Ar¹-L¹²-X-L¹³-Ar²: Formula (3-1)

wherein each of Ar¹ and Ar² represents an aromatic group independently from each other. The definition and example for the aromatic group are the same as those for Ar¹ and Ar² of the formula (3).

In the formula (3-1), each of L¹² and L¹³ represents, independently from each other, a divalent linking group selected from an alkylene group, —O—, —CO— and groups composed of combinations thereof.

The alkylene group preferably has a chain structure compared with a cyclic structure, and more preferably has a straight chain structure compared with a branched chain structure.

Number of carbon atoms of the alkylene group is preferably 1-10, more preferably 1-8, further preferably 1-6, furthermore preferably 1-4, most preferably 1 or 2 (that is, methylene or ethylene).

Particularly preferably, L¹² and L¹³ are —O—CO— or —CO—O—.

In the formula (3-1), X is 1,4-cyclohexylene, vinylene or ethynylene.

As specific examples of the compounds of formula (3) or (3-1), mentioned are the compounds of [Formula 1] to [Formula 11] in JP-A 2004-109657.

Two kinds or more of the rod-shaped compounds, which have a maximum absorption wavelength (λmax) of less than 250 nm in an ultraviolet spectrum of the solution, may be used simultaneously.

A rod-shaped compound can be synthesized according to methods described in references. As references, Mol. Cryst. Liq. Cryst., vol. 53, p 229 (1979); do. vol. 89, p 93 (1982); do. vol. 145, p 111 (1987); do. vol. 170, p 43 (1989); Journal of the American Chemical Society, vol. 113, p 1349 (1991); do. vol. 118, p 5346 (1996); do. vol. 92, p 1582 (1970); Journal of Organic Chemistry, vol. 40, p 420 (1975); and Tetrahedron, vol. 48, No. 16, p 3437 (1992) can be mentioned.

The rod-shaped aromatic compounds described in JP-A 2004-50516, pp. 11-14 may be used as the Re enhancer.

As the Re enhancer, one compound alone or two or more compounds as combined may be used. Using two or more different types of compounds as the Re enhancer is preferred, as the retardation regulation range may be broadened and the retardation may be regulated in a desired range with ease.

The amount of the Re enhancer to be added is preferably from 0.1 to 20% by mass to the cellulose ester, more preferably from 0.5 to 10% by mass. In case where the cellulose ester film is formed according to a solvent casting method, the Re enhancer may be added to the dope. Adding it maybe effected in any timing, and for example, the Re enhancer is dissolved in an organic solvent such as alcohol, methylene chloride, dioxolane or the like, and the resulting solution may be added to the cellulose ester solution (dope), or the Re enhancer may be directly added to the dope composition.

Especially preferably, the proportion of the discotic compound is from 10% to 90% relative to the total mass of the discotic compound and the rod-shaped compound, more preferably from 20% to 80%.

Preferred examples of other rod-shaped compounds than those shown in the above-mentioned patent publication are shown below.

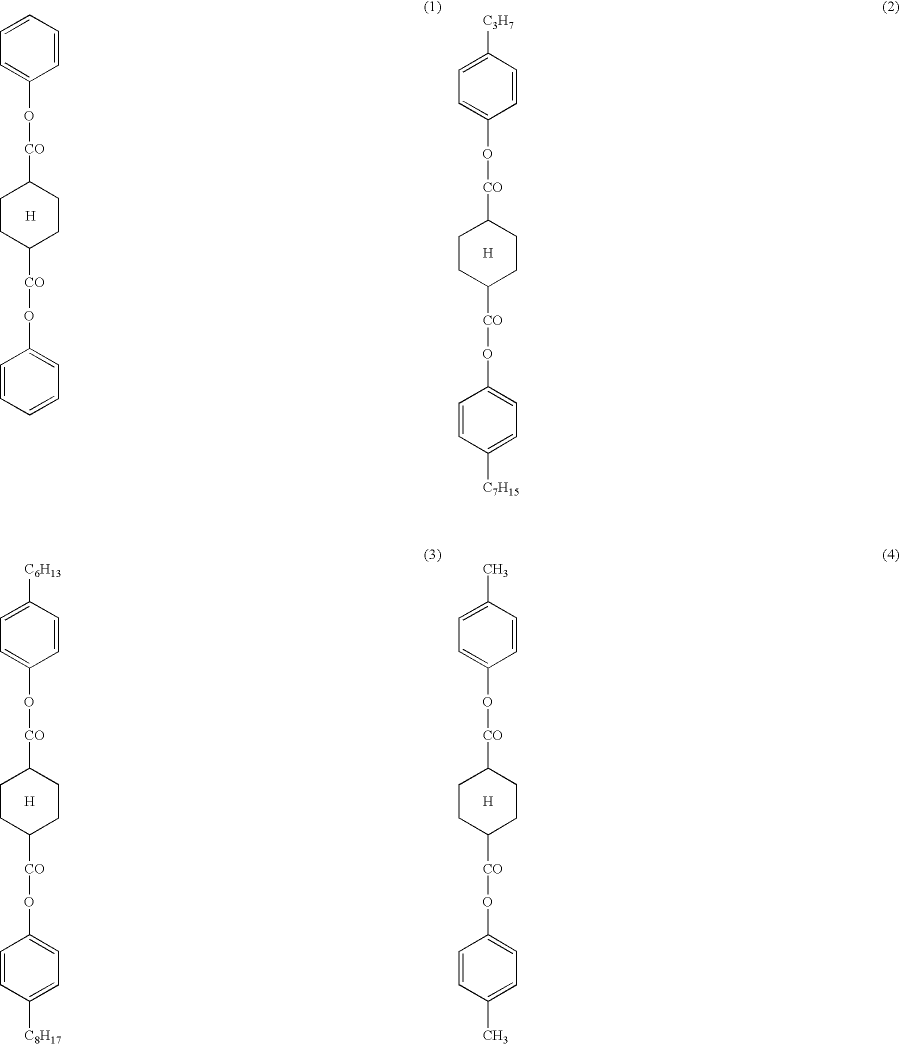

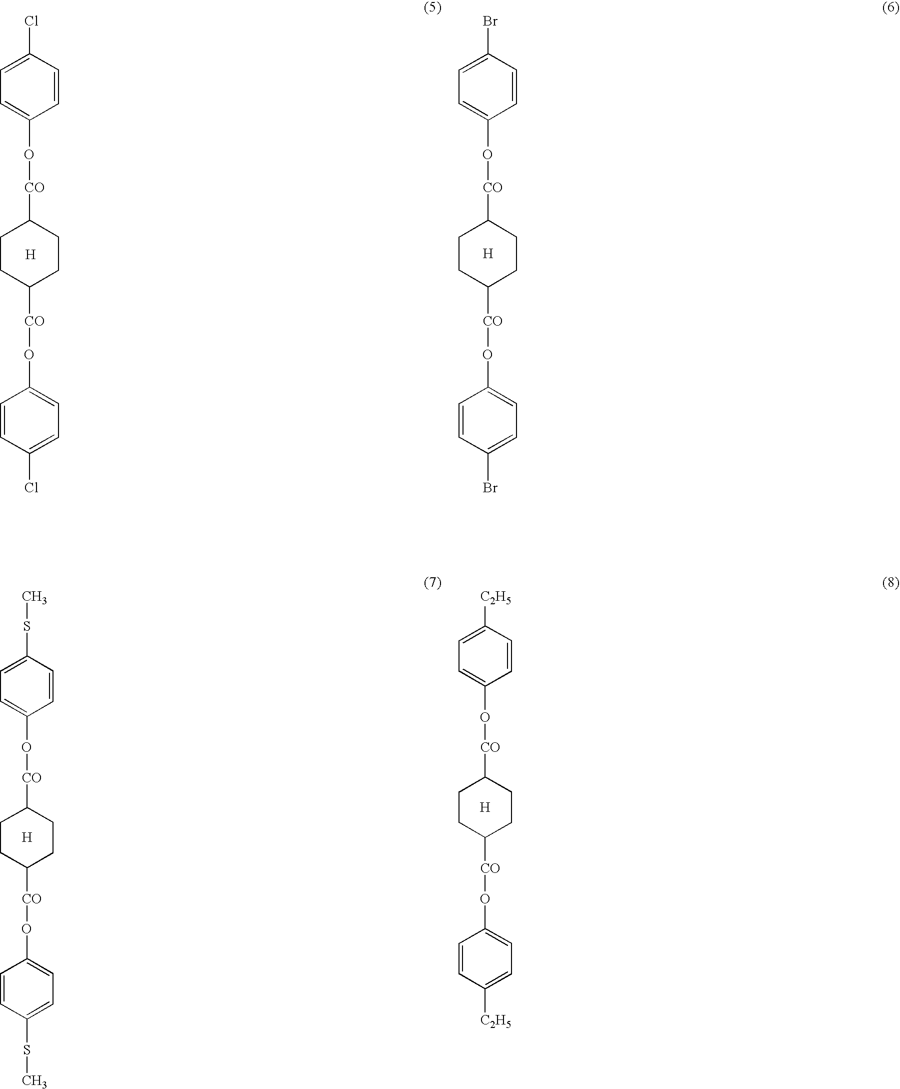

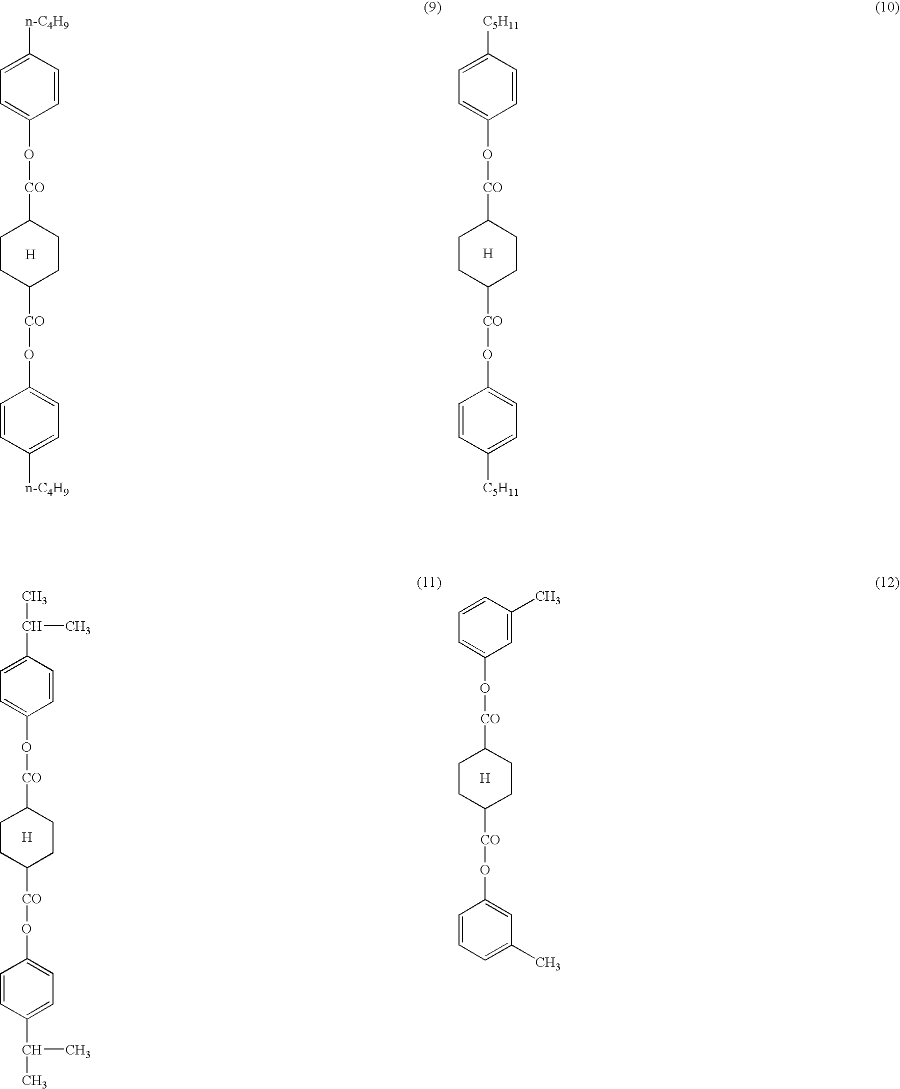

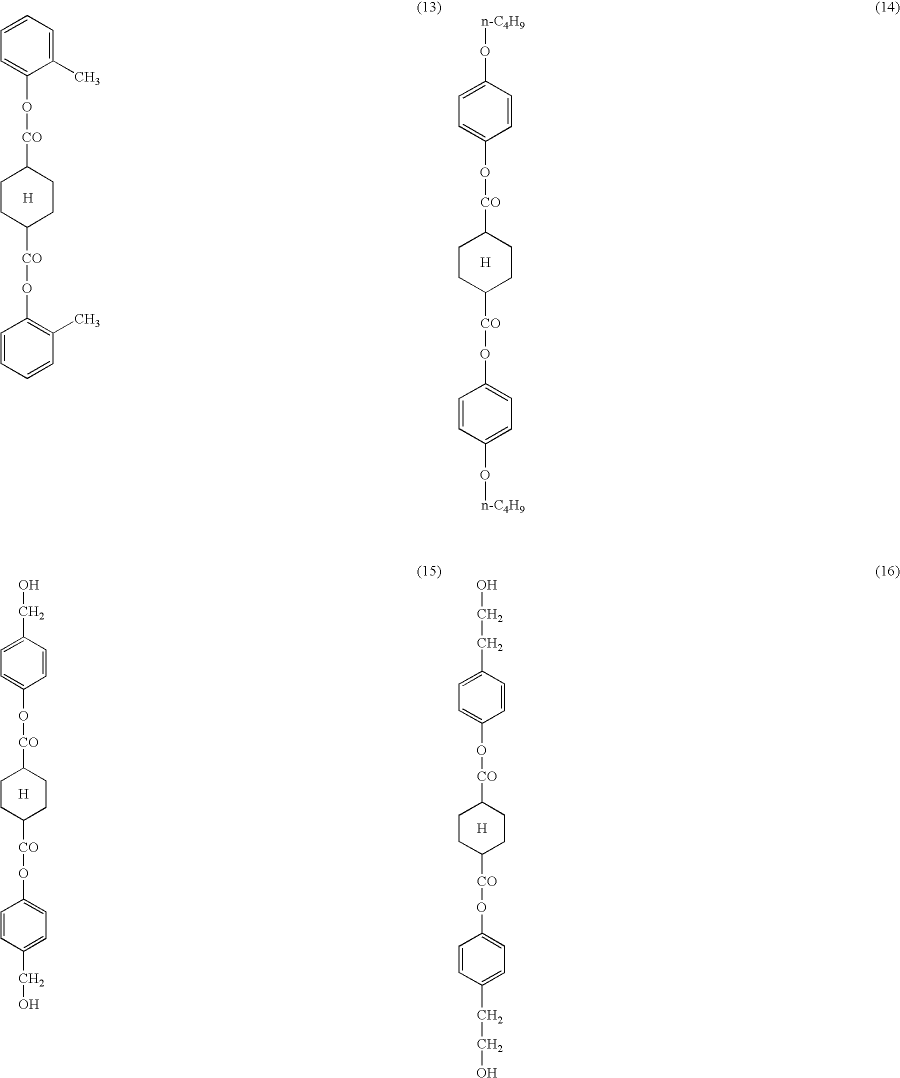

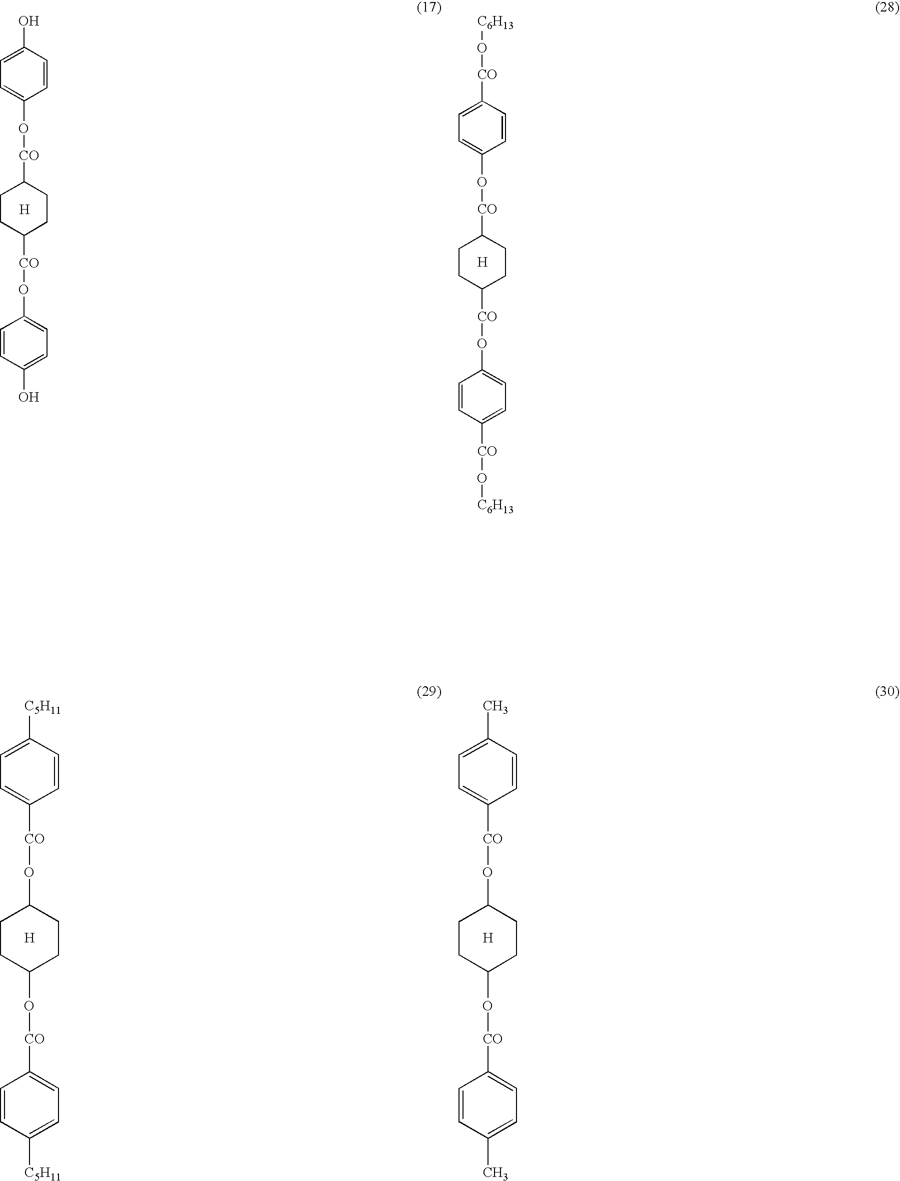

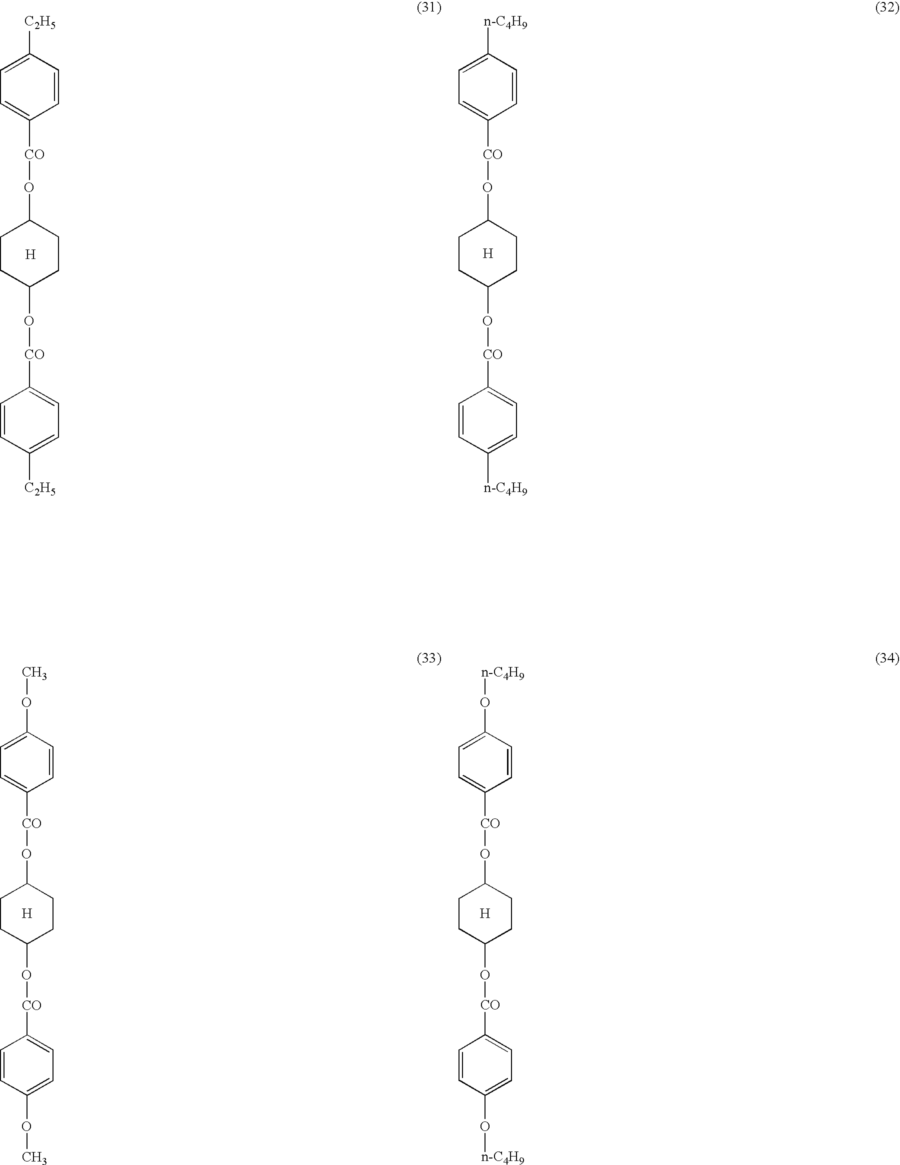

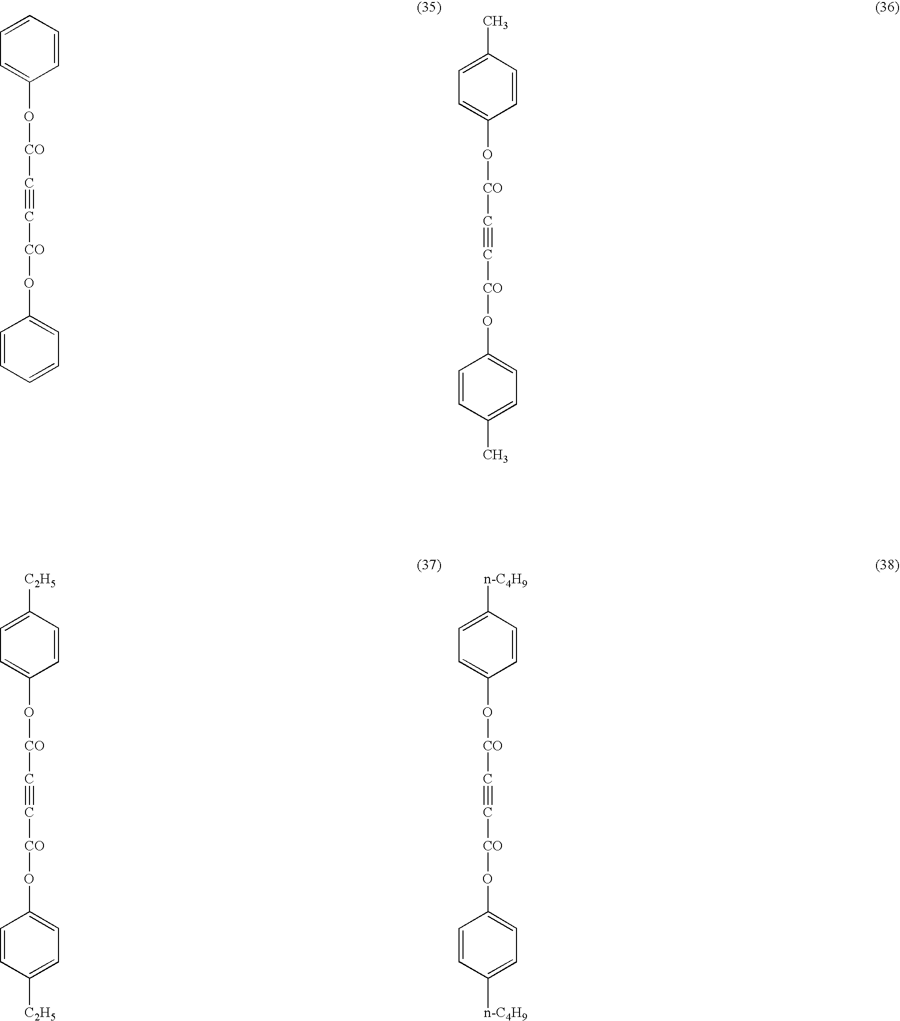

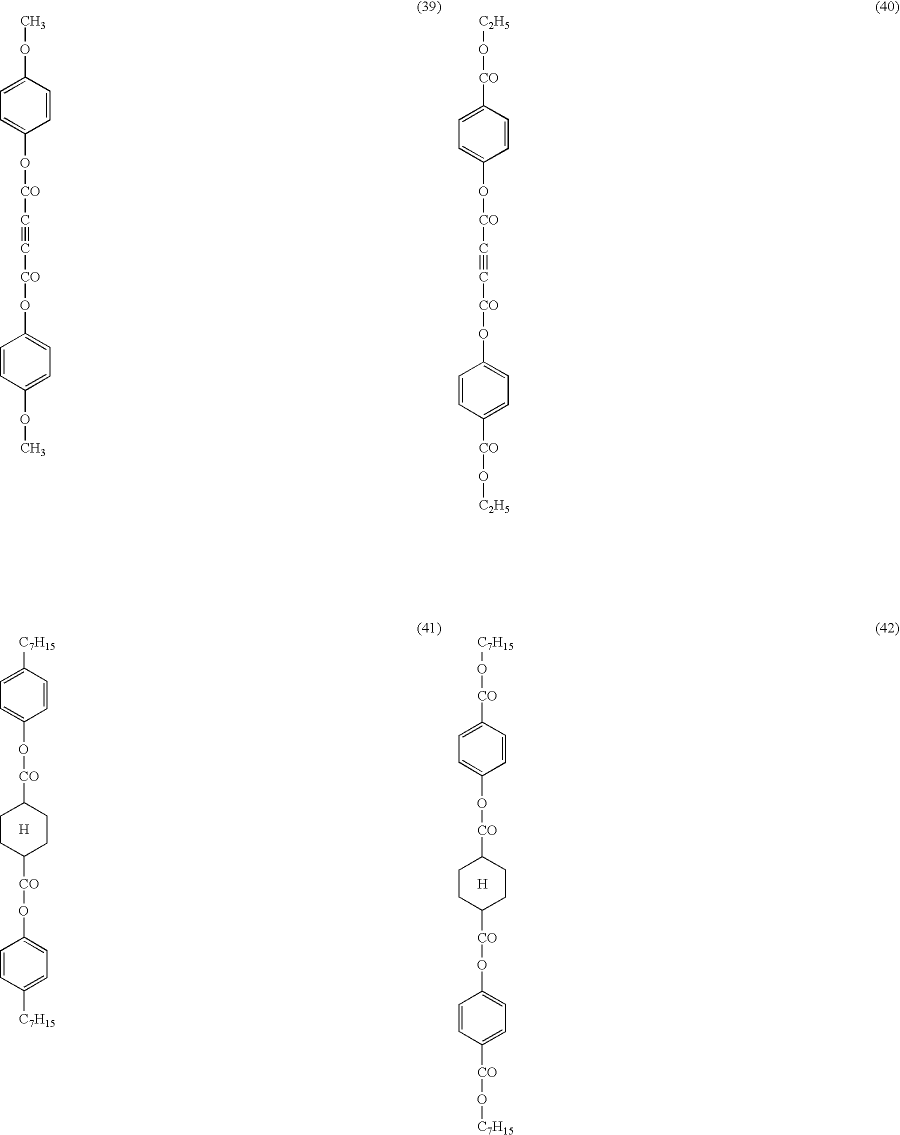

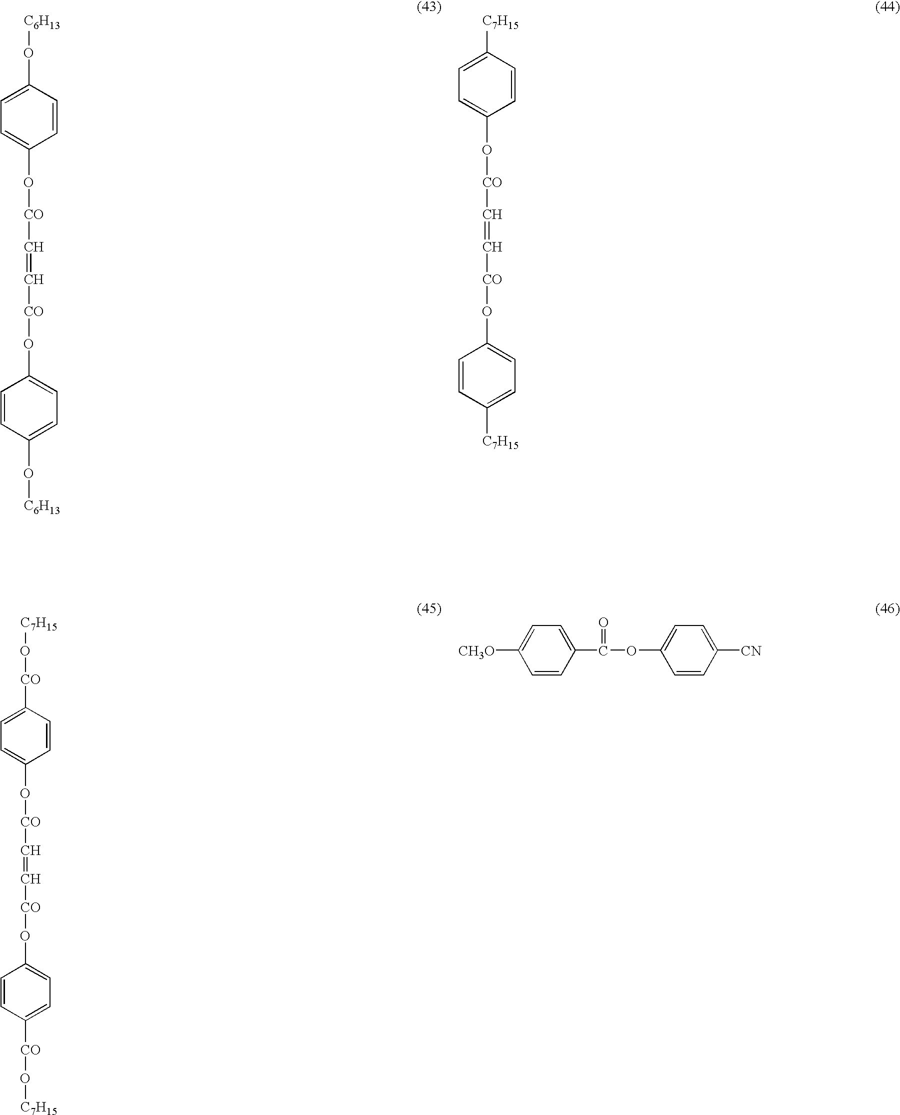

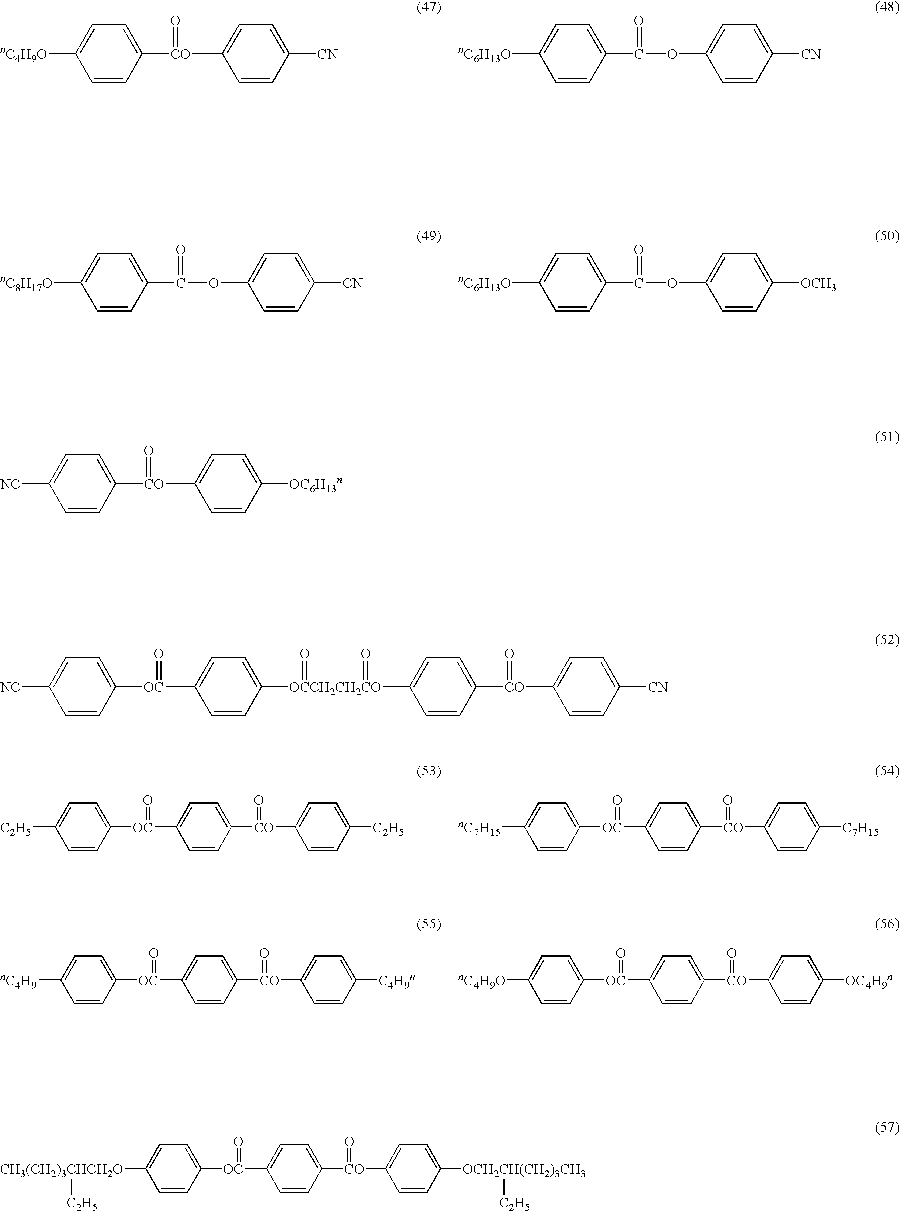

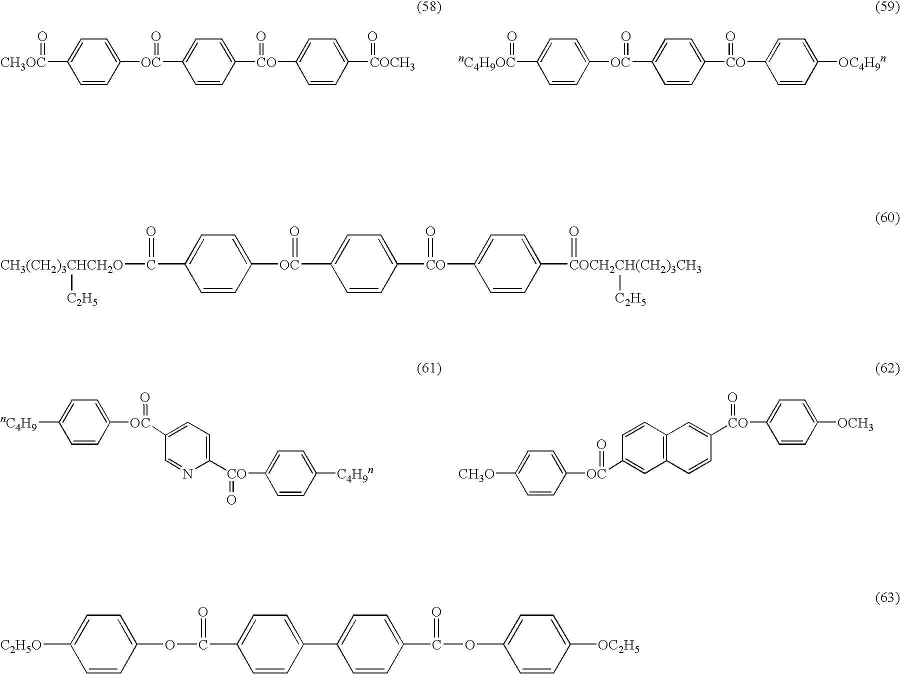

Specific examples (1)-(34), (41) and (42) have 2 asymmetric carbon atoms at 1- and 4-sites of the cyclohexane ring. However, since specific examples (1), (4)-(34), (41) and (42) have a symmetric molecular structure of meso form, there are no optical isomers (optical activity), and only geometric isomers (trans form and cis form) exist. The trans form (1-trans) and cis form (1-cis) of the specific example (1) are shown below.

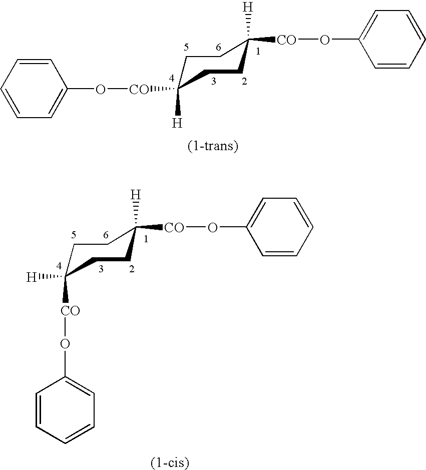

As described above, the rod-shaped compound preferably has a linear molecular structure. Therefore, a trans form is preferred to a cis form.

Specific examples (2) and (3) have optical isomers in addition to geometric isomers (4 kinds of isomers in total). As for the geometric isomers, similarly, the trans form is preferred to the cis form. There are no particular relative merits between the optical isomers, and any of D-, L- and racemic forms may be sufficient.

As for specific examples (43)-(45), there are the trans form and cis form due to the vinylene bond at the center. According to the same reason as described above, the trans form is preferred to the cis form.

### (Retardation Reducing Agent)

The film of the invention may include retardation reducing agents.

Examples of the retardation reducing agents include compounds represented by the following formulae (4) to (8-4), however the retardation reducing agents used in the invention is not limited thereto.

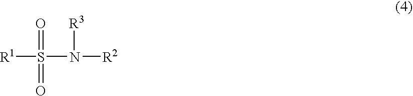

wherein R¹ represents an alkyl group or an aryl group, and each of R² and R³ represent, independently from each other, a hydrogen atom, an alkyl group or an aryl group. The total number of carbon atoms of R¹, R² and R³ is 10 or more.

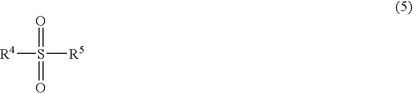

wherein each of R⁴ and R⁵ represent, independently from each other, an alkyl group or an aryl group. The total number of carbon atoms of R⁴ and R⁵ is 10 or more.

In the formula (5), the respective alkyl and aryl groups may have a substituent. As a substituent, a fluorine atom, an alkyl group, an aryl group, an alkoxy group, a sulfone group and a sulfonamido group are preferred, and an alkyl group, an aryl group, an alkoxy group, a sulfone group and a sulfonamido group are particularly preferred. The alkyl group may be of straight chain, branched chain or cycle. Number of carbon atoms thereof is preferably 1-25, more preferably 6-25, particularly preferably 6-20 (for example, a methyl group, an ethyl group, a propyl group, an isopropyl group, a butyl group, an isobutyl group, a tert-butyl group, an amyl group, an isoamyl group, a tert-amyl group, a hexyl group, a cyclohexyl group, a heptyl group, an octyl group, a bicyclooctyl group, a nonyl group, an adamantyl group, a decyl group, a tert-octyl group, an undecyl group, a dodecyl group, a tridecyl group, a tetradecyl group, a pentadecyl group, a hexadecyl group, a heptadecyl group, an octadecyl group, a nonadecyl group and a didecyl group). Number of carbon atoms of the aryl group is preferably 6-30, particularly preferably 6-24 (for example, a phenyl group, a biphenyl group, a terphenyl group, a naphthyl group, a binaphthyl group and a triphenylphenyl group). Preferable examples of the compound represented by the formula (4) or (5) are shown below, however the invention is not restricted to these specific examples.

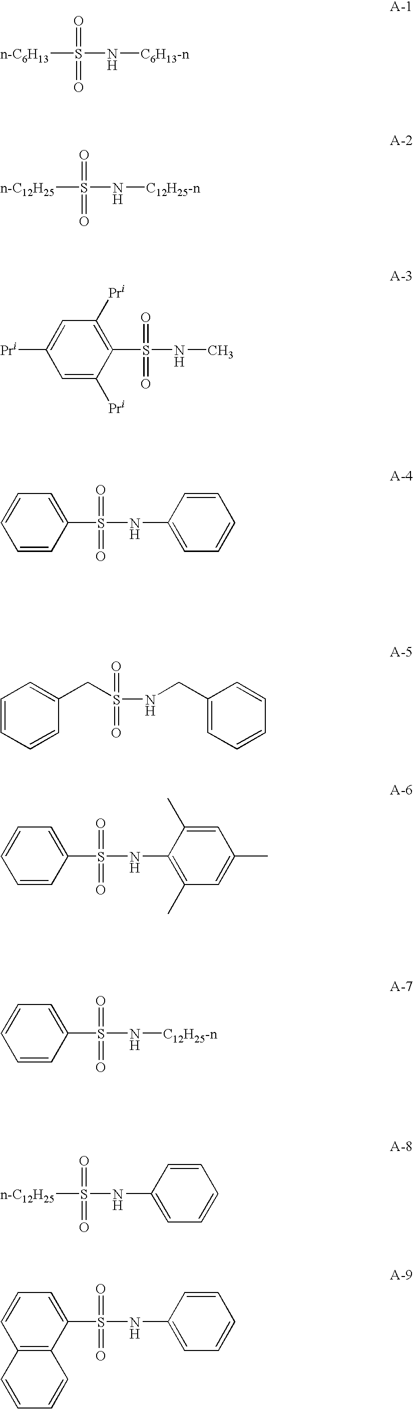

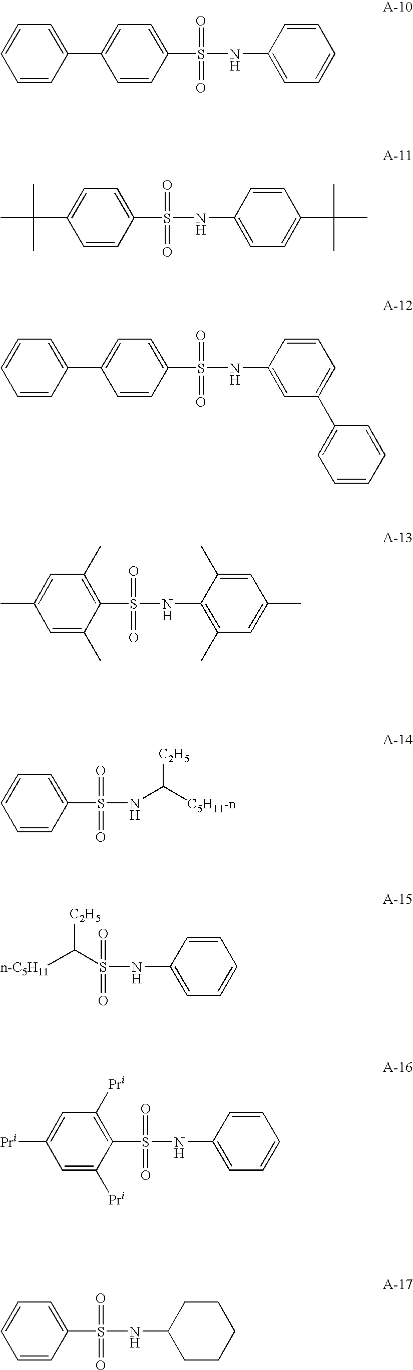

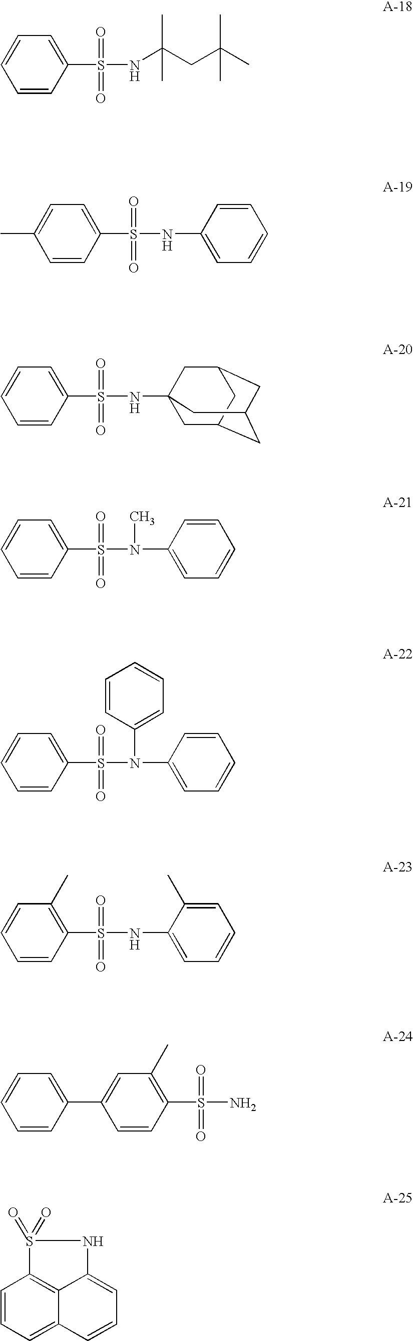

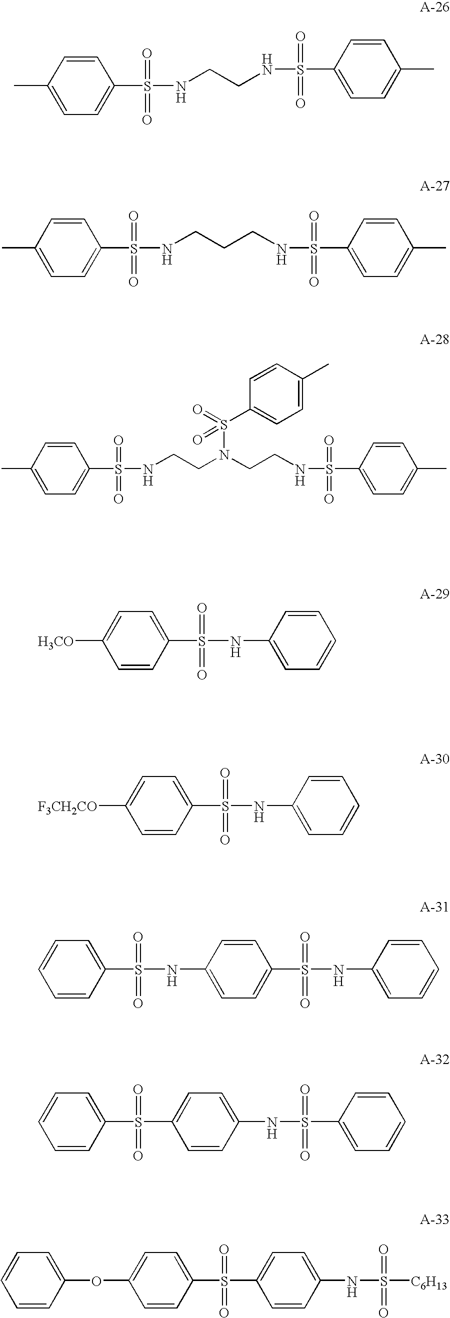

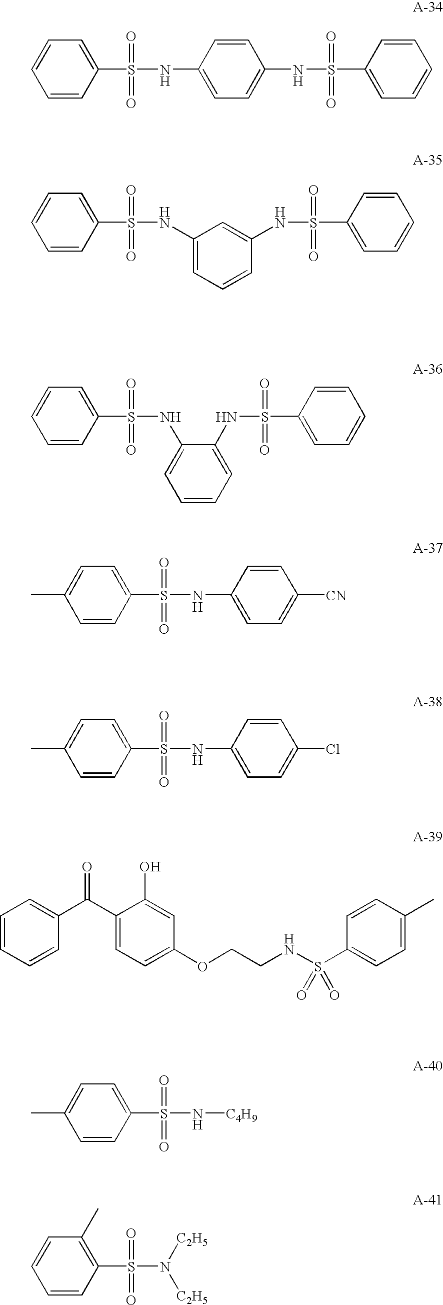

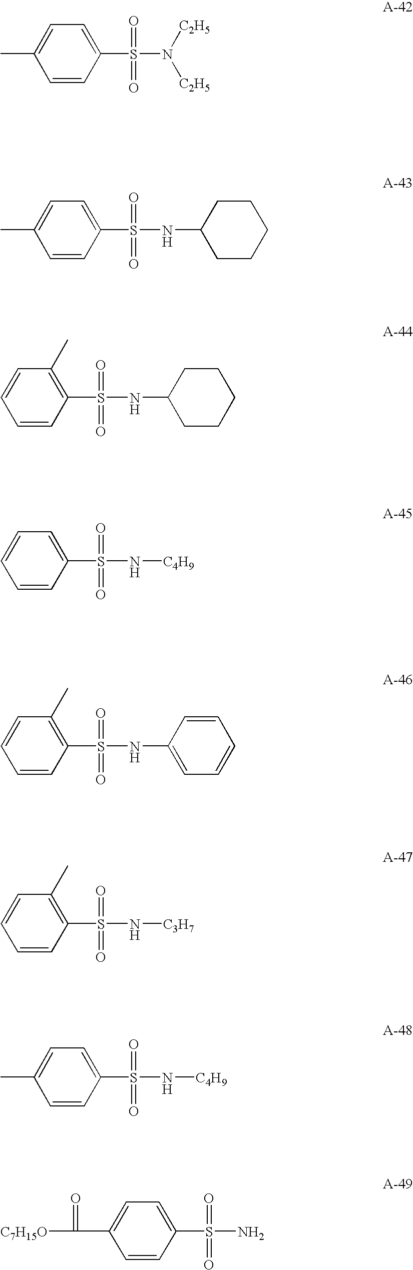

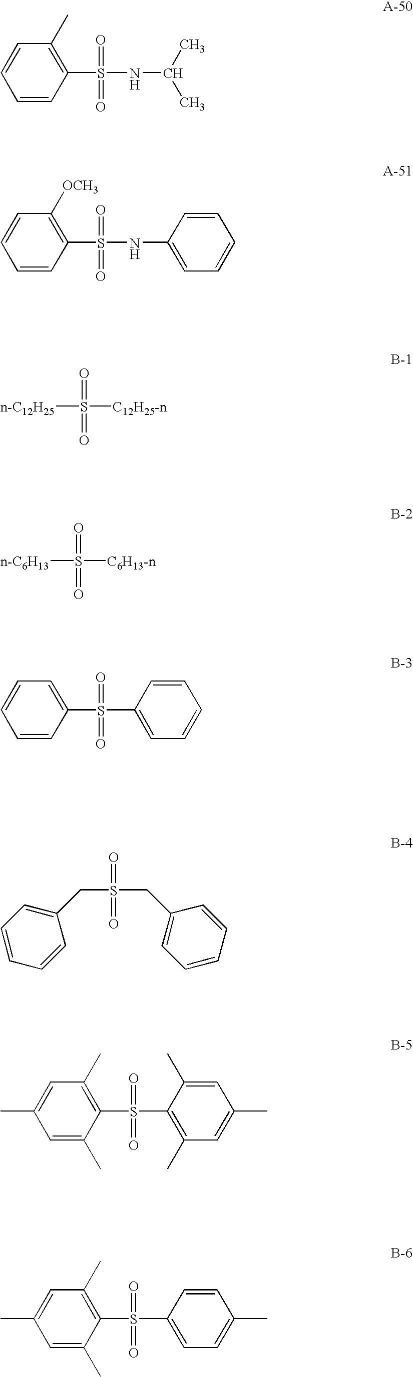

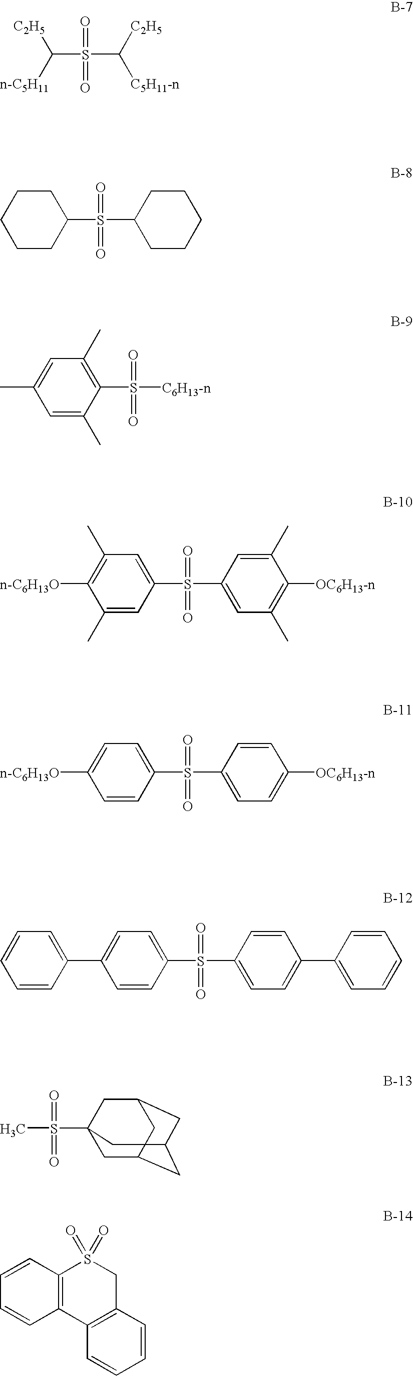

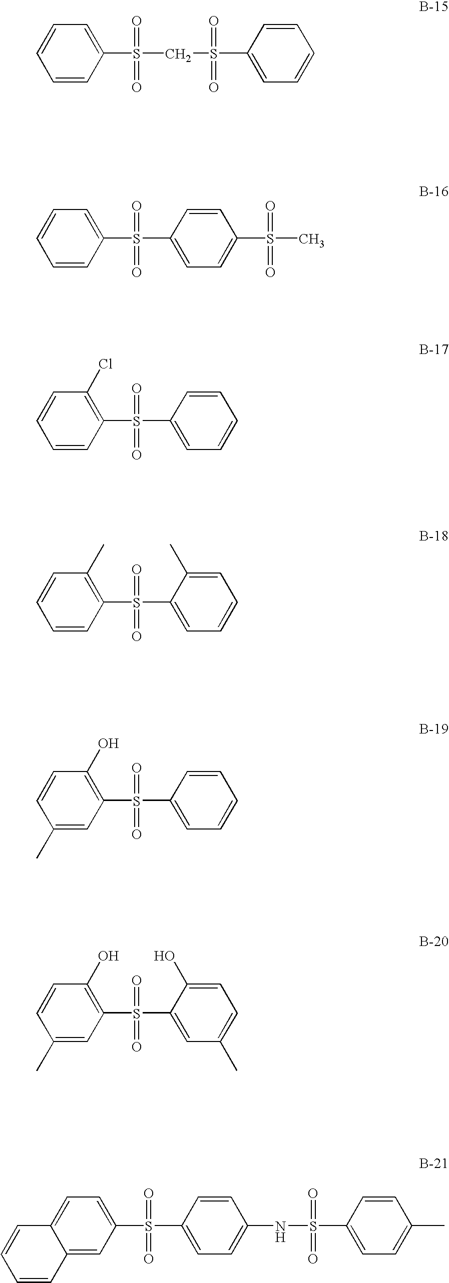

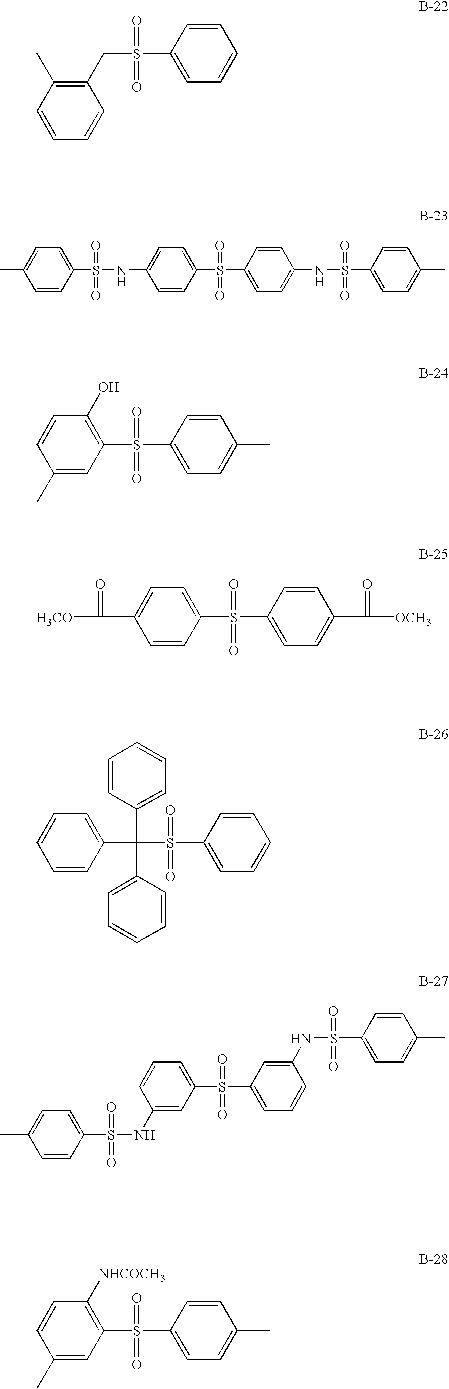

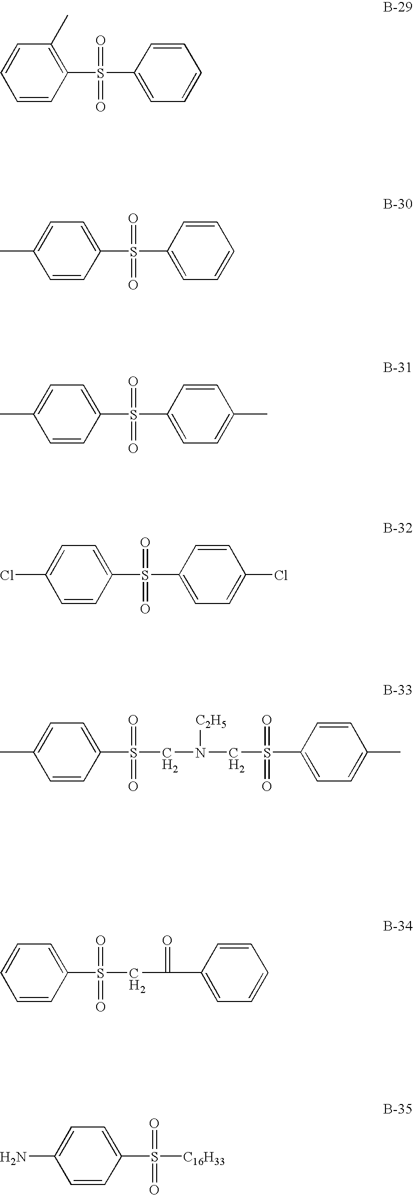

The compounds of formula (4) or formula (5) may be produced according to the following methods.

The compound of formula (4) may be produced through condensation of a sulfonyl chloride derivative and an amine derivative. The compound of formula (5) maybe produced through oxidation or a sulfide or Friedel-Crafts reaction of an aromatic compound and a sulfonic acid chloride.

The compound of formula (6) is described in detail hereinunder.

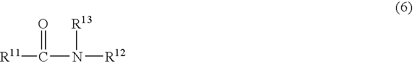

Wherein R¹¹ represents an aryl group. Each of R¹² and R¹³ represent, independently from each other, an alkyl group or an aryl group, and at least one of R¹² or R¹³ is an aryl group. Where R¹² is an aryl group R¹³ may be an alkyl group or an aryl group, more preferably an alkyl group. The alkyl group may be a straight chain, branched chain or cycle, and number of carbon atoms thereof is preferably 1-20, more preferably 1-15, most preferably 1-12. Number of carbon atoms of the alkyl group is preferably 6-36, more preferably 6-24.

The compound of formula (7) is described in detail hereinunder.

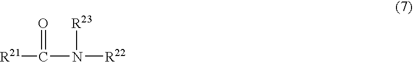

In the formula (7), each of R²¹, R²² and R²³ represent, independently from each other, an alkyl group. The alkyl group maybe a straight chain, branched chain or cycle. Preferably, R²¹ is a cyclic alkyl group, and more preferably at least one of R²² or R²³ is an cyclic alkyl group. Number of carbon atoms thereof is preferably 1-20, more preferably 1-15, most preferably 1-12. As a cyclic alkyl group, a cyclohexyl group is particularly preferred.

The alkyl group and aryl group of the formulae (6) and (7) may have a substituent. Examples of the substituent include, preferably, a halogen atom (for example, chlorine, bromine, fluorine and iodine), an alkyl group, an aryl group, an alkoxy group, an aryloxy group, an acyl group, an alkoxycarbonyl group, an aryloxycarbonyl group, an acyloxy group, a sulfonylamino group, a hydroxyl group, a cyano group, an amino group and an acylamino group, more preferably a halogen atom, an alkyl group, an aryl group, an alkoxy group, an aryloxy group, a sulfonylamino group and an acylamino group, particularly preferably an alkyl group, an aryl group, a sulfonylamino group and an acylamino group.

Preferable examples of the compound represented by the formulae (6) and (7) are shown below, however compounds usable in the invention are not restricted to these specific examples.

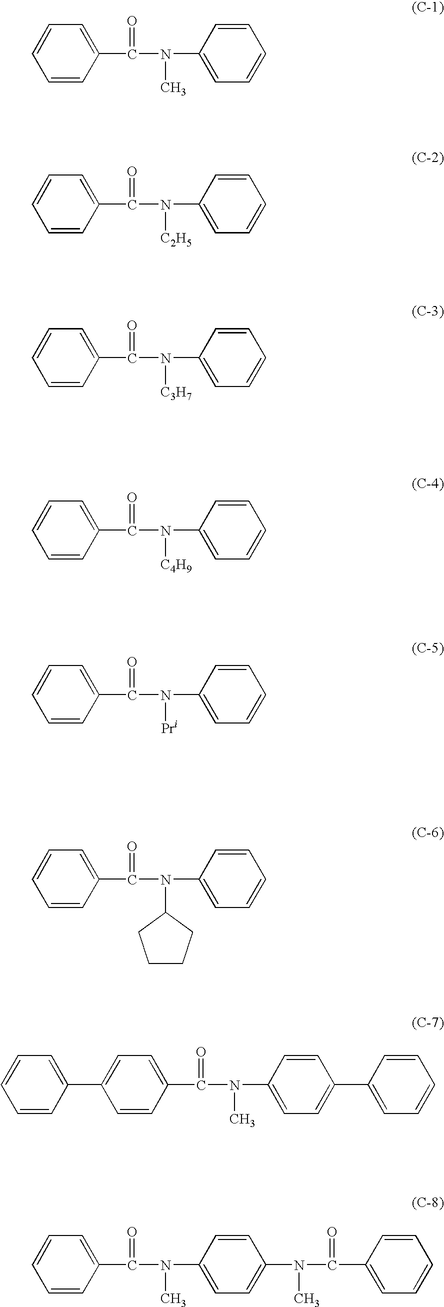

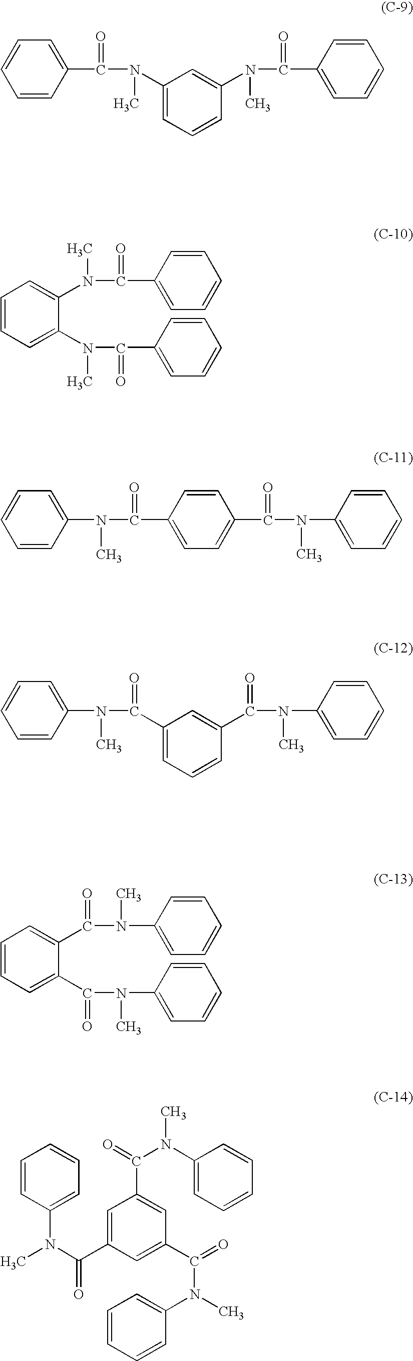

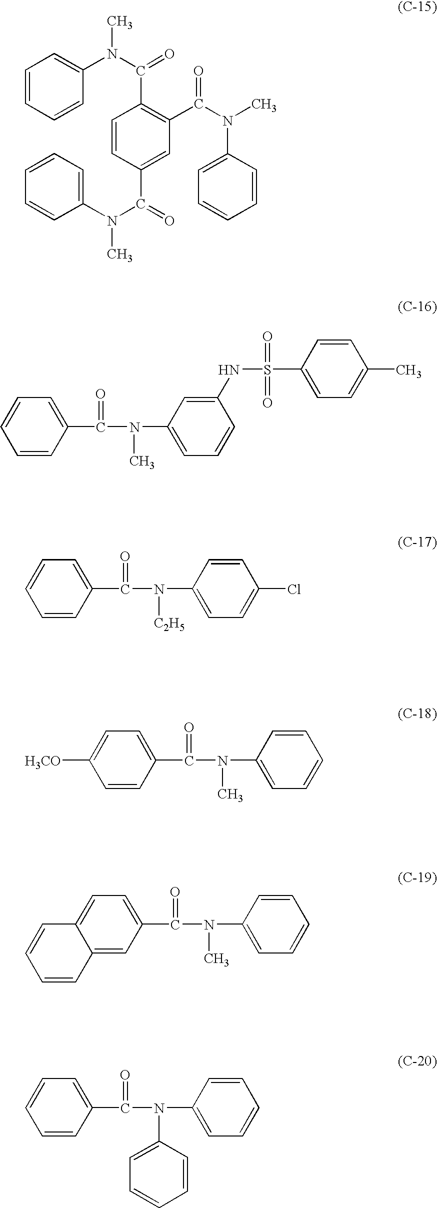

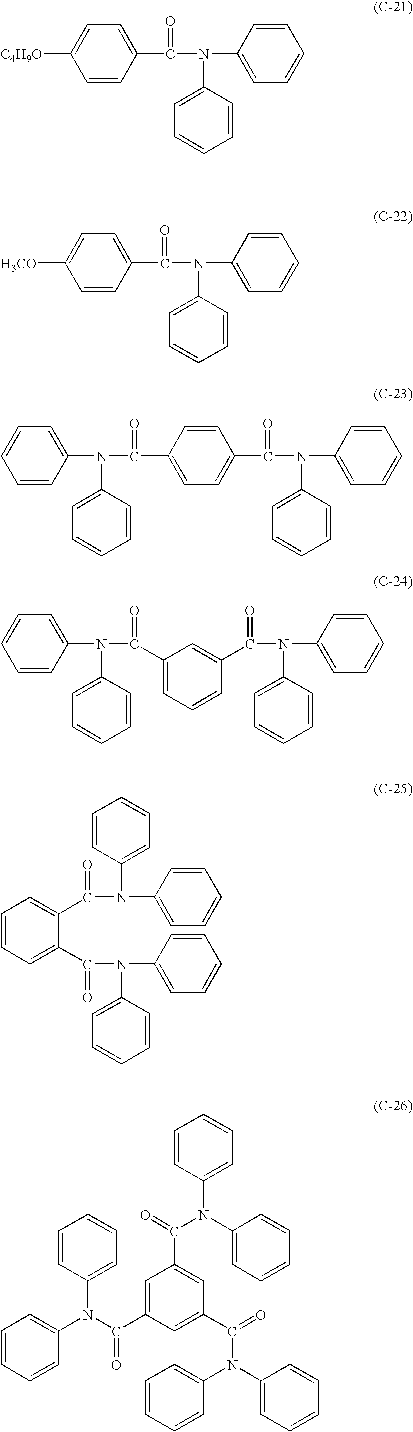

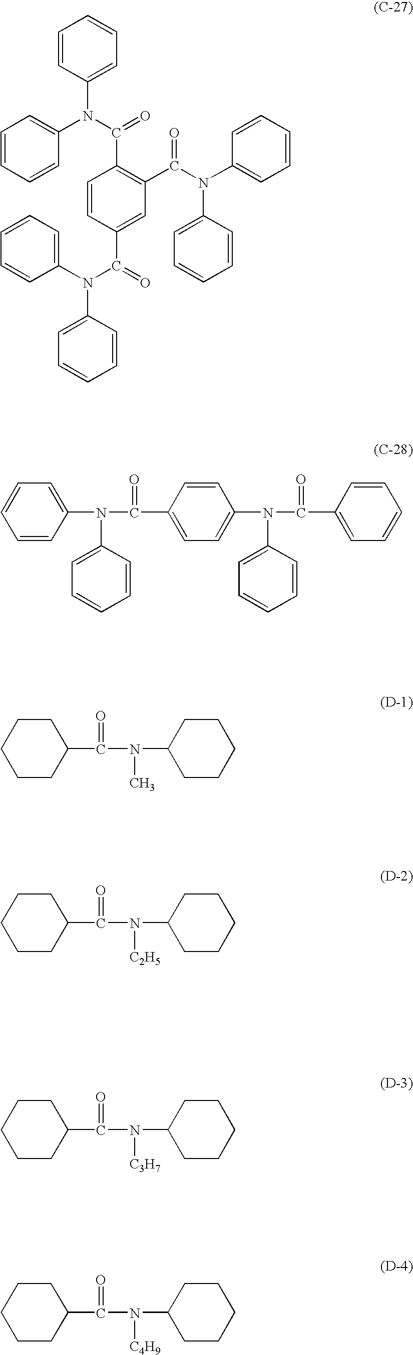

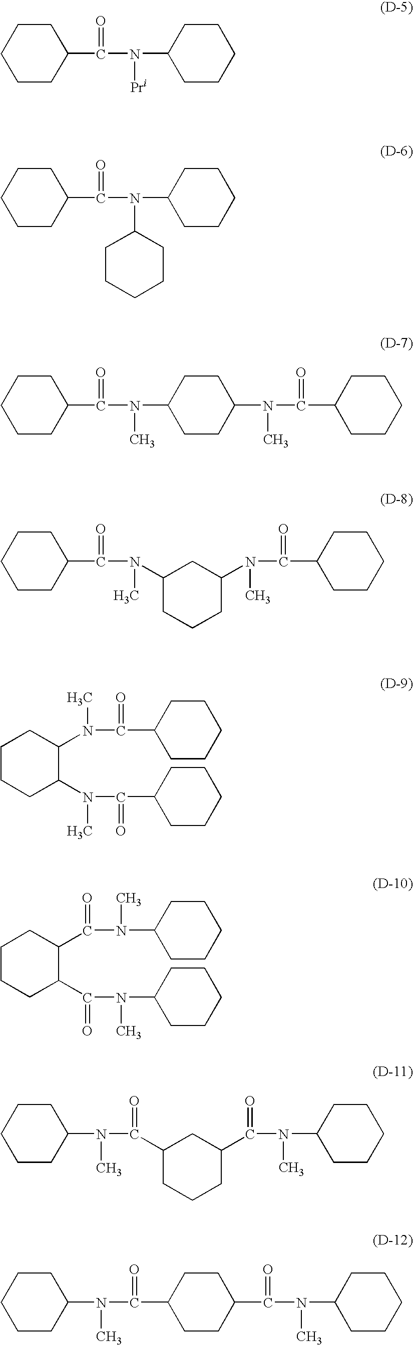

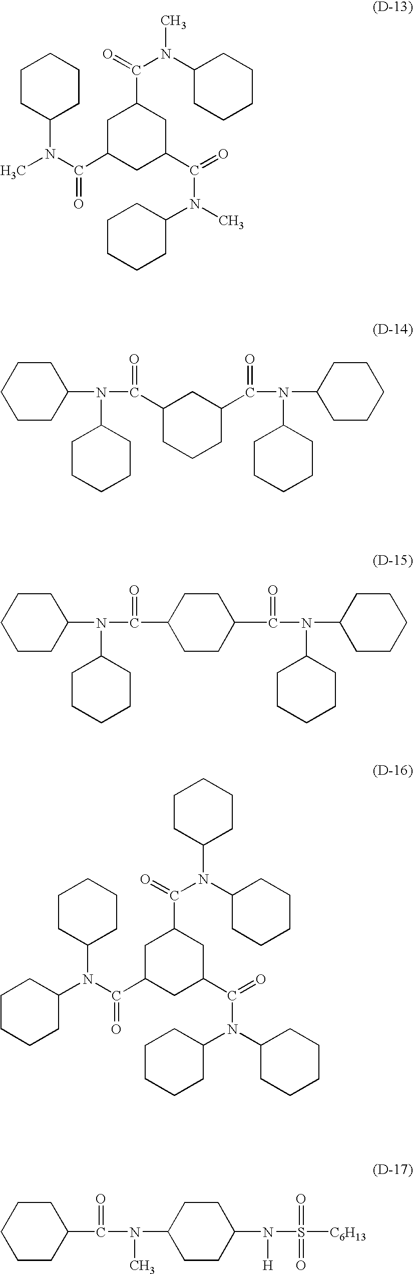

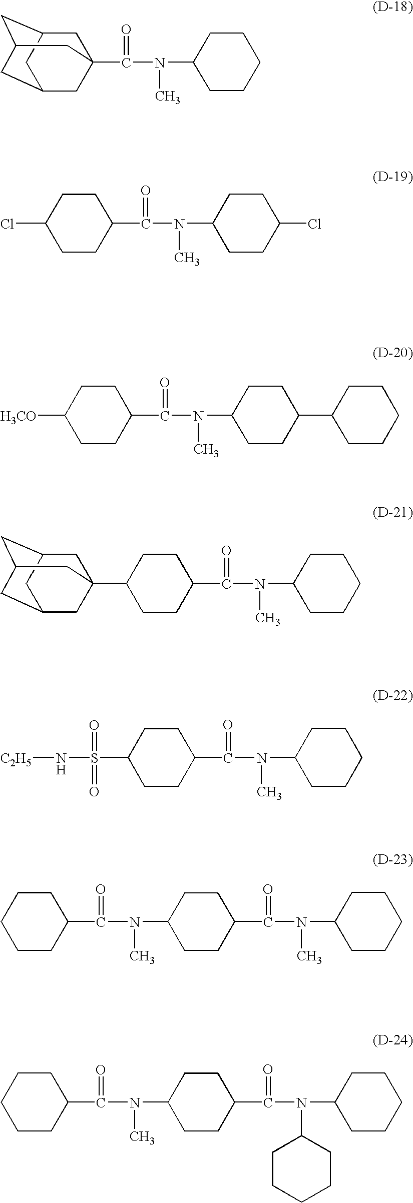

The compound of formula (8) is described in detail hereinunder.

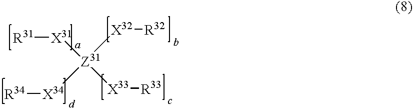

In the above formula (8), R³¹, R³², R³³ and R³⁴ each represent a hydrogen atom, a substituted or unsubstituted aliphatic group, or a substituted or unsubstituted aromatic group, preferably an aliphatic group. The aliphatic group may be linear, branched or cyclic, but is preferably cyclic. As the substituent that the aliphatic group and the aromatic group may have, mentioned are the substituents T given hereinunder; however, the groups are preferably unsubstituted.

X³¹, X³², X³³ and X³⁴ each represent a divalent linking group to be formed by at least one group selected from a single bond, —CO— and —NR³⁵— (R³⁵ represents a substituted or unsubstituted aliphatic group, or a substituted or unsubstituted aromatic group, and is preferably an unsubstituted one and/or an aliphatic group) The combination of X³¹, X³², X³³ and X³⁴ is not specifically defined, but is preferably selected from —CO— and —NR³⁵ —. a, b, c and d each indicate an integer of 0 or more, and are preferably 0 or 1. a+b+c+d is 2 or more, preferably from 2 to 8, more preferably from 2 to 6, even more preferably from 2 to 4. Z³¹ represents a (a+b+c+d)-valent organic group (excluding cyclic ones). The valence of Z³¹ is preferably from 2 to 8, more preferably from 2 to 6, even more preferably from 2 to 4, most preferably 2 or 3. The organic group is a group of an organic compound.

As the compound of above formula (8), the compound of formula (8-1) is preferable

R³¹¹—X³¹¹-Z³¹¹-X³¹²—R³¹² (8-1)

In the above formula (8-1), R³¹¹ and R³¹² each represent a substituted or unsubstituted aliphatic group, or a substituted or unsubstituted aromatic group, preferably an aliphatic group. The aliphatic group may be linear, branched or cyclic, but is preferably cyclic. As the substituent that the aliphatic group and the aromatic group may have, mentioned are the substituents T given hereinunder; however, the groups are preferably unsubstituted. X³¹¹ and X³¹² each independently represent —CONR³¹³— or NR³¹⁴CO—; R³¹³ and R³¹⁴ each represent a substituted or unsubstituted aliphatic group, or a substituted or unsubstituted aromatic group, and are preferably an unsubstituted one and/or an aliphatic group. Z³¹¹ represents a divalent organic group (excluding cyclic ones) formed of one or more groups selected from —O—, —S—, —SO—, —SO₂—, —CO—, —NR³¹⁵—(R³¹⁵ represents a substituted or unsubstituted aliphatic group, or a substituted or unsubstituted aromatic group, and are preferably an unsubstituted one and/or an aliphatic group), an alkylene group and an arylene group. The combination for Z³¹¹ is not specifically defined, for which preferred are those selected from —O—, —S—, —NR³¹⁵— and an alkylene group, more preferred are those selected from —O—, —S— and an alkylene group.

As the compound of above formula (8-1), the compound of formulae (8-2) to (8-4) is preferable.

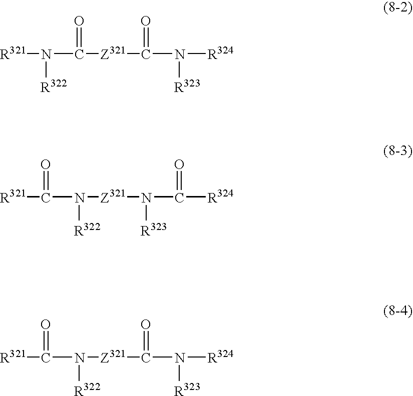

In the above formula (8-2) to (8-4), R³²¹, R³²², R³²³, and R³²⁴ each represent a substituted or unsubstituted aliphatic group, or a substituted or unsubstituted aromatic group, preferably an aliphatic group. The aliphatic group may be linear, branched or cyclic, but is preferably cyclic. As the substituent that the aliphatic group and the aromatic group may have, mentioned are the substituents T given hereinunder; however, the groups are preferably unsubstituted. Z³²¹ represents a divalent organic group (excluding cyclic ones) formed of one or more groups selected from —O—, —S—, —SO—, —SO₂—, —CO—, —NR³²⁵— (R³²⁵ represents a substituted or unsubstituted aliphatic group, or a substituted or unsubstituted aromatic group, and are preferably an unsubstituted one and/or an aliphatic group), an alkylene group and an arylene group. The combination for Z³²¹ is not specifically defined, for which preferred are those selected from —O—, —S—, —NR³²⁵— and an alkylene group, more preferred are those selected from —O—, —S— and an alkylene group, and most preferred are those selected from —O—, —S— and an alkylene group.

The substituted or unsubstituted aliphatic group is described in detail hereinunder. The aliphatic group may be a straight chain, a branch chain, or a circle, and numbers of the carbon atoms thereof is preferably 1-25, more preferably 6-25, and particularly preferably 6-20. Specific examples of the aliphatic group include, for example, methyl group, ethyl group, n-propyl group, isopropyl group, cyclopropyl group, n-butyl group, isobutyl group, tert-butyl group, amyl group, isoamyl group, tert-amyl group, n-hexyl group, cyclohexyl group, n-heptyl group, n-octyl group, bicyclooctyl group, adamantyl group, n-decyl group, tert-octyl group, dodecyl group, hexadecyl group, octadecyl group, didecyl group, etc.

The aromatic group is described in detail hereinunder.

The aromatic group may be an aromatic hydrocarbon group or an aromatic hetero ring group, and more preferably an aromatic hydrocarbon group. As the aromatic hydrocarbon group, number of carbon atoms thereof is preferably 6-24, further preferably 6-12. As an example of an aromatic hydrocarbon group, for example, benzene, naphthalene, anthracene, biphenyl, terphenyl, etc. As an aromatic hydrocarbon group, benzene, naphthalene and biphenyl are particularly preferable. As the aromatic hetero ring group, one containing at least one of an oxygen atom, a nitrogen atom, or a sulfur atom is preferable. As a specific example of the hetero ring, for example, furan, pyrrole, thiophene, imidazole, pyrazole, pyridine, and pyrazine, triazol, triazine, indole, indazole, purine, thiazoline, thiadiazol, oxazoline, oxazal, oxadiazole, quinoline, isoquinoline, phthalazine, naphthyridine, quinoxaline, quinazoline, cinnoline, pteridine, acridine, phenanthroline, phenazine, tetrazol, benzimidazole, benzoxazol, benzthiazol, benztriazol, tetrazaindene, etc. As the aromatic hetero ring group, pyridine, triazine and quinoline are particularly preferable.

The substituent T is described in detail hereinunder.

Examples of the substituent T include an alkyl group (including, preferably, 1-20 carbon atoms, more preferably 1-12 carbon atoms, particularly preferably 1-8 carbon atoms, such as a methyl group, an ethyl group, an isopropyl group, a tert-butyl group, a n-octyl group, a n-decyl group, a n-hexadecyl group, a cyclopropyl group, a cyclopentyl group and a cyclohexyl group), an alkenyl group (including, preferably, 2-20 carbon atoms, more preferably 2-12 carbon atoms, particularly preferably 2-8 carbon atoms, such as a vinyl group, an allyl group, a 2-butenyl group and a 3-pentenyl group), an alkynyl group (including, preferably, 2-20 carbon atoms, more preferably 2-12 carbon atoms, particularly preferably 2-8 carbon atoms, such as a propagyl group and a 3-pentynyl group), an aryl group (including, preferably, 6-30 carbon atoms, more preferably 6-20 carbon atoms, particularly preferably 6-12 carbon atoms, such as a phenyl group, a p-methylphenyl group and a naphthyl group), amino group (including, preferably, 0-20 carbon atoms, more preferably 0-10 carbon atoms, particularly preferably 0-6 carbon atoms, such as an amino group, a methylamino group, a dimethylamino group, a diethylamino group and a dibenzylamino group), an alkoxy group (including, preferably, 1-20 carbon atoms, more preferably 1-12 carbon atoms, particularly preferably 1-8 carbon atoms, such as a methoxy group, an ethoxy group and a butoxy group), an aryloxy group (including, preferably, 6-20 carbon atoms, more preferably 6-16 carbon atoms, particularly preferably 6-12 carbon atoms, such as a phenyloxy group and a 2-naphthyloxy group), an acyl group (including, preferably, 1-20 carbon atoms, more preferably 1-16 carbon atoms, particularly preferably 1-12 carbon atoms, such as an acetyl group, a benzoyl group, a formyl group and a pivaloyl group), an alkoxycarbonyl group (including, preferably, 2-20 carbon atoms, more preferably 2-16 carbon atoms, particularly preferably 2-12 carbon atoms, such as a methoxycarbonyl group and an ethoxycarbonyl group), an aryloxycarbonyl group (including, preferably, 7-20 carbon atoms, more preferably 7-16 carbon atoms, and particularly preferably 7-10 carbon atoms, such as a phenyloxycarbonyl group), an acyloxy group (including, preferably, 2-20 carbon atoms, more preferably 2-16 carbon atoms, particularly preferably 2-10 carbon atoms, such as an acetoxy group and a benzoyloxy group), an acylamino group (including, preferably, 2-20 carbon atoms, more preferably 2-16 carbon atoms, particularly preferably 2-10 carbon atoms, such as an acetylamino group and a benzoylamino group), an alkoxycarbonylamino group (including, preferably, 2-20 carbon atoms, more preferably 2-16 carbon atoms, particularly preferably 2-12 carbon atoms, such as a methoxycarbonylamino group), an aryloxycarbonylamino group (including, preferably, 7-20 carbon atoms, more preferably 7-16 carbon atoms, particularly preferably 7-12 carbon atoms, such as a phenyloxycarbonylamino group), a sulfonylamino group (including, preferably, 1-20 carbon atoms, more preferably 1-16 carbon atoms, particularly preferably 1-12 carbon atoms, such as a methanesulfonylamino group and a benzenesulfonylamino group), a sulfamoyl group (including, preferably, 0-20 carbon atoms, more preferably 0-16 carbon atoms, particularly preferably 0-12 carbon atoms, such as a sulfamoyl group, a methylsulfamoyl group, a dimethylsulfamoyl group and a phenylsulfamoyl group), a carbamoyl group (including, preferably, 1-20 carbon atoms, more preferably 1-16 carbon atoms, particularly preferably 1-12 carbon atoms, such as a carbamoyl group, a methylcarbamoyl group, a diethylcarbamoyl group and a phenylcarbamoyl group), an alkylthio group (including, preferably, 1-20 carbon atoms, more preferably 1-16 carbon atoms, particularly preferably 1-12 carbon atoms, such as a methylthio group and an ethylthio group), an arylthio group (including, preferably, 6-20 carbon atoms, more preferably 6-16 carbon atoms, particularly preferably 6-12 carbon atoms, such as a phenylthio group), a sulfonyl group (including, preferably, 1-20 carbon atoms, more preferably 1-16 carbon atoms, particularly preferably 1-12 carbon atoms, such as a mesyl group and a tosyl group), a sulfinyl group (including, preferably, 1-20 carbon atoms, more preferably 1-16 carbon atoms, particularly preferably 1-12 carbon atoms, such as a methanesulfinyl group and a benzenesulfinyl group), an ureide group (including, preferably, 1-20 carbon atoms, more preferably 1-16 carbon atoms, and particularly preferably 1-12 carbon atoms, such as an ureide group, a methylureide group and a phenylureide group), a phosphoric amide group (including, preferably, 1-20 carbon atoms, more preferably 1-16 carbon atoms, particularly preferably 1-12 carbon atoms, such as a diethylphosphoric amide group and a phenylphosphoric amide group), a hydroxyl group, a mercapto group, a halogen atom (such as a fluorine atom, a chlorine atom, a bromine atom, an iodine atom and etc.), a cyano group., a sulfa group, a carboxyl group, a nitro group, a hydroxamic acid group, a sulfino group, a hydrazino group, an imino group, a heteroring group (including, preferably, 1-30 carbon atoms, more preferably 1-12 carbon atoms, wherein examples of the hetero atom include a nitrogen atom, an oxygen atom and a sulfur atom, and specific examples include an imidazolyl group, a pyridyl group, a quinolyl group, a furyl group, a piperidyl group, a morphorino group, a benzoxysazolyl group, a benzimidazolyl group and a benzothiazolyl group), and a silyl group (including, preferably, 3-40 carbon atoms, more preferably 3-30 carbon atoms, particularly preferably 3-24 carbon atoms, such as a trimethylsilyl group and a triphenylsilyl group). These substituents may further have a substituent. When there are two substituents or more, they may be same with or different from each other. Further, when possible, they may be linked with each other to form a ring.

Preferable examples of the compound represented by the formula (8) are shown below, however compounds usable in the invention are not restricted to these specific examples.

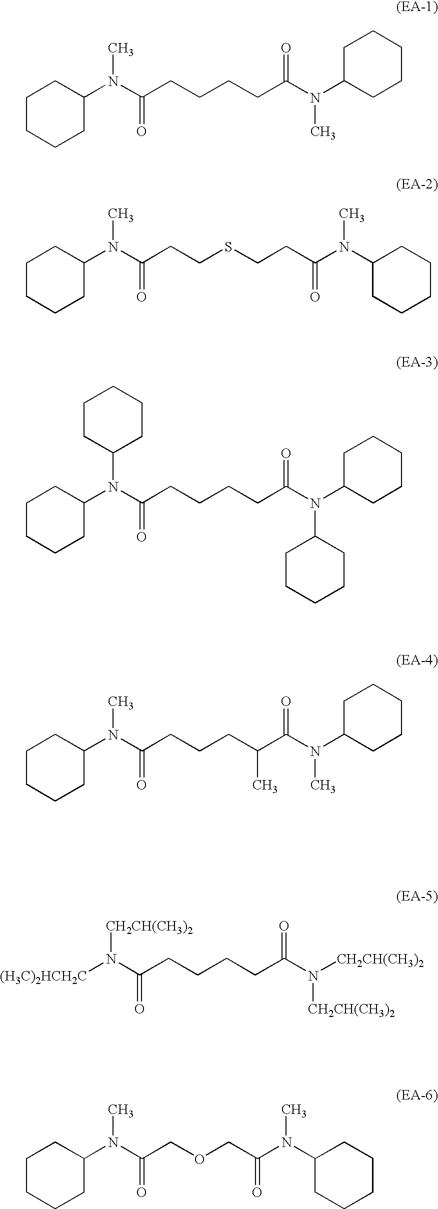

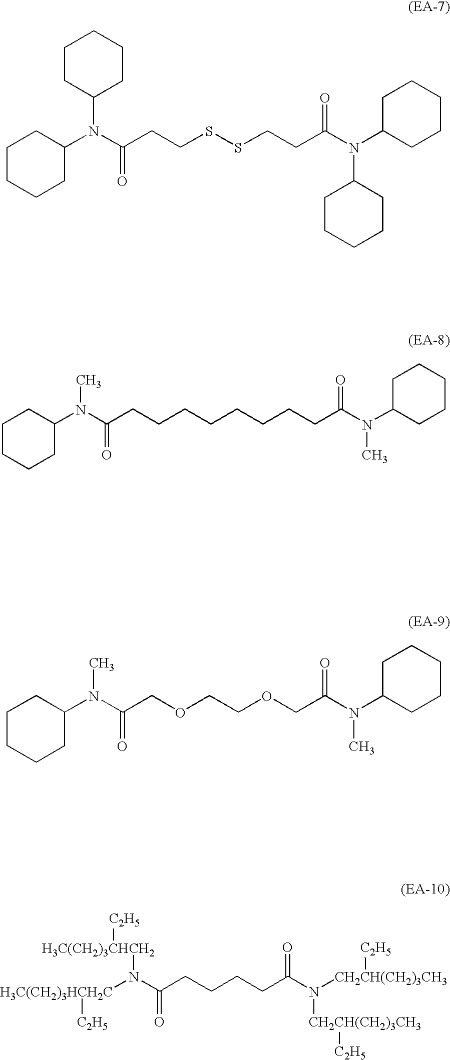

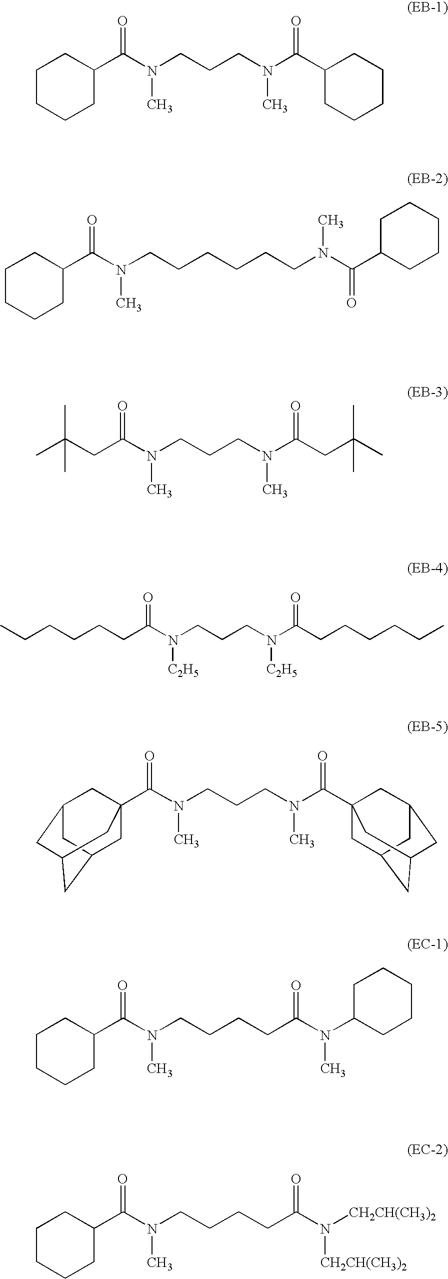

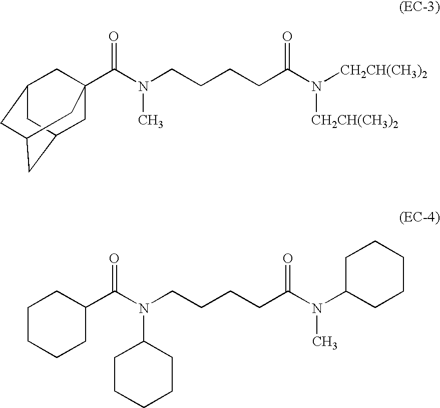

The compounds of formula (6), formula (7) and formula (8) may be obtained through dehydrating condensation of carboxylic acids and amines or substitution reaction between carboxylic acid chloride derivatives and amine derivatives, using a condensing agent (e.g., dicyclohexylcarbodiimide (DCC) or the like).

The retardation reducing agent is added in an amount of preferably from 0.01 to 30% by mass of the cellulose resin, more preferably from 0.1 to 20% by mass of the cellulose resin, still more preferably from 0.1 to 10% by mass of the cellulose resin.

When the retardation reducing agent is added in an amount of at most 30% by mass, compatibility with the cellulose resin can be improved and whitening can be inhibited. When two or more retardation reducing agents are used, the sum amount of the agents is preferably within the above range.

### (Other Additives)

The cellulose ester film of the invention may contain any other additives, in addition to the above-mentioned high-molecular-weight additive, polymer X and retardation enhancer. The other additives include antiaging agent, UV absorbent, release promoter, plasticizer, etc.

### (Antioxidant)

Any known antioxidant may be added to the cellulose ester solution in the invention. For example, phenolic or hydroquinone-based antioxidants may be added, including 2,6-di-tert-butyl-4-methylphenol, 4,4′-thiobis-(6-tert-butyl-3-methylphenol), 1,1′-bis(4-hydroxyphenyl)cyclohexane, 2,2′-methylenebis(4-ethyl-6-tert-butylphenol), 2,5-di-tert-butylhydroquinone, pentaerythrityl tetrakis[3-(3,5-di-tert-butyl-4-hydroxyphenyl)propionate], etc. Also preferred are phosphorus containing antioxidants such as tris(4-methoxy-3,5-diphenyl)phosphite, tris(nonylphenyl)phosphite, tris(2,4-di-tert-butylphenyl)phosphite, bis(2,6-di-tert-butyl-4-methylphenyl)pentaerythritol diphosphite, bis(2,4-di-tert-butylphenyl)pentaerythritol diphosphite, etc. The amount of the antioxidant to be added may be from 0.05 to 5.0 parts by mass relative to 100 parts by mass of the cellulose resin.

### (UV Absorbent)

From the viewpoint of preventing the deterioration of polarizers and liquid crystals, a UV absorbent is favorably added to the cellulose ester solution in the invention. Preferably, the UV absorbent has an excellent UV-absorbing capability at a wavelength of at most 370 nm, and has little absorption of visible light having a wavelength of at least 400 nm, from the viewpoint of good liquid crystal display capability. Preferred examples of the UV absorbent for use in the invention include hindered phenol compounds, hydroxybenzophenone compounds, benzotriazole compounds, salicylate compounds, benzophenone compounds, cyanoacrylate compounds, nickel complex compounds, etc. Examples of the hindered phenol compounds include 2,6-di-tert-butyl-p-cresol, pentaerythrityl tetrakis[3-(3,5-di-tert-butyl-4-hydroxyphenyl)propionate], N,N′-hexamethylenebis(3,5-di-tert-butyl-4-hydroxy-hydrocinnamide), 1,3,5-trimethyl-2,4,6-tris(3,5-di-tert-butyl-4-hydroxybenzyl)benzene, tris-(3,5-di-tert-butyl-4-hydroxybenzyl)isocyanurate, etc. Examples of the benzotriazole compounds include 2-(2′-hydroxy-5′-methylphenyl)benzotriazole, 2,2-methylenebis(4-(1,1,3,3-tetramethylbutyl)-6-(2H-benzotriazol-2-yl)phenol), (2,4-bis(n-octylthio)-6-(4-hydroxy-3,5-di-tert-butylanilino)-1,3,5-triazine, triethylene glycol-bis[3-(3-tert-butyl-5-methyl-4-hydroxyphenyl)propionate], N,N′-hexamethylenebis(3,5-di-tert-butyl-4-hydroxy-hydrocinnamide), 1,3,5-trimethyl-2,4,6-tris(3,5-di-tert-butyl-4-hydroxybenzyl)benzene, 2-(2′-hydroxy-3′,5′-di-tert-butylphenyl) 5-chlorobenzotriazole, 2-(2′-hydroxy-3′,5′-di-tert-amylphenyl)-5-chlorobenzotriazole, 2,6-di-tert-butyl-p-cresol, pentaerythrityltetrakis[3-(3,5-di-tert-butyl-4-hydroxyphenyl)propionate], etc. The amount of the UV absorbent to be added is preferably from 1 ppm to 1.0%, more preferably from 10 to 1000 ppm in terms of the ratio by mass thereof in the entire cellulose ester film.

### (Release Promoter)

The film of the invention may contain a release promoter. The release promoter may be, for example, in an amount of from 0.001 to 1% by mass. Any known release promoter may be used herein, and for example, ethyl citrate and the like are mentioned as its examples.

### (Plasticizer)

For improving the mechanical properties of the film of the invention or for increasing the drying speed thereof, a plasticizer may be added to the film. As the plasticizer, usable are phosphates or carboxylates. Examples of the phosphates include triphenyl phosphate (TPP), biphenyl diphenyl phosphate (BDP) and tricresyl phosphate (TCP). The carboxylates are typically phthalates and citrates. Examples of the phthalates include dimethyl phthalate (DMP), diethyl phthalate (DEP), dibutyl phthalate (DBP), dioctyl phthalate (DOP), diphenyl phthalate (DPP) and diethylhexyl phthalate (DEHP). Examples of the citrates include triethyl O-acetylcitrate (OACTE) and tributyl O-acetylcitrate (OACTB). Examples of other carboxylates include butyl oleate, methylacetyl ricinoleate, dibutyl sebacate, and various trimellitates. Preferred for use herein are phthalate plasticizers (DMP, DEP, DBP, DOP, DPP, DEHP). More preferred is a mixture of DEP and DPP (1:1). The amount of the plasticizer to be added is preferably from 0.1 to 25% by mass of the cellulose resin, more preferably from 1 to 20% by mass of the cellulose resin.

Apart from these low-molecular-weight plasticizers, polyester polymers are also usable as plasticizer in the invention, such as those mentioned hereinabove as high-molecular-weight additives.

### [Cellulose Ester Film]

The cellulose ester film of the invention is characterized by comprising a cellulose ester resin having a degree of acyl substitution of at least 2.3, and at least one, above-mentioned polymer X.

The cellulose ester film may be a single-layered film or a multilayered film. For example, in case where the cellulose ester film of the invention is produced through co-casting, it may have at least two layers of a core layer and a skin layer. In this case, the polymer X may be in any of the core layer or the skin layer, but is preferably in the core layer.

### (Mean Water Content)

The cellulose ester film of the invention preferably has an equilibrium water content of at most 10% at 25° C. and 60% RH, more preferably at most 5%, even more preferably at most 3%. Having a mean water content of at most 10%, the film may well answer to the ambient humidity change and is therefore favorable since the optical properties and the dimension thereof change little.

### (Retardation)

Re(λ) and Rth(λ) represent, herein, the retardation in the plane and the retardation in the thickness direction, respectively, at a wavelength of λ. Re(λ) is measured with KOBRA 21ADH or WR (by Oji Scientific Instruments) while allowing light having the wavelength of λ nm to enter in the normal direction of a film.

With the in-plane slow axis (determined by KOBRA 21ADH or WR) taken as the inclination axis (rotation axis) of the sample (in case where the sample has no slow axis, the rotation axis of the sample may be in any in-plane direction of the sample), Re(λ) of the sample is measured at 6 points in all thereof, up to +50° relative to the normal line direction of the sample at intervals of 10°, by applying a light having a wavelength of λ nm from the inclined direction of the sample.

With the slow axis taken as the inclination axis (rotation axis) (in case where the sample has no slow axis, the rotation axis of the sample may be in any in-plane direction of the film), the retardation values of the sample are measured in any inclined two directions; and based on the data and the mean refractive index and the inputted thickness of the sample, Rth may be calculated according to the following formulae (11) and (12).

The mean refractive index may be used values described in catalogs for various types of optical films. When the mean refractive index has not known, it may be measured with Abbe refractometer. The mean refractive index for major optical film is described below: cellulose acylate (1.48), cycloolefin polymer (1.52), polycarbonate (1.59), polymethylmethacrylate (1.49), polystyrene (1.59).

By inputting the value of these average refraction indices and thickness, KOBRA 21ADH or WR computes nx, ny, nz. From the computed nx, ny, nz, Nz=(nx−nz)/(nx−ny) is computed further.

$$Re ( θ ) - [ nx - \frac{ny \times nz}{\sqrt{\begin{matrix}{\{ ny sin ( {sin}^{- 1} ( \frac{sin ( - θ )}{nx} ) ) \}}^{2} + \\ {\{ nz cos ( {sin}^{- 1} ( \frac{sin ( - θ )}{nx} ) ) \}}^{2}\end{matrix}}} ] \times \frac{d}{cos \{ {sin}^{- 1} ( \frac{sin ( - θ )}{nx} ) \}} \qquad ( 11 )$$

The above Re (θ) represents the retardation in a direction that inclines in the degree of θ from the normal direction; and d is a thickness of the film.

Rth={(nx+ny)/2−nz}×d (12)

In this, the mean refractive index n is needed as a parameter, and it is measured with an Abbe refractiometer (Atago's Abbe Refractiometer 2-T).

The preferred range of the retardation of the cellulose ester film changes depending on the use thereof. Rth of the cellulose ester film of the invention is 0 nm<Rth. Preferably, 40 nm≦Rth<300 nm, more preferably 50 nm<Rth<280 nm, even more preferably 80 nm<Rth<250 nm.

Re of the film is preferably 0 nm<Re<100 nm, more preferably 20 nm<Re<80 nm, even more preferably 30 nm<Re<70 nm.

### (Humidity Stability of Rth)

The optical properties of the cellulose ester film of the invention change little with change in the ambient humidity. To that effect, the humidity dependence of the optical properties of the film is reduced, and therefore, the film may have a high retardation even under high humidity condition, comparable to the retardation thereof at ordinary temperature. The cellulose ester film of the invention is therefore favorable for use under high humidity condition.

The cellulose ester film of the invention preferably satisfies the following formula (3):

0≦|ΔRth(10-80)|≦20 nm (3)

wherein ΔRth(10-80) indicates a difference between Rth at 25° C. and 10% RH and Rth at 25° C. and 80% RH.

More preferably, the cellulose ester film of the invention satisfies the following formula (8):

0≦|ΔRth(10-80)|≦15 nm (8)

wherein ΔRth(10-80) indicates a difference between Rth at 25° C. and 10% RH and Rth at 25° C. and 80% RH.

### (Wet Heat Durability of Rth)

When stored for a long period of time under high-temperature high-humidity condition, the optical properties of the cellulose film of the invention change little. To that effect, the wet heat durability of the optical properties of the film of the invention is enhanced, and therefore the film can exhibit a high retardation for a long period of time under high-temperature high-humidity condition. Accordingly, the cellulose ester film of the invention is favorable for use in high-temperature high-humidity condition.

Preferably, the absolute value of the Rth change of the cellulose ester film of the invention before and after 24 hours at 60° C. and 90% RH, ΔRth(60° C. 90% RH) is at most 20 nm, more preferably at most 15 nm, even more preferably at most 10 nm.

### (Wet Heat Durability of Dimensional Change Resistance)

When stored for a long period of time under high-temperature high-humidity condition, the dimensional change of the cellulose ester film of the invention is small. As improved in point of the wet heat durability of the dimensional change resistance thereof, the cellulose ester film of the invention is favorable for use under high-temperature high-humidity condition.

Preferably, the absolute value of the dimensional change of the cellulose ester film of the invention before and after 24 hours at 60° C. and 90% RH, is at most 0.4%, more preferably at most 0.2%.

### (Film Thickness)

Preferably, the thickness of the cellulose ester film of the invention is from 20 to 80 μm, more preferably from 30 to 70 μm, even more preferably from 35 to 55 μm. Having a thickness of at least 20 μm, the film is favorable since the handlability thereof in producing a web-like film is good. Having a thickness of at most 80 μm, the film is also favorable since it readily answers to the ambient moisture change and may readily maintain its optical properties.

### [Production of Cellulose Ester Film]

For producing the film of the invention, widely employable is any known method for producing an ordinary cellulose ester film. Preferably, the film is produced according to a solvent casting method.

Organic solvents are preferably selected from ethers having 3-12 carbon atoms, esters having 3-12 carbon atoms, ketones having 3-12 carbon atoms and halogenated hydrocarbons having 1-6 carbon atoms. The ethers, the ketones and the esters may have a cyclic structure. Compounds having two or more functional groups of ethers; esters and ketones (i.e., —O—, —CO— and —COO—) are also usable herein as the organic solvent; and they may have any other functional group such as an alcoholic hydroxyl group. In case where the organic solvent has two or more functional groups, the number of the carbon atoms constituting them may fall within a range of the number of carbon atoms that constitute the compound having any of those functional groups.

Examples of the ethers having 3-12 carbon atoms are diisopropyl ether, dimethoxymethane, dimethoxyethane, 1,4-dioxane, 1,3-dioxolane, tetrahydrofuran, anisole and phenetole.

Examples of the ketones having 3-12 carbon atoms are acetone, methyl ethyl ketone, diethyl ketone, diisobutyl ketone, cyclohexanone, methylcyclohexanone.

Examples of the esters having 3-12 carbon atoms are ethyl formate, propyl formate, pentyl formate, methyl acetate, ethyl acetate, pentyl acetate.

Examples of the organic solvents having plural functional groups are 2-ethoxyethyl acetate, 2-methoxyethanol and 2-butoxyethanol.

The number of the carbon atoms constituting the halogenohydrocarbon is preferably 1 or 2, most preferably 1. The halogen in the halogenohydrocarbon is preferably chlorine. The proportion of the hydrogen atoms in the halogenohydrocarbon substituted with a halogen is preferably from 25 to 75 mol %, more preferably from 30 to 70 mol %, even more preferably from 35 to 65 mol %, most preferably from 40 to 60 mol %. Methylene chloride is a typical halogenohydrocarbon.

Two or more different types of organic solvents may be mixed for use in the invention.

The cellulose ester solution may be prepared according to an ordinary method In one general method, the solution is processed at a temperature not lower than 0° C. (room temperature or high temperature). For preparing the solution, employable is a method and an apparatus for dope preparation according to an ordinary solvent casting method. In the ordinary method, preferably used is a halogenohydrocarbon (especially methylene chloride) as the organic solvent.

The amount of the cellulose ester is so controlled that it may be in the solution in an amount of from 10 to 40% by mass. The amount of the cellulose ester is preferably from 10 to 30% by mass. To the organic solvent (main solvent), polymer X and any additives mentioned above can be added.

The solution is prepared by stirring a cellulose ester and an organic solvent at room temperature (0 to 40° C.). A high-concentration solution may be stirred under pressure and under heat. Concretely, a cellulose ester and an organic solvent are put into a pressure chamber, then closed and stirred therein and under heat at a temperature within a range between the boiling point of the solvent at room temperature and the boiling point under the pressure. The heating temperature is generally 40° C. or higher, preferably from 60 to 200° C., more preferably from 80 to 110° C.

The ingredients may be put into the chamber after roughly premixed. They may be put into the chamber one after another. The chamber must be so planned that the contents therein could be stirred. An inert gas such as nitrogen gas or the like may be introduced into the chamber to pressurize it. The solvent vapor pressure may increase under heat, and this may be utilized in process. Alternatively, after the chamber is closed, the ingredients may be introduced thereinto under pressure.

Preferably, the contents in the chamber are heated in an external heating mode. For example, a jacket type heating unit may be used. A plate heater may be disposed outside the chamber, and a liquid may be circulated through the pipeline disposed in the heater to thereby heat the entire chamber.

Also preferably, a stirring blade may be disposed inside the chamber, with which the contents may be stirred. The stirring blade preferably has a length that reaches near the wall of the chamber. At the tip of the stirring blade, a scraper is preferably provided for renewing the liquid film formed on the wall of the chamber.

The chamber may be equipped with various meters such as a pressure gauge, a thermometer, etc. In the chamber, the ingredients are dissolved in the solvent. Thus prepared, the dope is taken out of the chamber after cooled, or after taken out of it, the dope may be cooled with a heat exchanger or the like.

The solution may also be prepared according to a cooling dissolution method. According to the cooling dissolution method, a cellulose ester may be dissolved even in an organic solvent in which it can be hardly dissolved in an ordinary dissolution method. For the solvent in which a cellulose ester can be dissolved in an ordinary dissolution method, the cooling dissolution method is advantageous in that a uniform solution can be prepared rapidly.

In the cooling dissolution method, first, a cellulose ester is gradually added to an organic solvent at room temperature with stirring. The amount of the cellulose ester is so controlled that the resulting mixture can contain it in an amount of from 10 to 40% by mass. The amount of the cellulose ester is more preferably from 10 to 30% by mass. Further, any desired additives to be mentioned below may be added to the mixture.

Next, the mixture is cooled to −100 to −10° C. (preferably −80 to −10° C., more preferably −50 to −20° C., most preferably −50 to −30° C.). The cooling may be attained, for example, in a dry ice/methanol bath (−75° C.) or in a cooled diethylene glycol solution (−30 to −20° C.). Thus cooled, the mixture of cellulose ester and organic solvent is solidified.

The cooling speed is preferably at least 4° C./min, more preferably at least 8° C./min, most preferably at least 12° C./min. The cooling speed is preferably higher, but its theoretical uppermost limit is 10000° C./sec, the technical uppermost limit is 1000° C./sec, and the practicable uppermost limit is 100° C./sec. The cooling speed is a value computed by dividing the difference between the temperature at the start of the cooling and the final cooling temperature by the time taken from the start of the cooling to the arrival to the final cooling temperature.

Further, this is heated at 0 to 200° C. (preferably 0 to 150° C., more preferably 0 to 120° C., most preferably 0 to 50° C.), and the cellulose ester is thereby dissolved in the organic solvent. For the heating, the solid may be left at room temperature, or may be heated in a hot bath The heating speed is preferably at least 4° C./min, more preferably at least 8° C./min, most preferably at least 12° C./min. The heating speed is preferably higher; but its theoretical uppermost limit is 10000° C./sec, the technical uppermost limit is 1000° C./sec, and the practicable uppermost limit is 100° C./sec. The cooling speed is a value computed by dividing the difference between the temperature at the start of the heating and the final heating temperature by the time taken from the start of the heating to the arrival to the final heating temperature.

As in the above, a uniform solution can be obtained. When the dissolution is insufficient, then the cooling and heating operation may be repeated. As to whether or not the dissolution is satisfactory may be determined merely by visually observing the outward appearance of the solution.

In the cooling dissolution method, preferably used is a closed container for the purpose of preventing the mixture from being contaminated with water from the dew formed in cooling. In the cooling and heating operation, preferably, the chamber is made under pressure in cooling and is made under reduced pressure in heating, to thereby shorten the dissolution time. For the mode under pressure and under reduced pressure, preferably used is a pressure chamber.

A 20 mas. % solution prepared by dissolving a cellulose acylate (having a degree of total acetyl substitution of 60.9%, and having a viscosity-average degree of polymerization of 299) in methyl acetate according to the cooling dissolution method has a pseudo-phase transition point between a sol state and a gel state at around 33° C., when analyzed through differential scanning calorimetry (DSC), and at a temperature lower than the point, the solution is in the form of auniform gel. Accordingly, the solution must be stored at a temperature not lower than the pseudo-phase transition temperature, preferably at around a temperature of the gel-phase transition temperature plus 10° C. or so. However, the pseudo-phase transition temperature differs, depending on the degree of total acetyl substitution and the viscosity-average degree of polymerization of the cellulose acylate and on the solution concentration and the organic solvent used.

From the thus-prepared cellulose ester solution (dope), a cellulose ester film can be produced according to a solvent casting method.

The dope is cast on a drum or a band, on which the solvent is evaporated away to form a film. Before case, the concentration of the dope is preferably so planned that the solid content thereof is from 18 to 35% by mass. Preferably, the surface of the drum or the band is finished to be a mirror face. The casting and drying method in solvent casting is described in U.S. Pat. Nos. 2,336,310, 2,367,603, 2,492,078, 2,492,977, 2,492,978, 2,607,704, 2,739,069, 2,739,070, British Patents 640731, 736892, JP-B 45-4554, 49-5614, JP-A 60-176834, 60-203430, 62-115035.

Preferably, the dope is cast on a drum or a band at a surface temperature of not higher than 10° C. After thus cast, preferably, this is dried by exposing to air for at least 2 seconds. The formed film is peeled away from the drum or the band, and then it maybe dried with high-temperature air of which the temperature is stepwise changed from 100° C. to 160° C. to thereby remove the residual solvent by vaporization. This method is described in JP-B 5-17844. According to the method, the time to be taken from the casting to the peeling may be shortened. In carrying out the method, the dope must be gelled at the surface temperature of the drum or the band on which it is cast.

### (Co-Casting)

In the invention, the prepared cellulose ester solution may be cast onto a smooth band or drum serving as a metal support, as a single-layer solution; or plural cellulose ester solutions for 2 or more layers may be co-cast thereon. In case where plural cellulose ester solutions are co-cast, the cellulose ester-containing solution may be cast onto a metal support through plural casting mouths disposed around the support at intervals in the machine direction, and the co-cast solutions may be laminated on the support to give a film. For example, the methods described in JP-A 61-158414, 1-122419, 11-198285 are employable. The cellulose ester solution may be cast through two casting mouths to form a film, for which, for example, employable are the methods described in JP-B 60-27562, JP-A 61-94724, 61-947245, 61-104813, 61-158413, 6-134933. Also employable herein is a cellulose ester film co-casting method of casting a flow of a high-viscosity cellulose ester solution as enveloped with a low-viscosity cellulose ester solution thereby simultaneously extruding both the high-viscosity and low-viscosity cellulose ester solutions, as in JP-A 56-162617. Preferred is an embodiment where the outer solution contains a larger amount of a poor solvent, alcohol than in the inner solution, as in JP-A 61-94724, 61-94725.

Two casting mouths may be used as follows: A film is formed on a metal support through the first casting mouth, then this is peeled, and on the other surface of the film opposite to that having kept in contact with the metal support, another film is formed through the second casting mouth. For example, the method is described in JP-B 44-20235. The cellulose ester solutions to be cast maybe the same or different with no specific limitation. In order to make the plural cellulose ester layers have various functions, cellulose ester solutions corresponding to the desired functions may be cast through the respective casting mouths The cellulose ester solution of the invention may be cast along with any other functional layers (e.g., adhesive layer, dye layer, antistatic layer, antihalation layer, UV absorbent layer, polarizing layer).

In case where a single-layer film is formed according to a conventional technique, a high-concentration and high-viscosity cellulose ester solution must be extruded out in order to make the formed film have a desired thickness; but in such a case, the stability of the cellulose ester solution is poor therefore causing various problems of solid deposition to be fish eyes or to roughen the surface of the film. For solving the problems, plural cellulose ester solutions are cast out through different casting mouths, whereby high-density solutions can be extruded out at the same time on a metal support, and as a result, the surface properties of the formed films are bettered and films having excellent surface properties can be produced. In addition, since such thick cellulose ester solutions can be used and the drying load in the process can be reduced, and the film producibility is enhanced.

In co-casting, the thickness of the outer layer and the inner layer is not specifically defined. Preferably, the thickness of the outer layer is from 1 to 50% of the overall thickness of the film, more preferably from 2 to 30%. In co-casting of three or more layers, the total thickness of the layer adjacent to the metal support and the outermost layer adjacent to air is defined to be the thickness of the outer layer.

In another embodiment of co-casting, cellulose ester solutions in which the density of the additives such as the above-mentioned plasticizer, UV absorbent, mat agent and the like differs may be co-cast to produce a cellulose ester film having a laminate structure. For example, a cellulose ester film having a constitution of skin layer/core layer/skin layer can be produced. For example, the mat agent may be much in the skin layer, or may be only in the skin layer. The plasticizer and the UV absorbent may be more in the core layer than in the skin layer, or may be only in the core layer. The type of the plasticizer and the UV absorbent may differ between the core layer and the skin layer. For example, a low-volatile plasticizer and/or UV absorbent may be in the skin layer, and a plasticizer of excellent plasticization or a UV absorbent of excellent UV absorption may be added to the core layer. An embodiment of adding a release agent to only the skin layer on the side of the metal support is also preferred. In order to gel the solution by cooling the metal support in a cooling drum method, a poor solvent, alcohol may be more in the skin layer than in the core layer, and this is also a preferred embodiment. Tg may differ between the skin layer and the core layer. Preferably, Tg of the skin layer is lower than that of the core layer. The viscosity of the cellulose ester solution to be cast may differ between the skin layer and the core layer. Preferably, the viscosity of the solution for the skin layer is smaller than that for the core layer; however, the viscosity of the solution for the core layer may be smaller than that for the skin layer.

A method of drying the web that is dried on a drum or belt and is peeled away from it is described. The web peeled away at the peeling position just before one lap of the drum or the belt is conveyed according to a method where the web is led to pass alternately through rolls disposed like a houndstooth check, or according to a method where the peeled web is conveyed in a non-contact mode while both sides of the web are held by clips or the like. The drying may be attained according to a method where air at a predetermined temperature is given to both surfaces of the web (film) being conveyed, or according to a method of using a heating means such as microwaves, etc. Rapid drying may damage the surface smoothness of the formed film. Therefore, in the initial stage of drying, the web is dried at a temperature at which the solvent does not bubble, and after having gone on in some degree, the drying may be preferably attained at a high temperature. In the drying step after peeled away from the support, the film tends to shrink in the machine direction or in the cross direction owing to solvent evaporation. The shrinkage may be larger in drying at a higher temperature. Preferably, the shrinkage is inhibited as much as possible for bettering the surface condition of the film to be formed. From this viewpoint, for example, preferred is a method (tenter method) where the entire drying step or a part of the drying step is carried out with both sides of the web held with clips or pins so as to keep the width of the web, as in JP-A 62-46625. The drying temperature in the drying step is preferably from 100 to 145° C. The drying temperature, the drying air amount and the drying time may vary depending on the solvent used, and are therefore suitably selected in accordance with the type and the combination of the solvent to be used. In producing the film of the invention, the web (film) peeled away from the support is stretched preferably when the residual solvent amount in the web is less than 120% by mass.

The residual solvent amount may be represented by the following formula:

Residual Solvent Amount (% by mass)={(M−N)/N}×100

wherein M means the mass of the web at an undefined point, and N means the mass of the web having the mass M, dried at 110° C. for 3 hours. When the residual solvent amount in the web is too much, then the web could not enjoy the effect of its stretching; but when too small, stretching the web is extremely difficult, and the web may be broken. More preferably, the residual solvent amount in the web is from 10 to 50% by mass, even more preferably from 12 to 35% by mass. In case where the draw ratio in stretching is too small, the film could not have a sufficient retardation; but when too large, the film could not be stretched and would be broken.

In the invention, the film produced according to a solution casting method and having a residual solvent amount falling within a specific range can be stretched, not heated at a high temperature; however, preferably, the film is stretched while dried, as the processing process may be shortened. However, when the temperature of the web is too high, then the plasticizer may evaporate away, and therefore, the temperature range is preferably from room temperature (15° C.) to 145° C. A method of stretching the film in two directions perpendicular to each other is effective for controlling the film refractivity, Nx, Ny and Nz to fall within the range of the invention. For example, when the film is stretched in the casting direction and when the shrinkage in the cross direction is too large, then the value Nz may increase too much. In this case, the problem may be solved by reducing the cross shrinkage of the film and by stretching the film in the cross direction. In case where the film is stretched in the cross direction, the film may have a refractivity distribution in the cross direction. This often occurs, for example, when a tenter method is employed for film stretching. This is a phenomenon to he caused by the generation of the shrinking force in the center part of the film while the edges of the film are kept fixed, and this may be considered as a so-called bowing phenomenon. Also in this case, the bowing phenomenon can be prevented by stretching the film in the casting direction, whereby the retardation distribution in the cross direction can be reduced. Further, by stretching the film in two directions perpendicular to each other, the film thickness fluctuation may be reduced. When the film thickness fluctuation of a cellulose ester film is too large, then the distribution fluctuation thereof may also be large. The film thickness fluctuation of the cellulose ester film is preferably within a range of ±3%, more preferably within a range of ±1%. For the above-mentioned objects, the method of stretching the film in two directions perpendicular to each other is effective, and the draw ratio in stretching in two directions perpendicular to each other is preferably from 1.2 to 2.0 times in one direction and from 0.7 to 1.0 time in the other direction. The mode of stretching the film by from 1.2 to 2.0 times in one direction and by from 0.7 to 1.0 time in the other direction means that the distance between the clips and the pins supporting the film is made to be from 0.7 to 1.0 times the distance therebetween before the stretching.

In general, in case where the film is stretched in the cross direction by 1.2 to 2.0 times, using a biaxial stretching tenter, a shrinking force acts on the perpendicular direction thereof, or that is, on the machine direction of the film.

Accordingly, when the film is stretched while a force is kept applied only in one direction, then the width of the film in the other direction perpendicular to that one direction may shrink. The method means that the shrinking degree is controlled without control of the width of the film, or that is, this means that the distance between the clips or the pins for width control is defined to be from 0.7 to 1.0 time the distance therebetween before stretching. In this case, a force of shrinking the film in the machine direction acts on the film owing to the stretching in the cross direction. The distance kept between the clips or the pins in the machine direction makes it possible to prevent any unnecessary tension from being given to the film in the machine direction thereof. The method of stretching the web is not specifically defined. For example, there are mentioned a method of providing plural rolls each running at a different peripheral speed and stretching the film in the machine direction based on the peripheral speed difference between the rolls, a method of holding both sides of the web with clips or pins and expanding the distance between the clips or pins in the machine direction to thereby stretch the film in the machine direction, or expanding the distance therebetween in the cross direction to thereby stretch the film in the cross direction, and a method of expanding the distance both in the machine direction and in the cross direction to thereby stretch film in both the machine and cross directions. Needless-to-say, these methods may be combined. In the so-called tenter method, preferably, the clip parts are driven according to a linear driving system, by which the film may be smoothly stretched with little risk of breaking, etc.

### [Polarizer]

The polarizer of the invention comprises the cellulose ester film of the invention. Typically, the polarizer comprises the cellulose ester film of the invention as a protective film for the polarizing element. A polarizer comprises a polarizing element and a transparent protective film disposed on at least one side of the element, in general two transparent protective films disposed on both sides of the element. In the invention, at least one protective film of the polarizer is formed of the cellulose ester film of the invention. The other protective film may be the cellulose ester film of the invention or may be any other ordinary cellulose acetate film or the like.

As mentioned above, a polarizer is constructed by laminating a polarizer-protective film on at least one surface of a polarizing element. The polarizing element may be any conventional one. For example, this is prepared by processing a hydrophilic polymer film such as a polyvinyl alcohol film with a dichroic dye such as iodine. Not specifically defined, the cellulose ester film may be stuck to the polarizing element in any desired manner, for which, for example, an adhesive of an aqueous solution of a water-soluble polymer may be used. Preferably, the water-soluble polymer adhesive is an aqueous solution of completely-saponified polyvinyl alcohol.

The polarizer may have a retardation film provided on the protective film. Preferably, the retardation film is stuck with an adhesive. As the adhesive, for example, employable are those described in JP-A 2000-109771, 2003-34781.

Preferred embodiments of the constitution of the polarizer of the invention include a constitution of protective film/polarizing element/protective film/liquid crystal cell/cellulose ester film of the invention/polarizing element/polarizer-protective film; or a constitution of polarizer-protective film/polarizing element/cellulose ester film of the invention/liquid crystal cell/cellulose ester film of the invention/polarizing element/polarizer-protective film In particular, the polarizer of the invention is favorably stuck to a TN-mode, VA-mode or OCB-mode liquid crystal cell, thereby constructing liquid crystal displays excellent in viewing angle and visibility with little coloration. In particular, the polarizer comprising the cellulose ester film of the invention is excellent in the humidity stability under humidity changing condition and in the long-term wet heat durability under high-temperature high-humidity condition, and therefore can maintain stable performance for a long period of time under high-temperature high-humidity condition. Excellently, in addition, the haze of the polarizer of the invention is low.

### [Liquid Crystal Display Device]

The cellulose ester film and the polarizer comprising the film of the invention are usable in liquid crystal cells and liquid crystal display devices of various display modes. For these, proposed are various modes of TN (twisted nematic), IPS (in-plane switching), FLC (ferroelectric liquid crystal), AFLC (anti-ferroelectric liquid crystal), OCB (optically compensatory bend), STN (super twisted nematic), VA (vertically aligned) and HAN (hybrid aligned nematic) modes.

In the VA-mode liquid crystal cell, rod-shaped liquid crystal molecules are aligned substantially vertically under no voltage application.

The VA-mode liquid crystal cell includes, in addition to (1) the VA-mode liquid crystal cell of a narrow sense, where rod-shaped liquid crystal molecules are aligned substantially vertically under no voltage application and are aligned horizontally under voltage application (described in JP-A 2-176625), (2) a multidomained VA-mode (MVA-mode) liquid crystal cell with enlarged viewing angles (in SID 97, Digest of Tech. Papers (preprints) 28 (1997), 845), (3) a liquid crystal cell of an n-ASM mode in which the rod-shaped liquid crystal molecules are aligned substantially vertically under no voltage application and are aligned in twisted multi-domains under voltage application (in Sharp Technical Report, No. 80, p. 11), and (4) a liquid crystal cell of a SURVIVAL mode (in Monthly Journal of Display, May, p. 14 (1999)).

The VA-mode liquid crystal display device comprises a liquid crystal cell and two polarizers disposed on both sides thereof. The liquid crystal cell carries a liquid crystal between two electrode substrates. In one embodiment of a transmission-type liquid crystal display device of the invention, one film of the invention is disposed between the liquid crystal cell and one polarizer, or two films of the invention are between the liquid crystal cell and both polarizers.

In another embodiment of a transmission-type liquid crystal display device of the invention, an optically-compensatory sheet comprising the film of the invention is used as the transparent protective film of the polarizer to be disposed between the liquid crystal cell and the polarizing element. The optically-compensatory sheet may be used as only the protective film for one polarizer (between the liquid crystal cell and the polarizing element), or the optically-compensatory sheet may be used as the two protective films for both polarizers (between the liquid crystal cell and the polarizing element). In case where the optically-compensatory sheet is used only for one polarizer, preferably, the sheet serves as the protective film on the liquid crystal cell side of the backlight-side polarizer adjacent to the liquid crystal cell. When stuck to the liquid crystal cell, preferably, the film of the invention is on the VA-cell side. The protective film may be any ordinary cellulose film, and is preferably thinner than the film of the invention. For example, its thickness is preferably from 40 to 80 μm. Not limited thereto, the film includes commercial KC4UX2M (by Konica-Opto, 40 μm), KC5UX (by Konica-Opto, 60 μm), TD80 (by FUJIFILM, 80 μm), etc.

### EXAMPLES

The characteristics of the invention are described more concretely with reference to the following Examples. In the following Examples, the material used, its amount and the ratio, the details of the treatment and the treatment process may be suitably modified or changed. Accordingly, the invention should not be limitatively interpreted by the Examples mentioned below.

### Example 1

A cellulose ester dope (a) mentioned below was formed into a film according to a solution casting process.

### (Cellulose Ester Dope a)

| | | |
|---|---|---|
| Cellulose acetate resin: having a degree of substitution | 100 | mas. pts. |
| shown in Table 4 below | | |

Additive M, in an amount shown in Table 4 (unit, mas. pt.)

| | | |
|---|---|---|
| Retardation enhancer AA | 4 | mas. pts. |
| Release promoter | 0.03 | mas. pts. |
| Dichloromethane | 406 | mas. pts. |
| Methanol | 61 | mas. pts. |

Retardation Enhancer AA:

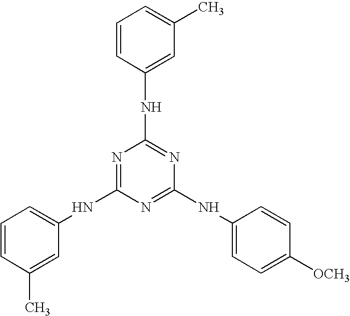

Retardation Enhancer AB:

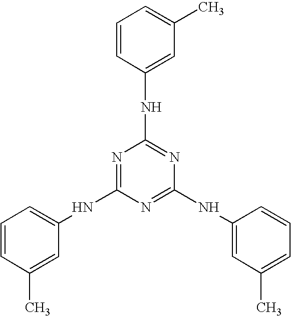

Retardation Enhancer AC:

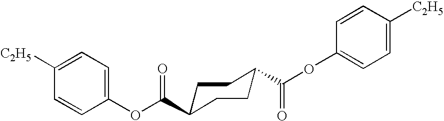

Release Promoter:

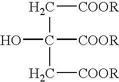

R═H or C₂H₅

The composition of the above-mentioned additive M is shown in Table 3 below, along with the compositions of other additives A to R therein. The copolymerization A and the copolymerization B of the copolymerization ingredient 1 and the copolymerization ingredient 2 that are named so for convenience′ sake are shown in Tables 4 and 5 below.

TABLE 3

| | Copolymerization | Copolymerization |
|---|---|---|
| Additive | Ingredient 1 | Ingredient 2 |
| A | styrene | o-hydroxystyrene |
| B | styrene | m-hydroxystyrene |
| C | styrene | p-hydroxystyrene |
| D | m-hydroxystyrene | o-acetoxystyrene |
| E | m-hydroxystyrene | m-acetoxystyrene |
| F | m-hydroxystyrene | p-acetoxystyrene |
| G | styrene | o-acetoxystyrene |
| H | styrene | m-acetoxystyrene |
| I | styrene | p-acetoxystyrene |
| J | m-hydroxystyrene | vinylpyrrolidone |
| K | m-hydroxystyrene | — |
| L | m-acetoxystyrene | — |
| M | m-acetoxystyrene | vinylpyrrolidone |
| R | styrene | acrylic acid |
| S | styrene | vinyl alcohol |
| T | styrene | propylene |
| U | p-hydroxystyrene | propylene |
| Y | styrene | maleic anhydride |
| Z | p-hydroxystyrene | — |

### (Solution Cast)

The cellulose ester dope (a) was put into a mixing tank, and stirred to dissolve the constitutive ingredients, and then this was filtered through a paper filter having a mean pore size of 34 μm and through a sintered metal filter having a mean pore size of 10 μm, thereby preparing a cellulose ester dope. The dope was cast onto a band caster. The film having a residual solvent amount of about 30% by mass was peeled away, and dried with hot air at 140° C., using a tenter. Then, this was transferred from the tenter onto a roll conveyor, then dried at 120° C. to 150° C. and wound up.

### (Stretching)

Using a tenter, the width of the film was expanded to a draw ratio of 34%, and then relaxed at 140° C. for 60 seconds so that its draw ratio could be 30%, thereby giving a cellulose ester film. The film thickness was 60 μm.

### Examples 2 to 50, Comparative Examples 1 to 6

Cellulose ester dopes were prepared in the same manner as in Example 1, for which, however, the degree of substitution of the cellulose ester resin, the type and the amount of the plasticizer, the type and the amount of the additive and the type and the amount of the retardation enhancer were changed as in Tables 4 and 5 below. In Tables 4 and 5, the plasticizer V is TPP, the plasticizer W is BDP; and the plasticizers P-1, P-6, P-20, P-32, P-38, P-47, P-52, P-53, P-54, P-55, P-60 and P-64 are the above-mentioned polymer additives, the polymers shown in the above Table 1 and Table 2. The amount of the plasticizer is in a unit of part by mass In the following Table 4 and Table 5, the cellulose ester resins are cellulose acetate resins in Examples 2 to 45, 49 and 50 and Comparative Examples 1 to 6. In Examples 46 to 48, these are cellulose acetate propionate resins. In Examples 49 and 50, two additives, additive Y (styrene/maleic anhydride copolymer, copolymerization ratio, 5/5) and additive Z were added.

Next, like in Example 1, the dope was cast in a mode of solution casting and stretched, thereby producing cellulose ester films of Examples 2 to 50 and Comparative Examples 1 to 6.

### Test Examples

### (Evaluation of Film Properties)

The physical properties of the cellulose ester films of Examples 1 to 50 and Comparative Examples 1 to 6 were evaluated according to the methods mentioned below.

The properties of the films were determined according to the following methods.

### (Retardation)

Using KOBRA 21ADH (by Oji Scientific Instruments) and according to the method mentioned in the above, Rth was determined. The results are shown in Table 4 and Table 5 below.

### (Humidity Stability of Rth)

Rth was measured at 25° C. and 10% RH, and this is Rth(10%) Rth was measured at 25° C. and 80% RH, and this is Rch (80%). From these, ΔRth(10-80) was derived, and the samples were evaluated according to the following criteria. The results are shown in Table 4 and Table 5 below.

⊚: At most 15 nm, and extremely excellent.
◯: From 15 to 20 nm, and practicable.
×: More than 20 nm, and impracticable.

### (Wet Heat Durability of Rth)

After kept at 60° C. and 90% RH for 24 hours, Rth of the sample was measured. Based on the initial Rth of the sample just after Its production, the Rth change was computed. With its absolute value, ΔRth (60° C., 90% RH), the samples were evaluated according to the following criteria. The results are shown in Table 4 and Table 5 below.

⊚: At most 10 no, and extremely excellent.
◯: From 10 to 15 nm, and favorable for practical use.
Δ: From 15 to 20 nm, and no problem in practical use.
×: More than 20 nm, and impracticable.

### (Wet Heat Durability of Dimensional Change Resistance)

Before and after 24 hours at 60° C. and 90% RH, the dimensional change in the machine direction (MD) of the film was computed. Based on its absolute value, the samples were evaluated according to the following criteria. The results are shown in Table 4 and Table 5 below.

⊚: At most 0.1%, and extremely excellent.
◯: From 0.1 to 0.2%, and favorable for practical use.
Δ: From 0.2 to 0.4%, and no problem in practical use.
×: More than 0.4%, and impracticable.

TABLE 4

| | | | | | | Amount | Additive | |
|---|---|---|---|---|---|---|---|---|
| | Degree of | | Amount of | | | of | Copolymerization Ratio | |
| | Substitution | | Plasticizer | Retardation | | Additive | Copolymerization | Copolymerization |
| | of Cellulose | Plasticizer | (mas. pt.) | Enhancer | Additive | (mas. pt.) | Ingredient 1 | Ingredient 2 |
| Comparative | 2.25 | no | | AA | M | 4 | 4 | 6 |
| Example 1 | | | | | | | | |
| Example 1 | 2.3 | no | | AA | M | 4 | 4 | 6 |
| Example 2 | 2.42 | no | | AA | M | 4 | 4 | 6 |
| Example 3 | 2.45 | no | | AA | M | 4 | 5 | 5 |
| Example 4 | 2.6 | no | | AA | M | 4 | 5 | 5 |
| Example 5 | 2.7 | no | | AA | M | 4 | 6 | 4 |
| Example 6 | 2.79 | no | | AB | M | 4 | 6 | 4 |
| Example 7 | 2.82 | no | | AB | M | 4 | 6 | 4 |
| Comparative | 2.25 | V:W = 1:1 | 12 | AA | M | 4 | 4 | 6 |
| Example 2 | | | | | | | | |
| Example 8 | 2.3 | V:W = 1:1 | 12 | AA | M | 4 | 4 | 6 |
| Example 9 | 2.42 | V:W = 1:1 | 12 | AA | M | 4 | 4 | 6 |
| Example 10 | 2.45 | V:W = 1:1 | 12 | AA | M | 4 | 5 | 5 |
| Example 11 | 2.6 | V:W = 1:1 | 12 | AA | M | 4 | 5 | 5 |
| Example 12 | 2.7 | V:W = 1:1 | 12 | AA | M | 4 | 6 | 4 |
| Example 13 | 2.79 | V:W = 1:1 | 12 | AB | M | 4 | 6 | 4 |
| Example 14 | 2.82 | V:W = 1:1 | 12 | AB | M | 4 | 6 | 4 |
| Example 15 | 2.45 | P-6 | 15 | nil | A | 4 | 4 | 6 |
| Example 16 | 2.45 | P-6 | 15 | nil | B | 4 | 4 | 6 |
| Example 17 | 2.45 | P-6 | 15 | nil | C | 4 | 4 | 6 |
| Example 18 | 2.45 | P-6 | 15 | nil | D | 4 | 4 | 6 |
| Example 19 | 2.45 | P-6 | 15 | nil | E | 4 | 4 | 6 |
| Example 20 | 2.45 | P-6 | 15 | nil | F | 4 | 4 | 6 |
| Example 21 | 2.45 | P-6 | 15 | nil | G | 4 | 3 | 7 |
| Example 22 | 2.45 | P-6 | 15 | nil | H | 4 | 3 | 7 |
| Example 23 | 2.45 | P-6 | 15 | nil | I | 4 | 3 | 7 |
| Example 24 | 2.45 | P-6 | 15 | nil | J | 4 | 5 | 5 |

| | | | | | | | |
|---|---|---|---|---|---|---|---|
| Example 25 | 2.45 | P-6 | 15 | nil | K | 4 | homopolymer |
| Example 26 | 2.45 | P-6 | 15 | nil | L | 4 | homopolymer |

| | Additive Ingredients | | | | | |
|---|---|---|---|---|---|---|
| | A (%) | B (%) | Rth (nm) | ΔRth (10-80) | ΔRth (60° C., 90% RH) | MD Dimensional Change |
| Comparative | 100 | 100 | 142 | ◯ | X | X |
| Example 1 | | | | | | |
| Example 1 | 100 | 100 | 125 | ◯ | Δ | Δ |
| Example 2 | 100 | 100 | 102 | ◯ | ◯ | Δ |
| Example 3 | 100 | 100 | 87 | ◯ | ◯ | Δ |
| Example 4 | 100 | 100 | 56 | ◯ | ◯ | Δ |
| Example 5 | 100 | 100 | 52 | ◯ | ◯ | Δ |
| Example 6 | 100 | 100 | 42 | ◯ | ◯ | Δ |
| Example 7 | 100 | 100 | 35 | ◯ | ◯ | Δ |
| Comparative | 100 | 100 | 135 | ◯ | X | X |
| Example 2 | | | | | | |
| Example 8 | 100 | 100 | 120 | ◯ | Δ | ◯ |
| Example 9 | 100 | 100 | 100 | ◯ | ◯ | ◯ |
| Example 10 | 100 | 100 | 90 | ◯ | ◯ | ◯ |
| Example 11 | 100 | 100 | 60 | ◯ | ◯ | ◯ |
| Example 12 | 100 | 100 | 55 | ◯ | ◯ | ◯ |
| Example 13 | 100 | 100 | 45 | ◯ | ◯ | ◯ |
| Example 14 | 100 | 100 | 38 | ◯ | ◯ | ◯ |
| Example 15 | 100 | 60 | 101 | ⊚ | Δ | ◯ |
| Example 16 | 100 | 60 | 102 | ⊚ | Δ | ◯ |
| Example 17 | 100 | 60 | 100 | ◯ | Δ | ◯ |
| Example 18 | 100 | 100 | 98 | ⊚ | ◯ | ◯ |
| Example 19 | 100 | 100 | 99 | ⊚ | ◯ | ◯ |
| Example 20 | 100 | 100 | 106 | ◯ | ◯ | ◯ |
| Example 21 | 100 | 70 | 108 | ⊚ | Δ | ◯ |
| Example 22 | 100 | 70 | 120 | ⊚ | Δ | ◯ |
| Example 23 | 100 | 70 | 108 | ◯ | Δ | ◯ |
| Example 24 | 100 | 100 | 97 | ⊚ | ◯ | ◯ |
| Example 25 | 100 | 100 | 100 | ◯ | ◯ | Δ |
| Example 26 | 100 | 100 | 97 | ⊚ | ◯ | Δ |

TABLE 5

| | | | | | | Amount | Additive | |
|---|---|---|---|---|---|---|---|---|
| | Degree of | | Amount of | | | of | Copolymerization Ratio | |
| | Substitution | | Plasticizer | Retardation | | Additive | Copolymerization | Copolymerization |
| | of Cellulose | Plasticizer | (mas. pt.) | Enhancer | Additive | (mas. pt.) | Ingredient 1 | Ingredient 2 |
| Comparative | 2.25 | P-6 | 20 | AA | R | 4 | 4 | 6 |
| Example 3 | | | | | | | | |
| Example 27 | 2.3 | P-6 | 20 | AA | R | 4 | 4 | 6 |
| Example 28 | 2.43 | P-1 | 20 | AA | R | 4 | 4 | 6 |
| Example 29 | 2.43 | P-6 | 20 | AC | R | 4 | 4 | 6 |
| Example 30 | 2.43 | P-20 | 20 | AA | R | 4 | 4 | 6 |
| Example 31 | 2.43 | P-32 | 20 | AA | R | 4 | 4 | 6 |
| Example 32 | 2.43 | P-38 | 20 | AA | R | 4 | 4 | 6 |
| Example 33 | 2.43 | P-47 | 20 | AA | R | 4 | 4 | 6 |
| Example 34 | 2.43 | P-52 | 20 | AA | R | 4 | 4 | 6 |
| Example 35 | 2.43 | P-53 | 20 | AA | R | 4 | 4 | 6 |
| Example 36 | 2.43 | P-54 | 20 | AA | R | 4 | 4 | 6 |
| Example 37 | 2.43 | P-55 | 20 | AA | R | 4 | 4 | 6 |
| Example 38 | 2.43 | P-60 | 20 | AA | R | 4 | 4 | 6 |
| Example 39 | 2.43 | P-64 | 20 | AA | R | 4 | 4 | 6 |
| Example 40 | 2.42 | P-6 | 20 | AA | R | 4 | 4 | 6 |
| Example 41 | 2.45 | V:W = 1:1 | 8 | AA | R | 4 | 5 | 5 |
| Example 42 | 2.6 | V:W = 1:1 | 10 | AA | R | 4 | 5 | 5 |
| Example 43 | 2.7 | V:W = 1:1 | 12 | AA | R | 4 | 6 | 4 |
| Example 44 | 2.79 | V:W = 1:1 | 12 | AB | R | 4 | 6 | 4 |
| Example 45 | 2.82 | V:W = 1:1 | 0 | AB | R | 4 | 6 | 4 |
| Example 46 | 2.38 | V:W = 1:1 | 5 | nil | G | 4 | 3 | 7 |
| Example 47 | 2.46 | V:W = 1:1 | 5 | nil | G | 4 | 3 | 7 |
| Example 48 | 2.57 | V:W = 1:1 | 5 | nil | G | 4 | 3 | 7 |
| Comparative | 2.45 | P-6 | 20 | AB | S | 4 | 2 | 8 |
| Example 4 | | | | | | | | |
| Comparative | 2.45 | P-6 | 20 | AB | T | 4 | 2 | 8 |
| Example 5 | | | | | | | | |
| Comparative | 2.45 | P-6 | 20 | AB | U | 4 | 2 | 8 |
| Example 6 | | | | | | | | |
| Example 49 | 2.45 | P-6 | 6 | AB | Y | 10 | 5 | 5 |

| | | | | Z | 4 | homopolymer | |
|---|---|---|---|---|---|---|---|
| Example 50 | 2.45 | no | AB | Y | 16 | 5 | 5 |

| | | |
|---|---|---|
| Z | 4 | homopolymer |

| | Additive Ingredients | | | | | |
|---|---|---|---|---|---|---|
| | A (%) | B (%) | Rth (nm) | ΔRth (10-80) | ΔRth (60° C., 90% RH) | MD Dimensional Change |
| Comparative | 40 | 60 | 124 | ⊚ | X | X |
| Example 3 | | | | | | |
| Example 27 | 40 | 60 | 120 | ⊚ | Δ | ◯ |
| Example 28 | 40 | 60 | 102 | ⊚ | ⊚ | ◯ |
| Example 29 | 40 | 60 | 101 | ⊚ | ⊚ | ◯ |
| Example 30 | 40 | 60 | 98 | ⊚ | ◯ | ◯ |
| Example 31 | 40 | 60 | 105 | ⊚ | ⊚ | ◯ |
| Example 32 | 40 | 60 | 102 | ⊚ | ⊚ | ◯ |
| Example 33 | 40 | 60 | 103 | ⊚ | ◯ | ◯ |
| Example 34 | 40 | 60 | 104 | ⊚ | ◯ | ◯ |
| Example 35 | 40 | 60 | 108 | ⊚ | ◯ | ◯ |
| Example 36 | 40 | 60 | 112 | ⊚ | ◯ | ◯ |
| Example 37 | 40 | 60 | 120 | ⊚ | ◯ | ◯ |
| Example 38 | 40 | 60 | 105 | ⊚ | ◯ | ◯ |
| Example 39 | 40 | 60 | 109 | ⊚ | ◯ | ◯ |
| Example 40 | 40 | 60 | 102 | ⊚ | ◯ | ◯ |
| Example 41 | 50 | 50 | 100 | ⊚ | ⊚ | ◯ |
| Example 42 | 50 | 50 | 97 | ⊚ | ⊚ | ◯ |
| Example 43 | 60 | 40 | 99 | ⊚ | ⊚ | ◯ |
| Example 44 | 60 | 40 | 100 | ⊚ | ◯ | ◯ |
| Example 45 | 60 | 40 | 105 | ⊚ | Δ | Δ |
| Example 46 | 100 | 70 | 95 | ⊚ | ◯ | ◯ |
| Example 47 | 100 | 70 | 86 | ⊚ | ◯ | ◯ |
| Example 48 | 100 | 70 | 75 | ⊚ | ◯ | ◯ |
| Comparative | 20 | 80 | 102 | ◯ | ◯ | X |
| Example 4 | | | | | | |
| Comparative | 20 | 0 | 105 | X | X | X |
| Example 5 | | | | | | |
| Comparative | 20 | 0 | 110 | ◯ | X | X |
| Example 6 | | | | | | |
| Example 49 | 100 | 50 | 103 | ◯ | ⊚ | ⊚ |
| | 100 | 100 | | | | |
| Example 50 | 100 | 50 | 112 | ◯ | ⊚ | ⊚ |
| | 100 | 100 | | | | |

Table 4 and Table 5 confirm that the cellulose ester films of Examples 1 to 50 of the invention have a positive Rth, and are excellent in the humidity stability of Rth, in the wet heat durability of Rth and also in the wet heat durability of the dimensional change resistance in the machine direction. On the other hand, the films of Comparative Examples 1 to 3 where the cellulose resin used had a total degree of substitution of cellulose, DS, of less than 2.3, are not good in point of both the wet heat durability of Rth and the wet heat durability of the dimensional change resistance in the machine direction. The films of Comparative Examples 4 to 6 where the polymerization ratio A of the ingredient having a negative birefringence was less than 30% in the additive are impracticable in point of all the humidity stability of Rth, the wet heat durability of Rth and the wet heat durability of the dimensional change resistance in the machine direction. The films of Examples 49 and 50 where a small amount of an additive Z (p-hydroxystyrene) was added to the additive Y (styrene/maleic anhydride copolymer, copolymerization ratio of 5/5) were much more improved in point of ΔRth (60° C., 90% RH) and the dimensional change resistance.

### Examples 101 to 150

### (Formation of Polarizing Element)

A polyvinyl alcohol (PVA) film having a thickness of 75 μm and a degree of polymerization of 2400 was swollen in hot water at 30° C. for 40 seconds, then colored by dipping it in an aqueous solution potassium iodide (6% by mass) having an iodine concentration of 0.06% by mass at 30° C. for 60 seconds, and thereafter stretched in the machine direction by 5.0 times the original length while dipped in an aqueous solution of potassium iodide (3% by mass) having a boric acid concentration of 4% by mass) at 40° C. for 60 seconds. Next, this was dried at 50° C. for 4 minutes to give a polarizing element.

### (Preparation of Cellulose Ester Film)

The film produced in Example 1 was dipped in an aqueous sodium hydroxide solution (1.5 mol/L) at 30° C., and FUJIFILM's TD80U was in an aqueous sodium hydroxide solution (1.5 mol/L) at 55° C., and then these were fully washed with water to remove sodium hydroxide. Next, the films were dipped in an aqueous diluted sulfuric acid solution (0.05 mol/L) at 35° C. for 15 seconds and then dipped in water to fully remove the aqueous diluted sulfuric acid solution. Finally, the samples were fully dried at 120° C.

### (Sticking)

The film and FUJIFILM's T80U that had been saponified in the manner as above were stuck together with the previously-prepared polarizing element put therebetween, using a polyvinyl alcohol adhesive, and then heated at 70° C. for 30 minutes. Next, using a cutter, this was trimmed by 3 cm in the width direction, thereby giving a polarizer having an effective width of 1200 mm and a length of 50 m as a roll. In this case, the polarizing element and the protective films to be on both sides of the polarizing element were formed as rolls, and the machine direction of the individual rolls is in parallel to each other, and therefore, they are stuck together continuously. Regarding the protective film to be on the side of the cell, the transmission axis of the polarizing element is parallel to the slow axis of the cellulose ester film.

### (Formation of Adhesive Layer)

N-butyl acrylate (n-BA) (75 parts by mass), methyl acrylate (MA) (20 parts by mass), 2-hydroxyethyl acrylate (2-HEA) (5 parts by mass), ethyl acetate (100 parts by mass) and azobisisobutyronitrile (AIBN) (0.2 parts by mass) were put into a reactor, air inside the reactor was purged with nitrogen gas, and then the reactor was heated up to 60° C. with stirring in the nitrogen atmosphere, and the compounds were reacted for 4 hours. After 4 hours, toluene (100 parts by mass), α-methylstyrene dimer (5 parts by mass) and AIBN (2 parts by mass) were added, heated up to 90° C., and reacted for further 4 hours. After the reaction, this was diluted with ethyl acetate to give an acrylic polymer solution having a solid concentration of 20% by mass. An isocyanate-type crosslinking agent (Nippon Polyurethane's trade name, Coronate L) was added thereto in an amount of 1.0 parts by mass relative to 100 parts by mass of te solid content of the polymer solution, and well stirred to give an adhesive composition.

### (Formation of Adhesive-Coated Polarizer)

The above-mentioned, acrylic polymer solution-containing adhesive composition was applied to a lubricant-processed film to form a 25-μm adhesive layer thereon, and this was transferred onto the polarizer (on the protective film on the cell side) and aged at a temperature of 23° C. and a humidity of 63% for 7 days, thereby producing an adhesive-coated polarizer. A separate film was stuck to the adhesive layer. A protect film was stuck to the protective film on the side opposite to the cell side. Thus produced, these are polarizers of Examples 101 to 150.

### Test Example 2

### (Durability of Polarizer)

The polarizer of Examples 101 to 150 was stuck to a glass sheet. Two samples were prepared for every one polarizer. These were aged at 60° C. and 90% RH for 1000 hours, and then using a spectrophotometer, Shimadzu's UV3100, the parallel transmittance and the vertical transmittance of each sample were measured. From the data, the degree of polarization of each sample was computed. As a result, the heat and humidity-dependent polarization change in the polarizers of Examples 101 to 150 was small, and it is known that the polarizers all have good durability.

The polarizers of Examples 101 to 150 were kept at 60° C. and 90% RH for 24 hours, and then the dimensional change S in the machine direction (MD) and the dimensional change S in the transverse direction (TD) were determined. The absolute value of the dimensional change S(MD) and S(TD) was at most 1.0% in all the tested samples, and the polarizers were all good.

### Examples 201 to 250

### (Packaging in VA Panel)

The polarizer and the retarder on both sides of a VA-mode liquid crystal TV (Sharp's LC-20C5) were peeled away; and the polarizer of Examples 101 to 150 and a commercial polarizer with no viewing angle compensation plate (Sanritz's HLC2-5618) were stuck to the surface and the back of the TV, using a laminator roll.

In this case, the absorption axis of the polarizer on the viewing side was parallel to the panel, and the absorption axis of the polarizer on the backlight side was vertical to the panel, and the adhesive layer was on the liquid crystal cell side.

### Test Example 3

### (Viewing Angle Characteristic)

Using a tester (ELDIM's EZ-Contrast 160D), the display devices constructed in the above were tested at 8-stage viewing angles from a black level (L1) to a white level (L8). The viewing angle is within a range having a contrast ratio of at least 10 with no gradation reversal at the time of black level of display. The liquid crystal display devices comprising the polarizer of Examples 101 to 150 all had a broad viewing angle range of 80 degrees or more in both the right and the left direction, at 25° C. and 60% RH. Next, the liquid crystal display devices were left at 60° C. and 90% RH for 24 hours, then conditioned at 25° C. and 60% RH for at least 2 hours, and thereafter again tested for the viewing angle range at 25° C. and 60% RH. These all had a broad viewing angle range of 80 degrees of more in both the right and the left direction.

These test results confirm that the degree of polarization of the polarizers comprising the cellulose ester film of the invention changes little in varying thermal and humidity environments, and the polarizers are excellent in durability and exhibit excellent display performance.

### INDUSTRIAL APPLICABILITY

The invention has made is possible to provide a cellulose ester film of which the retardation in the thickness direction changes little in varying humidity environments, and which is therefore excellent in the wet heat durability of the retardation in the thickness direction thereof and in the wet heat durability of the dimensional change resistance thereof. Specifically, the cellulose ester film of the invention is favorable for use in polarizer-protective films and in optically-compensatory films.

In addition, the polarizer of the invention is excellent in the wet heat durability thereof. Accordingly, the invention has made is possible to provide a liquid crystal display device sufficiently resistant to color shift, discoloration and light leakage on the display panel thereof in varying humidity environments.

The present disclosure relates to the subject matter contained in Japanese Patent Application No. 210183/2008 filed on Aug. 18, 2008, which is expressly incorporated herein by reference in its entirety. All the publications referred to in the present specification are also expressly incorporated herein by reference in their entirety.

The foregoing description of preferred embodiments of the invention has been presented for purposes of illustration and description, and is not intended to be exhaustive or to limit the invention to the precise form disclosed. The description was selected to best explain the principles of the invention and their practical application to enable others skilled in the art to best utilize the invention in various embodiments and various modifications as are suited to the particular use contemplated. It is intended that the scope of the invention not be limited by the specification, but be defined claims set forth below.

What is claimed is:

1. A cellulose ester film comprising a cellulose ester having a total degree of substitution of at least 2.3 and a polymer X having a weight-average molecular weight of from 500 to 100000, wherein:
the polymer X satisfies the following formula (1):
30%≦A≦100% (1)
wherein A indicates the polymerization ratio of a monomer whose homopolymer has a negative birefringence in the polymer X, and
the cellulose ester film has an Rth of more than 0 nm wherein the Rth indicates the retardation in the thickness direction of the film.

2. The cellulose ester film according to claim 1, wherein the polymer X satisfies the following formula (2):
30%≦B≦100% (2)
wherein B indicates the polymerization ratio of a monomer having at least one of a hydroxyl group or a carbonyl group in the polymer X.

3. The cellulose ester film according to claim 1, having an Rth of at least 40 nm.

4. The cellulose ester film according to claim 1, wherein the cellulose ester satisfies the following formula:
2.30≦DS<2.80
wherein DS is the total degree of substitution of the cellulose ester.

5. The cellulose ester film according to claim 2, wherein at least one of the monomer whose homopolymer has a negative birefringence and the monomer having at least one of a hydroxyl group or a carbonyl group has an aromatic ring.

6. The cellulose ester film according to claim 1, wherein the monomer whose homopolymer has a negative birefringence is a styrene derivative monomer.

7. The cellulose ester film according to claim 2, wherein the monomer having at least one of a hydroxyl group or a carbonyl group is a monomer selected from the group consisting of hydroxystyrene, acetoxystyrene, vinylpyrrolidone, hydroxyacrylate, acrylic acid and hydroxymethacrylate.

8. The cellulose ester film according to claim 2, wherein at least one of the monomer whose homopolymer has a negative birefringence and the monomer having at least one of a hydroxyl group or a carbonyl group has a phenyl group with a functional group at the ortho-position or the meta-position.

9. The cellulose ester film according to claim 8, wherein the phenyl group has a functional group only at the ortho-position or the meta-position.

10. The cellulose ester film according to claim 1, wherein A is 100%.

11. The cellulose ester film according to claim 2, wherein B is 100%.

12. The cellulose ester film according to claim 2, wherein A is 100% and B is 100%.

13. The cellulose ester film according to claim 1, comprising the polymer X in an amount of from 0.5 to 30% parts by mass relative to 100 parts by mass of the cellulose ester.

14. The cellulose ester film according to claim 1, satisfying the following formula (3):
0<|ΔRth(10-80)|≦20 nm (3)
wherein ΔRth(10-80) indicates a difference between Rth at 25° C. and 10% RH and Rth at 25° C and 80% RH.

15. The cellulose ester film according to claim 1, wherein the absolute value of the Rth change before and after 24 hours at 60° C. and 90% RH is at most 15 nm.

16. The cellulose ester film according to claim 1, wherein the absolute value of the cellulose ester film dimensional change before and after 24 hours at 60° C. and 90% RH is at most 0.2%.

17. The cellulose ester film according to claim 1, comprising at least one retardation enhancer.

18. The cellulose ester film according to claim 1, wherein the cellulose ester is a cellulose acetate.

19. A polarizer comprising the cellulose ester film of claim 1.

20. A liquid crystal display device comprising the cellulose ester film of claim 1.
